(19) United States
(12) Patent Application Publication
(10) Pub. No.: US 2005/0208440 A1
(43) Pub. Date: Sep. 22, 2005

(54) Photothermographic material

(75) Inventors: Keiichi Suzuki, Kanagawa (JP); Yoshihisa Tsukada, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/078,525

(22) Filed: Mar. 14, 2005

(30) Foreign Application Priority Data
Mar. 17, 2004 (JP) 2004-77122

(51) Int. Cl. G03C 1/00

(52) U.S. Cl. 430/619

(57) ABSTRACT

A photothermographic material which comprises an image forming layer provided on at least one side of the face of a support, the image forming layer containing a photosensitive silver halide, a nonphotosensitive organic acid silver salt, a reducing agent, a polyhalogenated compound, and a binder, wherein an outermost layer which is the furthermost from the support is provided on the side of the face having the aforementioned image forming layer with respect to the support, and the outermost layer contains a binder, and wherein the binder in the outermost layer contains an aqueous dispersion of a polymer having at least one crosslinked structure.

### CROSS-REFERENCE TO RELATED APPLICATIONS

This application claims priority under 35USC 119 from Japanese Patent Application No. 2004-077122, the disclosure of which is incorporated herein by reference.

### BACKGROUND OF THE PRESENT INVENTION

1. Field of the Present Invention

The present invention relates to a photothermographic material.

2. Description of the Related Art

In recent years, there has been a strong demand to decrease the volume of liquid processing wastes in the medical field both for environmental protection and economy of space. In order to use photothermographic materials in medical diagnosis and photographic techniques they must be capable of being exposed efficiently by laser image setters or laser imagers; further the materials must be capable of forming clear black images having high resolution and sharpness. With photothermographic materials, thermal development processing systems can be used that eliminate the use of solution system processing chemicals, have a more simple construction and do not deteriorate environments.

While such requirements exist also in the field of general image forming materials, in medical imaging, high image quality with excellent sharpness and grainin are particularly required since fine expression is needed; blue black image tone are preferred to facilitate diagnosis. At present, various kinds of hard copy systems that utilize pigments and dyes such as ink jet printers or electrophotography have been marketed as conventional image forming systems, but they are not satisfactory as image output systems for medical use.

Thermal image formation systems in which an organic silver salt is utilized are described in many documents. The photothermographic material generally has an image forming layer including a photocatalyst in a catalytically active amount (e.g., silver halide), a reducing agent, a reducible silver salt (e.g., organic silver salt), and a color toner that controls silver color tone as needed, which are dispersed in a binder matrix. The photothermographic material forms a black image of silver by heating at a high temperature (e.g., 80° C. or higher) after exposing the image, through an oxidation reduction reaction between a silver halide or a reducible silver salt (which functions as an oxidizing agent) and a reducing agent. The oxidation reduction reaction is accelerated by a catalytic action of a silver halide latent image generated upon the exposure. Therefore, a black image of silver is formed in the exposed area. Fuji Medical dry imager FM-DP L is marketed as an image formation system for medical practice by means of a photothermographic material.

A photothermographic material includes the aforementioned ingredients therein, and all of these ingredients remain following development. Therefore, there are problems in connection with storage stability. Procedures frequently studied so far in order to solve such problems involve changes in the composition included in the image forming layer, and the addition of a new compound. Examples include improvement of print out performance by changing the silver halide to one having a high silver iodide content as described in Japanese Patent Application Laidpen (JP-A) No. 8-297345 and Japanese Patent No. 2785129, suppression of fog generation by adding a polyhalogenated compound as described in JP-A No. 2001-312027, increasing a silver behenate content in a nonphotosensitive organic silver salt as described in JP-A No. 2000-7683, and the like. However, further improvements have been desired for practical use.

Because the image forming layer is a part which is directly involved with forming an image, it is extremely important to investigate the compositions in the image forming layer as a method for the improvement of storage stability. However, these compositions are present in a mixture in the image forming layer, and therefore, sensitivity tends to be decreased when improvement of storage stability is attempted, while image density tends to be decreased when suppression of fog generation is attempted. It is extremely difficult to try to concomitantly achieve contradictory performances, i.e., storage stability and supersensitization, and suppression of fog and good image density.

Furthermore, in production of a thermal image formation system in which an organic silver salt is utilized, a method enabling coating of a coated surface so as to give a uniform state without surface irregularity at a high speed has been desired for the purpose of mass production.

JP-A No. 2002-162712 and the like disclose that in the case of a thermal image formation system utilizing an organic silver salt and having an image forming layer coated with a water-based coating, fluidity is lost on the side of the image forming layer upon coating by using a hydrophilic polymer (e.g., gelatin) for a nonphotosensitive protective layer, whereby coating of a coated surface so as to give a uniform state without surface irregularity at a high speed is enabled.

Because the photothermographic material prepared by such a method has been prepared in a well-balanced manner such that advantages of respective compositions maximized it is difficult to improve storage stability by merely changing or adding a single component. A procedure capable of improving storage stability without deteriorating high-speed coating capabilities, and without counteracting features of respective compositions has been eagerly desired.

### SUMMARY OF THE PRESENT INVENTION

Accordingly, the present invention has been made in view of the above circumstances and provides a first aspect of the present invention.

A first aspect of the present invention is to provide a photothermographic material which comprises an image forming layer provided on at least one side of a support, the image forming layer containing a photosensitive silver halide, a nonphotosensitive organic acid silver salt, a reducing agent, and a binder, wherein: a binder in an outermost layer on the side of the supprt on which the image forming layer is provided contains an aqueous dispersion of a polymer having at least one crosslinked structure; and a percentage of water absorptionof the polymer having a crosslinked structure is 0.3% or greater and 10% or less.

### DETAILED DESCRIPTION OF THE PRESENT INVENTION

A photothermographic material of the present invention comprises an image forming layer provided on at least one side of a support, the image forming layer containing a photosensitive silver halide, a nonphotosensitive organic acid silver salt, a reducing agent, and a binder, wherein the binder in the outermost layer on the side of the support on which the aforementioned image forming layer is provided contains an aqueous dispersion of a polymer having at least one crosslinked structure, and the percentage of water absorptionof the polymer having a crosslinked structure is 0.3% or greater and 10% or less.

As other aspects of the present invention, second to nineteenth aspects will be described below.

A second aspect of the present invention is to provide a photothermographic material according to the first aspect, wherein the binder in the outermost layer contains the aqueous dispersion of the polymer having the crosslinked structure in an amount of 90% by mass or greater and 100% by mass or less.

A third aspect of the present invention is to provide a photothermographic material according to the first aspect, wherein: a first nonphotosensitive layer is provided on the side of the supprt on which the image forming layer is provided; and the first nonphotosensitive layer contains at least one binder which can be gelated due to a reduction in temperature.

A second aspect of the present invention is to provide a photothermographic material according to the third aspect, wherein: a second nonphotosensitive layer containing a binder is provided on the side of the supprt on which the image forming layer is provided; and the binder in the second nonphotosensitive layer contains an aqueous dispersion of a hydrophobic polymer in an amount of 50% by mass or greater.

A second aspect of the present invention is to provide a photothermographic material according to the fifth aspect, wherein any one layer on the side of the supprt on which the image forming layer is provided contains a crosslinking agent.

A sixth aspect of the present invention is to provide a photothermographic material according to the first aspect, wherein the image forming layer is provided on both sides of the supprt.

A seventh aspect of the present invention is to provide a photothermographic material according to the first aspect, wherein a polymer having the crosslinked structure is obtained by the polymerization of monomera including a crosslinkable radical polymerizable monomer.

A eighth aspect of the present invention is to provide a photothermographic material according to the seventh aspect, wherein a content of the crosslinkable radical polymerizable monomer is 0.1% by mass or greater and 10% by mass or less.

A ninth aspect of the present invention is to provide a photothermographic material according to the first aspect, wherein the binder in the outermost layer contains the aqueous dispersion of the polymer having the crosslinked structure in an amount of 92% by mass or greater and 100% by mass or less.

A tenth aspect of the present invention is to provide a photothermographic material according to the third aspect, wherein the binder which can be gelated due to a reduction in temperature is a polymer derived from animal protein.

A eleventh aspect of the present invention is to provide a photothermographic material according to the tenth aspect, wherein the polymer derived from animal protein is gelatin.

A twelfth aspect of the present invention is to provide a photothermographic material according to the eleventh aspect, wherein the number average molecular weight of the gelatin is 10,000 or greater and 1,000,000 or less.

A thirteenth aspect of the present invention is to provide a photothermographic material according to the fourth aspect, wherein the binder in the second nonphotosensitive layer contains the aqueous dispersion of the hydrophobic polymer in an amount of 80% by mass or greater.

A fourteenth aspect of the present invention is to provide a photothermographic material according to the fourth aspect, wherein the binder in the second nonphotosensitive layer contains the aqueous dispersion of the hydrophobic polymer in an amount of 90% by mass or greater.

A fifteenth aspect of the present invention is to provide a photothermographic material according to the fourth aspect, wherein the number average molecular weight of the hydrophobic polymer is 5,000 or greater and 1,000,000 or less.

A sixteenth aspect of the present invention is to provide a photothermographic material according to the fourth aspect, wherein the glass transition temperature of the hydrophobic polymer is −30° C. or higher and 70° C. or lower.

A seventeenth aspect of the present invention is to provide a photothermographic material according to the fourth aspect, wherein the hydrophobic polymer is a polymer obtained by copolymerization of a monomer represented by the following formula (M):
CH₂═CR⁰¹—CR⁰²═CH₂
wherein R⁰¹ and R⁰² are each independently a group selected from a hydrogen atom, an alkyl group having 1 to 6 carbon atoms, a halogen atom, or a cyano group.

A eighteenth aspect of the present invention is to provide a photothermographic material according to the first aspect, wherein a matting agent is contained in the outermost layer.

A nineteenth aspect of the present invention is to provide a photothermographic material according to the eighteenth aspect, wherein the volume weighted average of the sphere equivalent diameter of the matting agent is 0.3 μm or greater and 10 μm or less.

A twentieth aspect of the present invention is to provide a photothermographic material according to the eighteenth aspect, wherein the Beck smoothness of the matting agent is 10 seconds or greater and 1,200 seconds or less.

In general, changes in the composition of the image forming layer are carried out for improving storability. However, when a composition of the image forming layer is changed, adjustment with other compositions may be complicated, and thus, reinvestigation must be conducted for all of the compositions each time when a new developed composition is applied to an image forming layer. Therefore, the present inventors focused attention on the outermost layer. Consequently, it was extremely effective for improving storage stability to include an aqueous dispersion which contains a polymer having a crosslinked structure, and in which the polymer having the crosslinked structure has a percentage of film water absorption within the range of from 0.3% to 10%, as a binder in the outermost layer.

This construction is conjectured to effectively prevent penetration of moisture from the outside by including the aqueous dispersion of a polymer having a crosslinked structure in the outermost layer. In other words, substantial involvement of moisture was found as a factor in deteriorating unprocessed stock storability and image storability.

Also, in contrast to the case in which a hydrophilic binder is used for the outermost layer, it was found that unevenness of the image due to reflected light is also improved because disorder of the photosensitive material surface (concavity and convexity) is not caused through handling of the image surface with bare hands after processing.

Moreover, taking into account the coating capabilities, the percentage of film water absorption of the polymer having a crosslinked structure to be 0.3% or greater and 10% or less.

It was found that when the percentage of water absorptionis less than 0.3%, the hydrophobic property is so great that formation of a coating film on the outermost layer may be difficult due to the great drying speed, particularly when coating at a high speed is conducted. Furthermore, it was also found that when the percentage of water absorptionis greater than 10%, the finished coating film has an inferior effect of preventing the penetration of moisture.

Also, because the aqueous dispersion of the polymer having the crosslinked structure lacks setting property (i.e., a property having fluidity at a certain temperature or higher, but losing or lowering the fluidity through gelation at a temperature lower than the certain temperature), it is extremely difficult to coat a coated surface so as to give a uniform state without unevenness. Thus, a nonphotosensitive layer other than the outermost layer is provided, and a binder which is gelated due to a reduction in temperature is used in the nonphotosensitive layer. Because fluidity of the layer which is formed by the coating is lost through gelation, the surface of the image forming layer becomes less susceptible to air employed for drying in a drying step following the coating step. Accordingly, a photothermographic material whose coated surfave has a uniform state can be obtained.

Furthermore, effective prevention of penetration of moisture from the outside by including a hydrophobic polymer as a binder in an intermediate layer disposed in the vicinity of the image forming layer is proposed. Accordingly, even when a binder which is gelated due to a reduction in temperature is used in the nonphotosensitive layer of the image forming layer side, penetration of moisture into the image forming layer can be prevented.

Hereinafter, layered construction of the photothermographic material of the present invention is explained first, and then component substances of each layer are explained.

1. Layered Construction

Generally, photothermographic materials have an image forming layer, which is constructed from one or more layers, on a support. In addition to the image forming layer, they also have a nonphotosensitive layer.

The nonphotosensitive layer can be categorized on the basis of the arrangement into: (a) a surface protective layer provided on the image forming layer (on the farther side from the support), (b) an intermediate layer provided between multiple image forming layers or between the image forming layer and the surface protective layer, (C) an undercoat layer provided between the image forming layer and the support, and (d) a back layer provided on the opposite side of the image forming layer. These layers may be each independently a single layer or multiple layers.

The photothermographic material of the present invention comprises the image forming layer and the outermost layer as essential components. The outermost layer is the surface protective layer in the item (a), which is the farthest layer from the support. The outermost layer contains an aqueous dispersant of a polymer having at least one crosslinked structure as a binder.

Moreover, according to the present invention, it is preferred that a first nonphotosensitive layer and a second nonphotosensitive layer are provided as the surface protective layer in the item (a) or the intermediate layer in the item (b). The first nonphotosensitive layer preferably contains the binder which can be gelated upon drop of the temperature. The second nonphotosensitive layer preferably contains an aqueous dispersion of a hydrophobic polymer as a binder in an amount of 50% by mass or greater.

Further, according to the present invention, a layer that functions as an optical filter can be provided, which is provided as the layer described in the item (a) or (b) among the nonphotosensitive layers. The photosensitive material may be provided with an antihalation layer as a layer described in the item (c) or (d).

The photothermographic material of the present invention may be either a single-sided type having the image forming layer on only one side of the support, or a double-sided type having the image forming layer on both sides of the support. In instances of the double-sided type, the outermost layer containing the aqueous dispersion of a polymer having a crosslinked structure may be provided on at least one side. However, in preferred instances, the outermost layer containing the aqueous dispersion of a polymer having a crosslinked structure is provided on both sides of the support.

In instances of the single-sided type photothermographic material, a back layer is preferably provided on the opposite side to the side having the image forming layer with respect to the support (hereinafter, referred to as back side).

The single-sided type photothermographic material according to the present invention can be preferably used as an X-ray sensitive material for mammography. It is important to design the single-sided type photothermographic material for use in this purpose such that contrasts of the obtained image fall within a adequate range. In connection with the preferable element as the X-ray sensitive material for mammography, JP-A Nos. 5-45807, 10-62881, 10-54900 and 11-109564 may serve as a reference.

The double-sided photothermographic material can be preferably used in an image-forming method in which an X-ray image is recorded using an X-ray intensifying screen. The photosensitive materials to which X-ray exposure is executed are suitably used for medical diagnoses.

In constructions of multicolor photosensitive thermal development photographic materials, combinations of these two layers may be contained for each color, alternatively, as described in U.S. Pat. No. 4,708,928, all ingredients may be contained into a single layer. In instances of multidye, multicolor photosensitive thermal development photographic materials, each emulsion layer is generally retained distinctively with each other by using a functional or nonfunctional barrier layer between respective photosensitive layers, as described in U.S. Pat. No. 4,460,681.

2. Component Substance of Each Layer

(1) Outermost Layer

The outermost layer in the present invention is provided on the side of the image forming layer, and contains an aqueous dispersant of a polymer having at least one crosslinked structure as a binder. The aqueous dispersion of the polymer having a crosslinked structure for use in the present invention has the percentage of water absorptionbeing in the range of 0.3% or greater and 10% or less. The percentage of water absorptionis preferably 0.5% or greater and 8.0% or less, and more preferably 0.5% or greater and 6.0% or less. When the percentage of water absorptionis less than 0.3%, the hydrophobic property becomes so great that formation of a coating film on the outermost layer may be difficult due to high drying speed, particularly when coating at a high speed is conducted. Furthermore, when the percentage of water absorptionis greater than 10%, the finished coating film has an inferior effect to prevent the penetration of moisture.

For the “percentage of water absorption (%)” referred to herein, absorption of water is allowed at 25° C. for 10 min on a sample which formed the film of the polymer (amount of coating: 15 g/m²). Thus, a value is obtained on the basis of the amount of absorbed moisture, which is determined according to:
percentage of water absorption (%)=absorbed moisture content (g/m²)/amount of coated polymer (g/m²)×100.

The polymer having a crosslinked structure for use in the present invention is a polymer obtained by polymerization of a material comprising at least one crosslinkable radical polymerizable monomer described below.

The crosslinkable radical polymerizable monomer is a compound having at least 2, preferably 2 to 4 radical polymerizable [carbon=carbon] double bonds; or a vinyl compound having a functional group which imparts a self-crosslinking structure during polymerization, and/or post polymerization. Specific examples thereof include the following monomers.
(1) Polyvalent vinyl aromatic compounds: diisopropenyl benzene, divinyl benzene and the like,
(2) unsaturated ester compounds of an α,β-ethylenic unsaturated carboxylic acid: vinyl acrylate, vinyl methacrylate, allyl methacrylate and the like,
(3) unsaturated ester compounds of a polyvalent carboxylic acid: diallyl phthalate, triallyl cyanurate, triallyl isocyanurate, triallyl trimellitate and the like,
(4) unsaturated ester compounds of a polyhydric alcohol: ethyleneglycol diacrylate, ethyleneglycol dimethacrylate, propyleneglycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, 1,2,4-cyclohexane tetramethacrylate polyoxyethylene diacrylate, polyoxyethylene dimethacrylate, polyoxypropylene diacrylate, polyoxypropylene dimethacrylate, neopentylglycol diacrylate, neopentylglycol dimethacrylate, butanediol diacrylate, butanediol dimethacrylate and the like,
(5) conjugated diene compounds: 1,3-butadiene, 1,3-pentadiene, 1-phenyl-1,3-butadiene, 1-naphthyl-1,3-butadiene, 1-β-naphthyl-1,3-butadiene, 1-bromo-1,3-butadiene, 1-chloro-1,3-butadiene, 1,1,2-trichloro-1,3-butadiene, cyclopentadiene and the like,
(6) vinyl compounds having a functional group which imparts a crosslinked structure during polymerization, and/or post polymerization: epoxy group-containing monomers, e.g., glycidyl acrylate, glycidyl methacrylate, allyl glycidyl ether, methyl glycidyl acrylate and methyl glycidyl methacrylate, methylol group-containing monomers, e.g., N-methylol acrylamide, N-methylol methacrylamide, dimethylol acrylamide, dimethylol methacrylamide and the like, alkoxymethyl group-containing monomers, e.g., N-methoxymethylacrylamide, N-methoxymethylmethacryl amide, N-butoxymethyl acrylamide and N-butoxymethyl methacrylamide, hydroxyl group-containing monomers, silyl group-containing monomers, e.g., vinyltrichlorosilane, vinyltrimethoxysilane, vinyltriethoxysilane, tris-2-methoxyethoxyvinylsilane, γ-methacryloxypropyltrimethoxysilane and γ-methacryloxypropylmethyldimethoxysilane and the like are included.

In the present invention, other monomer which can be copolymerized with the crosslinkable radical polymerizable monomer is not particularly limited, but any monomer which can be polymerized in a common radical polymerization or ion polymerization method can be suitably used.

The monomer which can be preferably used may be selected from the following monomer groups (a) to (j) independently and in combination ad libitum.

—Monomer Groups (a) to (j)—
(a) Olefins: ethylene, propylene, vinyl chloride, vinylidene chloride, 6-hydroxy-1-hexene, 4-pentenoic acid, methyl 8-nonenate, vinyl sulfonate, trimethylvinylsilane, trimethoxyvinylsilane, 1,4-divinylcyclohexane, 1,2,5-trivinylcyclohexane and the like.
(b) α,β-Unsaturated carboxylic acids and salts thereof: acrylic acid, methacrylic acid, itaconic acid, maleic acid, sodium acrylate, ammonium methacrylate, potassium itaconate and the like.
(c) α,β-Unsaturated carboxylic acid esters: alkyl acrylate (e.g., methyl acrylate, ethyl acrylate, butyl acrylate, cyclohexyl acrylate, 2-ethylhexyl acrylate, dodecyl acrylate and the like), substituted alkyl acrylate (e.g., 2-chloroethyl acrylate, benzyl acrylate, 2-cyanoethyl acrylate and the like), alkyl methacrylate (e.g., methyl methacrylate, butyl methacrylate, 2-ethylhexyl methacrylate, dodecyl methacrylate and the like), substituted alkyl methacrylate (e.g., 2-hydroxyethyl methacrylate, glycidyl methacrylate, glycerin monomethacrylate, 2-acetoxyethyl methacrylate, tetrahydrofurfuryl methacrylate, 2-methoxyethyl methacrylate, polypropylene glycol monomethacrylate (having number of moles added polyoxypropylene=2 to 100), 3-N,N-dimethylaminopropyl methacrylate, chloro-3-N,N,N-trimethylammoniopropyl methacrylate, 2-carboxyethyl methacrylate, 3-sulfopropyl methacrylate, 4-oxysulfobutyl methacrylate, 3-trimethoxysilylpropyl methacrylate, aryl methacrylate, 2isocyanatoethyl methacrylate and the like), derivatives of an unsaturated dicarboxylic acid (e.g., monobutyl maleate, dimethyl maleate, monomethyl itaconate, dibutyl itaconate and the like), polyfunctional esters (e.g., ethyleneglycol diacrylate, ethyleneglycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, 1,2,4-cyclohexane tetramethacrylate and the like).
(d) Amides of a β-unsaturated carboxylic acid: for example, acrylamide, methacrylamide, N-methylacrylamide, N,N-dimethylacrylamide, N-methyl-N-hydroxyethylmethacrylamide, N-tert-butylacrylamide, N-tert-octylmethacryl amide, N-cyclohexylacrylamide, N-phenylacrylamide, N-(2-acetoacetoxyethyl)acrylamide, N-acryloyl morpholine, diacetone acrylamide, diamide itaconate, N-methylmaleimide, 2-acrylamide-methylpropane sulfonic acid, methylenebisacrylamide, dimethacryloylpiperazine and the like
(e) Unsaturated nitriles: acrylonitrile, methacrylonitrile and the like.
(f) Styrene and derivatives thereof: styrene, vinyltoluene, p-tert-butylstyrene, vinyl benzoate, methylvinyl benzoate, α-methylstyrene, p-chloromethylstyrene, vinylnaphthalene, p-hydroxymethylstyrene, p-styrene sulfonic acid sodium salt, p-styrene sulfinic acid potassium salt, p-aminomethylstyrene, 1,4-divinylbenzene and the like.
(g) Vinyl ethers: methylvinyl ether, butylvinyl ether, methoxyethylvinyl ether and the like.
(h) Vinyl esters: vinyl acetate, vinyl propionate, vinyl benzoate, vinyl salicylate, vinyl chloroacetate and the like.
(i) Other polymerizable monomers: N-vinylimidazole, 4-vinylpyridine, N-vinylpyrrolidone, 2-vinyloxazoline, 2-isopropenyloxazoline, divinylsulfone and the like.

Preferable examples of the crosslinkable radical polymerizable monomer include (2) unsaturated ester compounds of an α,β-ethylenic unsaturated carboxylic acid, (4) unsaturated ester compounds of a polyhydric alcohol, (6) vinyl compounds having a functional group which imparts a crosslinked structure during polymerization, and/or post polymerization.

The polymer having a crosslinked structure is preferably, a copolymer of a crosslinkable radical polymerizable monomer with styrene, acrylic acid, and/or an acrylate ester. Furthermore, in the light of usability of the obtained polymer having a crosslinked structure in an aqueous dispersion having a favorable dispersion state, it is preferably a copolymer having a crosslinkable radical polymerizable monomer, and styrene and acrylic acid as a monomer unit.

The proportion of copolymerization of the crosslinkable radical polymerizable monomer and other monomer is not particularly limited, however, amount of the crosslinkable radical polymerizable monomer to be used is preferably 0.1% by mass or greater and 10% by mass or less, more preferably 0.2% by mass or greater and 7% by mass or less, and still more preferably 0.5% by mass or greater and 5% by mass or less per the entire monomer.

The aqueous dispersion of the polymer having a crosslinked structure of the present invention is obtained by dispersing a water insoluble polymer in the state of fine particles in a water soluble dispersion medium. State of the dispersion may be any one of: emulsified states of the polymer in the dispersion medium: emulsion polymerized states, micelle dispersed states, or molecularly dispersed states of the molecular chain themselves because of a partially hydrophilic structure that is present within the polymer molecule. Polymer latexes are described in ♭Synthetic resin emulsion (edited by Taira Okuda, Hiroshi Inagaki, published by Kobunshi Kankoukai (1978))”, “Application of synthetic latex (edited by Takaaki Sugimura, Yasuo Kataoka, Souichi Suzuki, Keiji Kasahara, published by Kobunshi Kankoukai (1993))”, “Chemistry of synthetic latex (Souichi Muroi, published by Kobunshi Kankoukai (1970))” and each patent publication of JP-A-Nos. 64-538, 7-53831 and 11-217722, and the like.

According to the present invention, the polymer having a crosslinked structure is contained in a coating liquid in the state of an aqueous dispersion. The aqueous dispersion may be any one of latexes in which fine particles of a water insoluble hydrophobic polymer are dispersed in a water-based solvent, those in which polymer molecules are dispersed in the molecular state or forming micelles, and particles dispersed to form a latex are more preferred.

The mean particle size of the dispersed particles is 1 nm or greater and 50000 nm or less, preferably in the range of 5 nm or greater and 1000 nm or less, more preferably in the range of 10 nm or greater and 500 nm or less, and still more preferably in the range of 50 nm or greater and 200 nm or less. The grain size distribution of the dispersed particles is not particularly limited, but the particles may be either ones having a wide grain size distribution or ones having a monodisperse grain size distribution. Use as a mixture of two or more types having a monodisperse grain size distribution is also a preferred method of the use in controlling the physical properties of the coating liquid.

The glass transition temperature (Tg) of the polymer having a crosslinked structure of the present invention is preferably in the range of −30° C. or higher and 70° C. or lower. The glass transition temperature is more preferably −10° C. or higher and 35° C. or lower, and most preferably 0° C. or higher and 35° C. or lower. When the Tg is lower than −30° C., a film having inferior thermostable strength is provided although film-forming performance is excellent, while the Tg being higher than 70° C. is not preferred because insufficient film-forming performance is achieved although the polymer has excellent thermostable strength. It should be noted that preparation using two or more polymers is permitted to achieve such Tg. In other words, even though the polymer has the Tg out of the range described above, the weight average Tg thereof preferably falls within the range.

Specific examples are illustrated below, however, the present invention is not limited to these compounds.
KP-1; latex of -MMA (41.5) -BA (56) -AA (2) -EGDMA (0.5) (Tg: 9.0° C.)
KP-2; latex of -MMA (41) -BA (56) -AA (2) -EGDMA (1) (Tg: 8.7° C.)
KP-3; latex of -MMA (40) -BA (56) -AA (2) -EGDMA (2) (Tg: 8.0° C.)
KP-4; latex of -St (42) -MAA (2) -AAm (1) -2EHA (54.4) -EGDMA (0.6) (Tg: 4.0° C.)
KP-5; latex of -St (58) -MAA (2) -AAm (1) -2EHA (38.8) -EGDMA (0.2) (Tg: 25° C.)
KP-6; latex of -St (58) -MAA (2) -AAm (1) -2EHA (38.4) -γ-MS (0.6) (Tg: 23° C.)
KP-7; latex of -St (58) -MAA (2) -AAm (1) -2EHA (38) -DVB (0.6) (Tg: 22° C.)
KP-8; latex of -St (58) -MAA (2) -AAm (0.6) -2EHA (38.8) -EGDMA (0.6) (Tg: 23° C.)
KP-9; latex of -St (58) -MAA (2) -AAm (1.4) -2EHA (38) -EGDMA (0.6) (Tg: 23° C.)
KP-10; latex of -St (53) -MAA (2) -AAm (1) -2EHA (43.4) -EGDMA (0.6) (Tg: 18° C.)
KP-11; latex of -St (58) -MAA (2) -2EHA (39.4) -EGDMA (0.6) (Tg: 22° C.)
KP-12; latex of -St (57) -MAA (2) -AAm (1) -2EHA (37) -EGDMA (3) (Tg: 14° C.)
KP-13; latex of -St (37.4) -MAA (2) -AAm (3) -2EHA (57) -EGDMA (0.6) (Tg: 3.0° C.)
KP-14; latex of -BA (50) -AA (2) -St (46) -EGDMA (2) (Tg: 24° C.)
KP-15; latex of -BA (50) -AA (2) -St (46) -DVB (2) (Tg: 26° C.)
KP-16; latex of -BA (50) -AA (2) -St (47) -γ-MS (1) (Tg: 27° C.)
KP-17; latex of -BA (50) -AA (2) -St (47) -EGDMA (1) (Tg: 27° C.)
KP-18; latex of -BA (56) -MMA (38) -AA (2) -DVB (2) (Tg: 5° C.)
KP-19; latex of -BA (56) -MMA (39) -AA (2) -γ-MS (1) (Tg: 4° C.)
KP-20; latex of -BA (56) -MMA (39) -AA (2) -DVB (1) (Tg: 5° C.)

Moreover, latexes for comparison used in Examples described below are as follows.
CKP-1; latex of -MMA (42) -BA (56) -AA (2) (Tg: 10.8° C.)
CKP-2; latex of -BA (50) -AA (2) -St (48) (Tg: 23° C.)
CKP-3; latex of -EA (96.4) -AA (3.6) (Tg: −20° C.)

Abbreviations described above represent the following monomers. MMA; methyl methacrylate, MAA; methacrylic acid, 2EHA; 2-ethylhexyl acrylate, St; styrene, AA; acrylic acid, AAm; acrylamide, DVB; divinylbenzene, γ-MS; γ-methacryloxypropyltrimethoxysilane, BA; butyl acrylate, EGDMA; ethyleneglycol dimethacrylate. Values in parentheses in the aforementioned structure are based on “% by mass”.

Examples of commercially available products include NAL Star MR-174, MR-170 and MR-180 (foregoings are manufactured by NIPPON A&L INC.) and the like.

In the present invention, the construction layer is preferably prepared by coating a waterbased coating liquid followed by drying. The “water-based” referred to herein means that the solvent of the coating liquid (dispersion medium) contains water in an amount of 60% by mass or greater. Examples of the ingredient which may be used other than water in the coating liquid include water miscible organic solvents such as methyl alcohol, ethyl alcohol, isopropyl alcohol, methyl cellosolve, ethyl cellosolve, dimethylformamide, ethyl acetate, diacetone alcohol, furfuryl alcohol, benzyl alcohol, diethyleneglycol monoethyl ether and oxyethylphenyl ether.

The aqueous dispersion of the polymer having a crosslinked structure is included in an amount of preferably 90% by mass or greater and 100% by mass or less per total amount of the binder in the outermost layer, and more preferably, it is included in an amount of 92% by mass or greater and 100% by mass or less. The amount of less than 90% by mass is not preferred because the effect of preventing penetration of the moisture is deteriorated. The polymer having a crosslinked structure herein is contained in the state of an aqueous dispersion, however, the aforementioned percentage content is indicated based on the amount of the solid content of the polymer having a crosslinked structure, which excludes the moisture content.

In the outermost layer of the present invention, examples of the binder which can be used in combination with the polymer having a crosslinked structure include the following hydrophobic polymers and hydrophilic polymers.

Examples of the latex of preferred hydrophobic polymer which can be used in combination include latexes which can be used in the nonphotosensitive layer of the present invention described below, for example, latexes of polyacrylate, polyurethane, polymethacrylate or copolymers comprising the same. The aqueous dispersion of the hydrophobic polymer may be used alone, or may be used through blending two or more thereof as needed. The content of the hydrophobic polymer used in combination is preferably 3% by mass or greater and 60% by mass or less, and more preferably 5% by mass or greater and 50% by mass or less per the entire coating liquid for outermost layer. The amount of coating of the hydrophobic polymer which is used in combination for the outermost layer is preferably 0.1 g/m² or greater and 10 g/m² or less, more preferably 0.2 g/m² or greater and 5 g/m² or less, and most preferably 0.5 g/m² or greater and 3 g/m² or less.

Also, a water soluble polymer may be used as a binder in combination for the outermost layer of the present invention in the range not to exceed 50% by mass of total amount of the binder in the outermost layer. A hydrophilic polymer such as gelatin, polyvinyl alcohol, methyl cellulose, hydroxypropyl cellulose or carboxymethyl cellulose may be added as needed. Specifically, examples thereof include hydrophilic polymers which can be used in the nonphotosensitive layer described below. When the hydrophilic polymer is used in combination, the content of the aqueous dispersion of the hydrophobic polymer is preferably 80% by mass or greater and 100% by mass or less, and more preferably 90% by mass or greater and 100% by mass or less in the binder in the outermost layer as described above.

A film formation aid may be also added in order to control the minimum film-forming temperature of the aqueous dispersion of the polymer having a crosslinked structure or the aqueous dispersion of the hydrophobic polymer. The film formation aid is also called a temporary plasticizer, which is an organic compound (in general, organic solvent) that lowers the minimum film formation temperature of the polymer latex, and is described in, for example, the aforementioned “Chemistry of synthetic latex (Souichi Muroi, published by Kobunshi Kankoukai (1970)). Although exemplary preferred film formation aids include the following compounds, the compounds which can be used in the present invention are not limited to the following specific examples.
Z-1: benzyl alcohol
Z-2: 2,2,2,4-trimethylpentanediol-1,3-monoisobutyrate
Z-3: 2-dimethylaminoethanol
Z4: diethylene glycol

In the present invention, it is preferred that a crosslinking agent is contained in any layer of the image forming layer sides. More preferably, a crosslinking agent is added to the outermost layer or the nonphotosensitive intermediate layer explained below. By adding a crosslinking agent, hydrophobicity/water resisting property of the outermost layer or the nonphotosensitive intermediate layer may be increased, thereby yielding an excellent photothermographic material.

The crosslinking agent may merely include a plurality of groups that react with a carboxyl group within the molecule, and the type of the crosslinking agent is not particularly limited. Examples of the crosslinking agent are described in T. H. James, “THE THEORY OF THE PHOTOGRAPHIC PROCESS FOURTH EDITION” (published by Macmillan Publishing Co., Inc. in 1977) pp. 77 to 87. Although any one of crosslinking agents of an inorganic compound (e.g., chromium alum) and crosslinking agents of an organic compound is preferred, a crosslinking agent of an organic compound is more preferred.

Examples of preferred compound as the crosslinking agent of an organic compound include carboxylic acid derivatives, carbamic acid derivatives, sulfonic acid ester compounds, sulfonyl compounds, epoxy compounds, aziridine compounds, isocyanate compounds, carbodiimide compounds, and oxazoline compounds. More preferable examples include epoxy compounds, isocyanate compounds, carbodiimide compounds and oxazoline compounds. These crosslinking agents may be used alone, or may be used in combination of two or more types thereof.

Specifically, the following compounds can be exemplified, but the present invention is not limited to the examples below.

(Carbodiimide Compound)

A water soluble or water dispersible carbodiimide compound is preferred, and examples thereof include polycarbodiimide derived from isophorone diisocyanate described in JP-A No. 59-187029 and JP-B No. 5-27450; carbodiimide compounds derived from tetramethylxylylene diisocyanate described in JP-A No. 7-330849; other branched carbodiimide compounds described in JP-A No. 10-30024; and carbodiimide compounds derived from dicyclohexylmethane diisocyanate described in JP-A No. 2000-7642.

(Oxazoline Compound)

A water soluble or water dispersible oxazoline compound is preferred, and examples thereof include oxazoline compounds described in JP-A No. 2001-215653.

(Isocyanate Compound)

Because it is a compound which can react with water, a water dispersible isocyanate compound is preferred in the light of the pot life, and in particular, an isocyanate compound having self emulsifying property is preferred. Examples thereof include water dispersible isocyanate compounds described in JP-A Nos. 7-304841, 8-277315, 10-45866, 9-71720, 9-328654, 9-104814, 2000-194045, 2000-194237 and 2003-64149.

(Epoxy Compound)

A water soluble or water dispersible epoxy compound is preferred. Examples thereof include water dispersible epoxy compounds described in JP-A Nos. 6-329877 and 7-309954.

More specific examples of the crosslinking agent which may be used in the present invention are illustrated below, however, the present invention is not limited to the following examples.

(Epoxy Compound)
Trade name: DIC Fine EM-60 (Dainippon Ink and Chemicals, Incorporated)

(Isocyanate Compound)
Trade name: DURANATE WB40-100 (Asahi Kasei Corporation)
   DURANATE WB40-80D (Asahi Kasei Corporation)
   DURANATE WT20-100 (Asahi Kasei Corporation)
   DURANATE WT30-100 (Asahi Kasei Corporation)
   CR-60N (Dainippon Ink and Chemicals)

(Carbodiimide Compound)
Trade name: CARBODILITE V-02 (Nisshinbo Industries, Inc.)
CARBODILITE V402-L2 (Nisshinbo Industries, Inc.)
   CARBODILITE V-04 (Nisshinbo Industries, Inc.)
   CARBODILITE V-06 (Nisshinbo Industries, Inc.)
   CARBODILITE E-01 (Nisshinbo Industries, Inc.)
   CARBODILITE E-02 (Nisshinbo Industries, Inc.)

(Oxazoline Compound)
Trade name: EPOCROS K-1010E (Nippon Shokubai Co., Ltd.)
   EPOCROS K-1020E (Nippon Shokubai Co., Ltd.)
   EPOCROS K-1030E (Nippon Shokubai Co., Ltd.)
   EPOCROS K-2010E (Nippon Shokubai Co., Ltd.)
   EPOCROS K-2020E (Nippon Shokubai Co., Ltd.)
   EPOCROS K-2030E (Nippon Shokubai Co., Ltd.)
   EPOCROS WS-500 (Nippon Shokubai Co., Ltd.)
   EPOCROS WS-700 (Nippon Shokubai Co., Ltd.)

The crosslinking agent for use in the present invention may be added in the state previously admixed in a binder solution, or may be added finally in the step for preparing the coating liquid. Alternatively, it may be added immediately before coating.

The amount of the crosslinking agent used in the present invention is preferably 0.5 to 200 parts by mass, more preferably 2 to 100 parts by mass, and still more preferably 3 to 50 parts by mass per 100 parts by mass of the binder in the construction layer where the agent is contained.

It is preferred that a thickening agent is added to the coating liquid for forming the outermost layer. Addition of the thickening agent is preferred because a hydrophobic layer having a uniform thickness can be formed. Examples of the thickening agent include e.g., alkali metal salts of polyvinyl alcohol, hydroxyethyl cellulose or carboxymethyl cellulose. However, taking into account convenience in handling, thixotropic ones are preferred. Thus, hydroxyethyl cellulose, sodium hydroxymethyl carboxylate or carboxymethyl-hydroxyethyl cellulose may be used. Furthermore, the viscosity of the coating liquid for nonphotosensitive intermediate layer to which the thickening agent is added is preferably 1 mPa.s or greater and 200 mPa.s or less, more preferably 10 mPa.s or greater and 100 mPa.s or less, and still more preferably 15 mPa.s or greater and 60 mPa.s or less at 40° C.

In addition to the binder, any one of a variety of additives may be added to the outermost layer. Examples of the additive include matting agents, slipping agents, surface active agents, pH adjusting agents, antiseptics, fungicides and the like, all of which described later as an additive.

(2) First Nonphotosensitive Layer

In the present invention, it is preferred that a first nonphotosensitive layer is provided. The first nonphotosensitive layer in the present invention is provided on the side of the image forming layer, between the outermost layer and the image forming layer. The first nonphotosensitive layer preferably contains a binder which can be gelated upon drop of the temperature. The binder which can be gelated refers to a water soluble polymer derived from an animal protein as described below, or a hydrophobic polymer or a water soluble polymer which is not derived from an animal protein to which a gelling agent is added thereto. Because fluidity of the layer which was formed by the coating is lost or lowered through the gelation, the surface on the side of the image forming layer becomes hardly susceptible to wind for drying in the drying step following the coating step. Accordingly, a photothermographic material which gives a coated surface having a uniform state can be obtained. It is important that the coating liquid is not gelated upon coating. Taking into account ease of operation, the coating liquid has fluidity during coating, but looses the fluidity through gelation at the timing point prior to starting the drying step following the coating. The viscosity of the coating liquid upon coating is preferably 5 mPa.s or greater and 200 mPa.s or less, and more preferably 10 mPa.s or greater and 100 mPa.S or less.

In the present invention, a water-based solvent is used as the solvent for the coating liquid. The water-based solvent refers to water or a mixture of water and 70% by mass or less of a water miscible organic solvent. Examples of the water miscible organic solvent include e.g., alcohols such as methyl alcohol, ethyl alcohol and propyl alcohol; cellosolves such as methyl cellosolve, ethyl cellosolve and butyl cellosolve; ethyl acetate, dimethyl formamide and the like.

Although it is difficult to measure the viscosity of the formed layer at the timing point prior to starting the drying step following the coating (gelation has been already caused at this timing point), the viscosity is assumed to be approximately 200 mPa.s or greater and 5000 mPa.s or less, and preferably approximately 500 mPa.s or greater and 5000 mPa.s or less.

The temperature for the gelation is not particularly limited, however, taking into account the operating efficiency of coating, the temperature of the gelation is preferably nearly the room temperature. The room temperature is: a temperature which enables the fluidity of the coating liquid to increase such that the coating is facilitated; a temperature which allows the fluidity to be kept (i.e., an approximate temperature in the range which enables the elevated temperature to be kept with ease); and a temperature which can be readily cooled down for eliminating the fluidity of the formed layer after the coating. Specifically, preferred temperature for the gelation is 0° C. or higher and 40° C. or lower, and more preferably 0° C. or higher and 35° C. or lower.

The temperature of the coating liquid upon coating is not particularly limited as long as it is set to be higher than the gelation temperature. Also, the cooling temperature before the drying step following coating is not particularly limited as long as it is set to be lower then the gelation temperature. However, when the difference between the temperature of the coating liquid and the cooling temperature is set to be small, gelation may be initiated while coating, thereby raising problems of impossible coating to give a uniform film, and the like. Furthermore, when the temperature of the coating liquid is set to be too high in order to increase the difference between these temperatures, the solvent in the coating liquid may evaporate, thereby raising problems of change of the viscosity. Therefore, it is desired that the difference in temperature is set to be preferably 5° C. or greater and 50° C. or less, and more preferably 10C or greater and 40° C. or less.

The first nonphotosensitive layer is not particularly limited as long as it is provided on the side of the image forming layer with respect to the support, and between the image forming layer and the outermost layer, however, it is preferably provided between the second nonphotosensitive intermediate layer explained below and the outermost layer. In particular, it is preferably a layer which is adjacent to the outermost layer, in the light of suppression of unevenness of the film face which may be caused during drying with window. More specifically, preferred layer construction may include the outermost layer, the first nonphotosensitive layer, the second nonphotosensitive layer, and the image forming layer, in this order starting from the outermost layer. A layer other than these layers may be also provided.

(Explanation of Water Soluble Polymer Derived from Animal Protein)

In the present invention, the polymer derived from an animal protein refers to any one of naturally occurring or chemically modified water soluble polymers such as glue, casein, gelatin and albumen. Preferably, the polymer is gelatin which may include acid-treated gelatin and alkali-treated gelatin (lime treatment or the like) depending on the synthesis method thereof, and any one of them can be preferably used. It is preferred that gelatin having a number average molecular weight of 10,000 to 1,000,000 is used. Also, denatured gelatin may be used prepared by subjecting to a denaturing treatment utilizing the amino group or carboxyl group of gelatin (e.g., phthalate gelatin or the like). An aqueous solution containing gelatin is solated when it is warmed to a temperature of 30° C. or higher, and when the temperature is reduced to a lower temperature, gelation is caused to loose the fluidity. Because such sol-gel transformation reversibly occurs depending on the temperature, an aqueous solution containing gelatin that is a coating liquid has a setting property to lose fluidity when it is cooled to a temperature lower than 30° C. Furthermore, the water soluble polymer derived from an animal protein can be used together with a water soluble polymer which is not derived from an animal protein as described below, and/or a hydrophobic polymer. The content of the water soluble polymer derived from an animal protein in the coating liquid is 1% by mass or greater and 20% by mass or less, and preferably 2% by mass or greater and 12% by mass or less per the entire coating liquid.

(Explanation of Water Soluble Polymer that is Not Derived From Animal Protein)

Examples of the water soluble polymer which is not derived from an animal protein in the present invention include natural macromolecules other than animal proteins such as gelatin (polysaccharide-based, microorganism-based, animal-based), semisynthetic macromolecules (cellulose-based, starch-based, alginic acid-based) and synthetic macromolecules (vinyl-based, and others), and synthetic polymers including polyvinyl alcohols and natural or semisynthetic polymers comprising a material derived from a plant such as cellulose as described below may be included. Preferable examples include polyvinyl alcohols, and acrylic acid-vinyl alcohol copolymerized polymers. The water soluble polymer which is not derived from an animal protein does not have a setting property, therefore, when the water soluble polymer which is not derived from an animal protein is used for the layer which is adjacent to the outermost layer, it should be used together with the gelling agent described later.

1)Polyvinyl Alcohols

The water-soluble polymer that is not derived from animal protein in the present invention is preferably polyvinyl alcohols.

As the polyvinyl alcohols (PVA) preferably used in the present invention, there are compounds that have various degree of saponification, degree of polymerization, degree of neutralization, modified compound and copolymer with various monomers as described below.

As fully saponified compound, it can be selected among PVA-105 [polyvinyl alcohol (PVA) content: 94.0% by mass or more, degree of saponification: 98.5±0.5 mol %, content of sodium acetate: 1.5% by mass or less, volatile constituent: 5.0% by mass or less, viscosity (4% by mass at 20° C/): 5.6±0.4 CPS], PVA-110 [PVA content: 94.0% by mass, degree of saponification: 98.5±0.5 mol %, content of sodium acetate: 1.5% by mass, volatile constituent: 5.0% by mass, viscosity (4% by mass at 20° C.): 11.0±0.8 CPS], PVA-117 [PVA content: 94.0% by mass, degree of saponification: 98.5±0.5 mol %, content of sodium acetate: 1.0% by mass, volatile constituent: 5.0% by mass, viscosity (4% by mass at 20° C.): 28.0±3.0 CPS], PVA-117H [PVA content: 93.5% by mass, degree of saponification: 99. 6±0.3 mol %, content of sodium acetate: 1.85% by mass, volatile constituent: 5.0% by mass, viscosity (4% by mass at 20° C.): 29.0±0.3 CPS], PVA-120 [PVA content: 94.0% by mass, degree of saponification: 98.5±0.5 mol %, content of sodium acetate: 1.0% by mass, volatile constituent: 5.0% by mass, viscosity (4% by mass at 20° C.): 39.5±4.5 CPS], PVA-124 [PVA content: 94.0% by mass, degree of saponification: 98.5±0.5 mol %, content of sodium acetate: 1.0% by mass, volatile constituent: 5.0% by mass, viscosity (4% by mass at 20° C.): 60.0±6.0 CPS], PVA-124H [PVA content: 93.5% by mass, degree of saponification: 99.6±0.3 mol %, content of sodium acetate: 1.85% by mass, volatile constituent: 5.0% by mass, viscosity (4% by mass at 20° C.): 61.0±6.0 CPS], PVA-CS [PVA content: 94.0% by mass, degree of saponification: 97.5±0.5 mol %, content of sodium acetate: 1.0% by mass, volatile constituent: 5.0% by mass, viscosity (4% by mass at 20° C.): 27.5±3.0 CPS], PVA-CST [PVA content: 94.0% by mass, degree of saponification: 96.0±0.5 mol %, content of sodium acetate: 1.0% by mass, volatile constituent: 5.0% by mass, viscosity (4% by mass at 20° C.): 27.0±3.0 CPS], PVA-HC [PVA content: 90.0% by mass, degree of saponification: 99.85 mol % or more, content of sodium acetate: 2.5% by mass, volatile constituent: 8.5% by mass, viscosity (4% by mass at 20° C.): 25.0±3.5 CPS] (above all trade names, produced by Kuraray Co., Ltd.), and the like.

As partial saponified compound, it can be selected among PVA-203 [PVA content: 94.0% by mass, degree of saponification: 88.0±1.5 mol %, content of sodium acetate: 1.0% by mass, volatile constituent: 5.0% by mass, viscosity (4% by mass at 20° C.): 3.4±0.2 CPS], PVA-204[PVA content: 94.0% by mass, degree of saponification: 88.0±1.5 mol %, content of sodium acetate: 1.0% by mass, volatile constituent: 5.0% by mass, viscosity (4% by mass at 20° C.): 3.9±0.3 CPS], PVA-205 [PVA content: 94.0% by mass, degree of saponification: 88.0±1.5 mol %, content of sodium acetate: 1.0% by mass, volatile substance: 5.0% by mass, viscosity (4% by mass at 20° C.): 5.0±0.4 CPS], PVA-210 [PVA content: 94.0% by mass, degree of saponification: 88.0±1.0 mol %, content of sodium acetate: 1.0% by mass, volatile constituent: 5.0% by mass, viscosity (4% by mass at 20° C.): 9.0±1.0 CPS], PVA-217 [PVA content: 94.0% by mass, degree of saponification: 88.0±1.0 mol %, content of sodium acetate: 1.0% by mass, volatile constituent: 5.0% by mass, viscosity (4% by mass at 20° C.): 22.5±2.0 CPS], PVA-220 [PVA content: 94.0% by mass, degree of saponification: 88.0±1.0 mol %, content of sodium acetate: 1.0% by mass, volatile constituent: 5.0% by mass, viscosity (4% by mass at 20° C.): 30.0±3.0 CPS], PVA-224 [PVA content: 94.0% by mass, degree of saponification: 88.0±1.5 mol %, content of sodium acetate: 1.0% by mass, volatile constituent: 5.0% by mass, viscosity (4% by mass at 20° C.): 44.0±4.0 CPS], PVA-228 [PVA content: 94.0% by mass, degree of saponification: 88.0±1.5 mol %, content of sodium acetate: 1.0% by mass, volatile constituent: 5.0% by mass, viscosity (4% by mass at 20° C.): 65.0±5.0 CPS], PVA-235 [PVA content: 94.0% by mass, degree of saponification: 88.0±1.5 mol %, content of sodium acetate: 1.0% by mass, volatile constituent: 5.0% by mass, viscosity (4% by mass at 20° C.): 95.0±15.0 CPS], PVA-217EE [PVA content: 94.0% by mass, degree of saponification: 88.0±1.0 mol %, content of sodium acetate: 1.0% by mass, volatile constituent: 5.0% by mass, viscosity (4% by mass at 20° C.): 23.0±3.0 CPS], PVA-217E [PVA content: 94.0% by mass, degree of saponification: 88.0±1.0 mol %, content of sodium acetate: 1.0% by mass, volatile constituent: 5.0% by mass, viscosity (4% by mass at 20° C.): 23.0±3.0 CPS], PVA-220E [PVA content: 94.0% by mass, degree of saponification: 88.0±1.0 mol %, content of sodium acetate: 1.0% by mass, volatile constituent: 5.0% by mass, viscosity (4% by mass at 20° C.): 31.0±4.0 CPS], PVA-224E [PVA content: 94.0% by mass, degree of saponification: 88.0±1.0 mol %, content of sodium acetate: 1.0% by mass, volatile constituent: 5.0% by mass, viscosity (4% by mass at 20° C.): 45.0±5.0 CPS], PVA403 [PVA content: 94.0% by mass, degree of saponification: 80.0±1.5 mol %, content of sodium acetate: 1.0% by mass, volatile constituent: 5.0% by mass, viscosity (4% by mass at 20° C.): 3.1±0.3 CPS], PVA-405 [PVA content: 94.0% by mass, degree of saponification: 81.5±1.5 mol %, content of sodium acetate: 1.0% by mass, volatile constituent: 5.0% by mass, viscosity (4% by mass at 20° C.): 4.8±0.4 CPS], PVA-420 [PVA content: 94.0% by mass, degree of saponification: 79.5±1.5 mol %, content of sodium acetate: 1.0% by mass, volatile constituent: 5.0% by mass], PVA-613 [PVA content: 94.0% by mass, degree of saponification: 93.5±1.0 mol %, content of sodium acetate: 1.0% by mass, volatile constituent: 5.0% by mass, viscosity (4% by mass at 20° C.): 16.5±2.0 CPS], L-8 [PVA content: 96.0% by mass, degree of saponification: 71.0±1.5 mol %, content of sodium acetate: 1.0% by mass (ash), volatile constituent: 3.0% by mass, viscosity (4% by mass at 20° C.): 5.4±0.4 CPS] (above all are trade names, produced by Kuraray Co., Ltd.), and the like.

The above values were measured in the manner described in JISK-6726-1977.

As modified polyvinyl alcohol, it can be selected among cationic modified compound, anionic modified compound, modified compound by —SH compound, modified compound by alkylthio compound and modified compound by silanol. Further the modified polyvinyl alcohol described in “POVAL”(Koichi Nagano et. al., edited by Koubunshi Kankoukai) can be used.

As this modified polyvinyl alcohol (modified PVA), there are C-118, C-318, C-318-2A, C-506 (above all are trade names, produced by Kuraray Co., Ltd.) as C-polymer, HL-12E, HL-1203 (above all are trade name, produced by Kuraray Co., Ltd.) as HL-polymer, HM-03, HM-03 (above all are trade marks, produced by Kuraray Co., Ltd.) as HM-polymer, KL-118, KL-318, KL-506, KM-118T, KM-618 (trade mark, produced by Kuraray Co., Ltd.) as K-polymer, M-115 (trade mark, produced by Kuraray Co., Ltd.) as M-polymer, MP-102, MP-202, MP-203 (above all are trade mark, produced by Kuraray Co., Ltd.) as MP-polymer, MPK-1, MPK-2, MPK-3, MPK4, MPK-5, MPK-6 (above all are trade marks, produced by Kuraray Co., Ltd.) as MPK-polymer, R-1130, R-2105, R-2130 (above all are trade marks, produced by Kuraray Co., Ltd.) as R-polymer, V-2250 (trade mark, produced by Kuraray Co., Ltd.) as V-polymer and the like.

Viscosity of aqueous solution of polyvinyl alcohol can be controlled or stabilized by addition of small amount of solvent or inorganic salts, which are described in detail in above literature “POVAL” (Koichi Nagano et. al., edited by Koubunshi Kankoukai, pages 144 to 154). The typical example preferably is to imcorporate boric acid to improve the surface quality of coating. The addition amount of boric acid preferably is from 0.01% by mass to 40% by mass with respect to polyvinyl alcohol.

It is also described in abovenentioned “POVAL” that the crystallization degree of polyvinyl alcohol is improved and waterproof property is improved by heat treatment. The binder can be heated at coating-drying process or can be additionally subjected to heat treatment after drying, and therefore, polyvinyl alcohol, which can be improved in waterproof property during those processes, is particularly preferable among water-soluble polymers.

Furthermore, it is preferred that a waterproof improving agent such as those described in above “POVAL” (pages 256 to 261) is added. As examples, there can be mentioned aldehydes, methylol compounds (e.g., N-methylolurea, N-methylolmelamine and the like), active vinyl compounds (divinylsulfones and their derivatives and the like), bis(3-hydroxyethylsulfones), epoxy compounds (epichlorohydrins and their derivatives and the like), polyvalent carboxylic acids (dicarboxylic acids, polyacrylic acid as polycarboxylic acids, methyl vinyl ether/maleic acid copolymers, isobutylene/maleic anhydride copolymers and the like), diisocyanates, and inorganic crosslinking agents (Cu, B, Al, Ti, Zr, Sn, V, Cr and the like).

In the present invention, inorganic crosslinking agents are preferable as a waterproof improving agent. Among these inorganic crosslinking agents, boric acids and their derivative are preferred and boric acid is particularly preferable. Specific examples of boric acid derivatives are shown below.

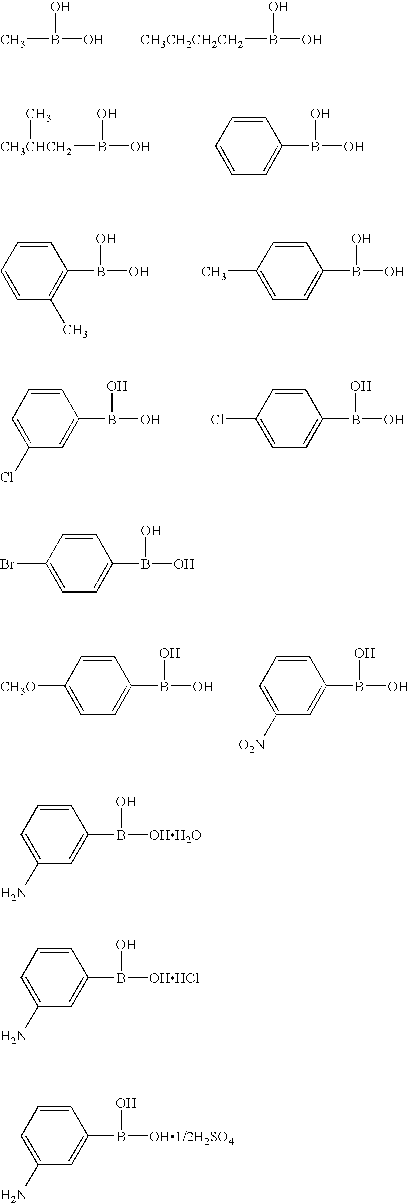

The addition amounts of these waterproof improving agents are preferably in the range from 0.01% by mass to 40% by mass with respect to polyvinyl alcohol.

Other Water-Soluble Polymers

Water-soluble polymers which are not derived from animal protein in the present invention besides abovenentioed polyvinyl alcohols are described below.

As typical examples, plant polysaccharides, such as gum arabic, κ-carrageenan, ι-carrageenan, λ-carrageenan, guar gum (Supercol produced by SQUALON Co. and the like), locust bean gum, pectin, tragacanth gum, corn starch (Purity-21 produced by National Starch & Chemical Co. and the like), starch phosphate (National 78-1898 produced by National Starch & Chemical Co. and the like) are included.

Also as polysaccharides derived from microorganism, xanthan gum (Keltrol T produced by KELCO Co. and the like), dextrin (Nadex 360 produced by National Starch & Chemical Co. and the like) and as animal polysaccharides, sodium chondroitin sulfate (Cromoist CS produced by CRODA Co. and the like) and the like are included.

And as cellulose polymer, ethyl cellulose (Cellofas WLD produced by I.C.I. Co. and the like), carboxymethyl cellulose (CMC produced by Daicel Chemical Industries, Ltd. and the like), hydroxyethyl cellulose (HEC produced by Daicel Chemical Industries, Ltd. and the like), hydroxypropyl cellulose (Klucel produced by AQUQLON Co. and the like), methyl cellulose (Viscontran produced by HENKEL Co. and the like), nitrocellulose (Isopropyl Wet produced by HELCLES Co. and the like) and cationized cellulose (Crodacel QM produced by CRODA Co. and the like) are included. As alginic acid series, sodium alginate, (Keltone produced by KELCO Co. and the like), propylene glycol alginate and the like and as other classification, cationized guar gum (Hi-care 1000 produced by ALCOLAC Co. and the like) and sodium hyaluronate (Hyalure produced by Lifecare Biomedial Co. and the like) are included.

As others, agar, furcelleran, guar gum, karaya gum, larch gum, guar seed gum, psylium seed gum, kino's seed gum, tamarind gum, tara gum and the like are included. Among them, highly water-soluble compound is preferable and the compound in which can solution sol-gel conversion can occur within 24 hours at a temperature change in the range of 5° C. to 95° C. is preferably used.

As for synthetic polymers, sodium polyacrylate, polyacrylic acid copolymers, polyacrylamide, polyacrylamide copolymers and the like as acryl series, polyvinyl pyrrolidone, polyvinyl pyrrolidone copolymers and the like as vinyl series and polyethylene glycols, polypropylene glycols, polyvinyl ethers, polyethylene imines, polystyrene sulfonic acid and copolymers thereof, polyvinyl sulfanic acid and copolymers thereof, polyacrylic acid and copolymer thereof, acrylic acid and copolymers thereof, maleic acid copolymers, maleic acid monoester copolymers, acryloylmethylpropane sulfonic acid and its copolymers, and the like are included.

Highly water absorbable polymers described in U.S. Pat. No. 4,960,681, JP-A No. 62-245260 and the like, namely such as homopolymers of vinyl monomer having —COOM or —SO₃M (M represents a hydrogen atom or an alkali metal) or copolymers of their vinyl monomers or other vinyl monomers (e.g., sodium methacrylate, ammonium methacrylate and Sumikagel L-5H produced by SUMITOMO KAGAKU Co.) can be also used.

Among these, Sumikagel L-5H produced by SUMITOMO KAGAKU Co.) is preferably used as the water-soluble polymer.

The concentration in the coating liquid is preferably adjusted such that the viscosity yielded upon the addition falls within a value which is suited for simultaneous superposition coating, although it is not particularly limited. In general, the concentration in the liquid is 0.01% by mass or greater and 30% by mass or less, more preferably 0.05% by mass or greater and 20% by mass or less, and particularly preferably 0.1% by mass or greater and 10% by mass or less. The viscosity thus obtained is preferably 1 mPa.s or greater and 200 mPa.s or less, and more preferably 5 mPa.s or greater and 100 mPa.s or less, as an increment from the initial viscosity. For reference, the viscosity is represented by a value obtained by the measurement carried out at 25° C. using a type B rotary viscometer. Although the glass transition temperature of the water soluble polymer which is preferably used in the present invention is not particularly limited, it is preferably 60° C. or higher and 220° C. or lower in the light of brittleness such as a belt mark resulting from the thermal development and generation of dusts during the processing. The glass transition temperature is more preferably 70° C. or higher and 200° C. or lower, still more preferably 80° C. or higher and 180° C. or lower, and most preferably 90° C. or higher and 170° C. or lower.

A polymer which can be dispersed in the water-based solvent may be used in combination with the water soluble polymer which is not derived from an animal protein in the present invention. Examples of suitable polymer which can be dispersed in the water-based solvent include synthetic resins, polymers and copolymers, as well as media that form a film, e.g., cellulose acetates, cellulose acetate butyrates, poly(methyl methacrylates), poly(vinyl chlorides), poly(methacrylic acids), styrene-maleic anhydride copolymers, styrene-acrylonitrile copolymers, styrene-butadiene copolymers, poly(vinyl acetals) (e.g., poly(vinyl formals) and poly(vinyl butyral)), poly(esters), poly(urethanes), phenoxy resins, poly(vinylidene chlorides), poly(epoxides), poly(carbonates), poly(vinyl acetates), poly(olefins), cellulose esters, poly(amides) and the like. Preferred latexes are described in the section of “Latex polymer” below. These latexes are preferably mixed in an amount of 1% by mass or greater and 70% by mass or less, and preferably 5% by mass or greater and 50% by mass or less per the water soluble polymer which is not derived from an animal protein.

(Explanation of Gelling Agent)

The gelling agent in the present invention is a substance that causes gelation by cooling a solution prepared by the addition to an aqueous solution of the water soluble polymer which is not derived from an animal protein or to an aqueous latex solution of a hydrophobic polymer of the present invention, or alternatively, a substance that causes gelation by using an additional gelation promoting agent in combination. Fluidity is markedly reduced by causing the gelation.

Specific examples of the gelling agent include the following water soluble polysaccharides, i.e., at least one selected from agar, κ-carageenan, ι-carageenan, alginic acid, alginic acid salts, agarose, furcellaran, gellan gum, gluconodeltalactone, Azotobacter vinelandii gum, xanthan gum, pectin, guar gum, locust bean gum, Tara gum, Cassia gum, glucomannan, Tragacanth gum, Kayaya gum, pullulan, gum arabic, arabinogalactan, dextran, carboxymethyl cellulose sodium salts, methyl cellulose, psyllium seed gum, starch, chitin, chitosan and curdlan.

Examples of substances which are gelated by cooling after heating to allow dissolution include agar, carageenan, gellan gum and the like.

Among these gelling agents, examples of more preferred compound include κ-carageenan (e.g., K-9F, manufactured by Taito Co., Ltd., and K-15: K-21 to 24, 1-3, manufactured by Nitta Gelatin Inc.), ι-carageenan and agar. Particularly preferred gelling agent is κ-carageenan.

It is preferred that the gelling agent is used in an amount of 0.01% by mass or greater and 10.0% by mass or less, preferably 0.02% by mass or greater and 5.0% by mass or less, and more preferably 0.05% by mass or greater and 2.0% by mass or less per the binder polymer.

The gelling agent is preferably used together with a gelation accelerator. The gelation accelerator according to the present invention is a compound which accelerates gelation through the contact with a gelling agent, and exerts the function depending on specific combinations with the gelling agent. According to the present invention, exemplary combinations of the gelling agent and the gelation accelerator which may be utilized include the combinations as described below.

1) Combinations of an alkali metal ion such as potassium or an alkaline earth metal ion such as calcium or magnesium as a gelation accelerator, and carageenan, an alginic acid salt, gellan gum, azotobacter vinelandii gum, pectin, carboxymethyl cellulose sodium or the like as a gelling agent.

2) Combinations of boric acid or other boron compound as a gelation accelerator, and guar gum, locust bean gum, Tara gum, Cassia gum or the like as a gelling agent.

3) Combinations of acid or alkali as a gelation accelerator, and an alginic acid salt, glucomannan, pectin, chitin, chitosan, curdlan or the like as a gelling agent.

4) A water soluble polysaccharide that forms a gel through reacting with the gelling agent is used as the gelation accelerator. Specifically, combinations prepared by using xanthan gum as a gelling agent, and using cassia gum as a gelation accelerator; and combinations obtained by using carageenan as a gelling agent, and using locust bean gum as a gelation accelerator are illustrated.

Specific examples of these combinations of the gelling agent and the gelation accelerator include the illustrated a) to g) below.
a) Combination of κ-carageenan and potassium;
b) Combination of ι-carageenan and calcium;
c) Combination of low-methoxyl pectin and calcium;
d) Combination of sodium alginate and calcium;
e) Combination of gellan gum and calcium;
f) Combination of gellan gum and an acid; and
g) Combination of locust bean gum and xanthan gum.
   Multiple combinations among these may be used concurrently.

These gelation accelerators may be added to the identical layer to which the gelling agent is added, however, it is preferably added to a different layer. More preferably, the gelation accelerator is added to a layer which is not directly adjacent to the layer to which the gelling agent is added. In other words, it is preferred that a layer which includes neither a gelling agent nor a gelation accelerator is provided between the layer containing the gelling agent and the layer containing the gelation accelerator.

It is preferred that the gelation accelerator is used in an amount of 0.1% by mass or greater and 200% by mass or less, and preferably 1.0% by mass or greater and 100% by mass or less per the gelling agent.

The content of the binder which can be gelated upon drop of the temperature in the entire coating liquid for outermost layer is preferably 3% by mass or greater and 60% by mass or less, and more preferably 5% by mass or greater and 50% by mass or less.

The amount of coating of the binder which is used in combination for the first nonphotosensitive layer is preferably 0.1 g/m² or greater and 10 g/m² or less, more preferably 0.2 g/m² or greater and 5 g/m² or less, and most preferably 0.5 g/m² or greater and 3 g/m² or less.

(3) Second Nonphotosensitive Layer

It is preferred that a second nonphotosensitive layer is provided according to the present invention. The binder in the second nonphotosensitive layer contains an aqueous dispersion of a hydrophobic polymer in an amount of 50% by mass or greater, preferably 80% by mass or greater and 100% by mass or less, and more preferably 90% by mass or greater and 100% by mass or less. The amount of less than 50% by mass is not preferred because inferior effect of improving the image storability may be achieved. The aqueous dispersion of the hydrophobic polymer referred to herein may be any one of latexes of fine particles of a water insoluble hydrophobic polymer dispersed in a water-based solvent, and those in which polymer molecules are dispersed in their molecular state or through forming a micelle. Among them, particles dispersed to form a latex are more preferred. The mean particle size of the dispersed particle is 1 nm or greater and 50000 nm or less, preferably in the range of 5 nm or greater and 1000 nm or less, more preferably in the range of 10 nm or greater and 500 nm or less, and still more preferably in the range of 50 nm or greater and 200 nm or less. The grain size distribution of dispersed particles is not particularly limited, but it may be either a wide grain size distribution or a grain size distribution of mono dispersion. In a method which is also preferred in the light of control of the physical properties of the coating liquid, two or more of those having a grain size distribution of mono dispersion may be used in a mixture.

In the present invention, the hydrophobic polymer is not particularly limited, however, any one of hydrophobic polymers such as acrylic polymers, poly(esters), rubbers (e.g., SBR resins), poly(urethanes), poly(vinyl chlorides), poly(vinyl acetates), poly(vinylidene chlorides), poly(olefins) and the like can be preferably used. These polymers may be any one of straight chain polymers, branched polymers or crosslinked polymers, or may be a homopolymer prepared by polymerization of a single monomer, or a copolymer prepared by polymerization of two or more kinds of monomers. In cases of the copolymer, it may be either a random copolymer, or a block copolymer. It is preferred that the molecular weight of the polymer is 5000 or greater and 1000000 or less, and preferably 10000 or greater and 200000 or less in the number average molecular weight. Those having a too small molecular weight are not preferred because dynamic strength of the image forming layer is insufficient, while those having too large molecular weight are not preferred because film-forming performance is deteriorated. Moreover, a crosslinkable polymer latex is particularly preferably used. The hydrophobic polymer of the present invention preferably has Tg(glass transition temperature) in the range of −30° C. or higher and 70° C. or lower, more preferably −10° C. or higher and 35° C. or lower, and most preferably 0° C. or higher and 35° C. or lower. Tg of lower than −30° C. is not preferred because a film having inferior thermostable strength is formed although excellent film-forming performance may be elicited, while Tg of higher than 70° C. is not preferred because a film which is inferior in film-forming performance is obtained although the polymer is excellent in thermostable strength. In order to adjust to give such Tg, it is also possible to prepare using two kinds or more polymers. Accordingly, even though the polymer has Tg of out of the aforementioned range is used, the weight average Tg thereof preferably falls within the range. The hydrophobic polymer preferably has an I/O value of 0.025 or greater and 0.5 or less, more preferably 0.05 or greater and 0.3 or less. The I/O value refers to a value obtained by dividing the inorganic group value by the organic group value on the basis of an organic conceptual diagram. The I/O value of lower than 0.025 is not preferred because poor affinity to a water base solvent is provided leading to difficulties in coating with a water-based coating liquid, while the I/O value of higher than 0.5 is not preferred because the finished film becomes hydrophilic thereby affecting photographic properties against humidity which may lead to marked deterioration of the photographic performances. The I/O value can be determined according to the method described in “Organic conceptual diagram—Bases and Applications—” (1984, Yoshio Kouda, published by Sankyo Shuppan).

The organic conceptual diagram herein is illustrated by categorizing a property of a compound based on an organic group which represents a covalent binding property and an inorganic group which represents an ionic binding property, and positioning all organic compounds to one point, respectively, on an orthogonal coordinate of axes named as organic axis and inorganic axis. The inorganicity value on this basis is determined to be a value of the influence of one hydroxyl group as being 100, because the distance between the boiling point curve of a linear alcohol and the boiling point curve of a linear paraffin corresponds to about 100° C. taken in the vicinity of the point of the carbon number of 5 when “inorganicity”, i.e., the degree of the influence on the boiling point of a variety of substituents, is defined using a hydroxyl group as a standard. The organicity value is defined, assuming that magnitude of the value for organicity can be determined using the number of carbon atoms representing a methylene group within a molecule as a unit. The value for one carbon to make the basis was determined to be 20 based on the average elevation of boiling point of 20° C. accompanied by addition of one carbon in a straight chain compound having approximately 5 to 10 carbon atoms. The inorganicity value and the organicity value are specified on the graph to give a one-to-one correspondence. The I/O value is calculated from these values.

Moreover, preferred binder for use in the second nonphotosensitive layer of the present invention is a polymer prepared by copolymerization of a monomer represented by the formula (M). The content of the polymer prepared by copolymerization of the monomer represented by the formula (M) in the binder in the nonphotosensitive intermediate layer is preferably 80% by mass or greater, more preferably 85% by mass or greater and 100% by mass or less, and still more preferably 90% by mass or greater and 100% by mass or less.
CH₂═CR⁰¹—CR⁰²═CH₂ Formula (M)
wherein R⁰¹ and R⁰² each independently represent a group selected from a hydrogen atom, an alkyl group having 1 to 6 carbon atoms, a halogen atom, or a cyano group.

Preferred alkyl group for R⁰¹ and R⁰² is each independently an alkyl group having 1 to 4 carbon atoms, and more preferably an alkyl group having 1 to 2 carbon atoms. Preferred halogen atom is a fluorine atom, a chlorine atom or a bromine atom, and a chlorine atom is more preferred.

In respect of R⁰¹ and R⁰², it is particularly preferred that both are a hydrogen atom, or one is a hydrogen atom while the other is a methyl group or a chlorine atom.

Specific examples of the monomer represented by the formula (M) according to the present invention include 1,3-butadiene, 2-ethyl-1,3-butadiene, 2-n-propyl-1,3-butadiene, 2,3-dimethyl-1,3-butadiene, 2-methyl-1,3-butadiene, 2-chloro-1,3-butadiene, 1-bromo-1,3-butadiene, 2-fluoro-1,3-butadiene, 2,3-dichloro-1,3-butadiene and 2-cyano-1,3-butadiene.

The other monomer which can be copolymerized with the monomer represented by the formula (M) in the present invention is not particularly limited, but any one can be suitably used as long as it is a polymerizable monomer in a conventional radical polymerization or ion polymerization method. The monomer which can be preferably used is selected from the following monomer groups (a) to (j) independently, and in combination ad libitum.

—Monomer Groups (a) to (j)—
(a) Conjugated dienes: 1,3-butadiene, 1,3-pentadiene, 1-phenyl-1,3-butadiene, 1-naphthyl-1,3-butadiene, 1-β-naphthyl-1,3-butadiene, 1-bromo-1,3-butadiene, 1-chloro-1,3-butadiene, 1,1,2-trichloro-1,3-butadiene, cyclopentadiene and the like.
(b) Olefins: ethylene, propylene, vinyl chloride, vinylidene chloride, 6-hydroxy-1-hexene, 4-pentenoic acid, methyl 8-nonenate, vinyl sulfonate, trimethylvinyl silane, trimethoxyvinyl silane, 1,4-divinyl cyclohexane, 1,2,5-trivinyl cyclohexane and the like.
(c) α,β-Unsaturated carboxylic acids and salts thereof: acrylic acid, methacrylic acid, itaconic acid, maleic acid, sodium acrylate, ammonium methacrylate, potassium itaconate and the like.
(d) α,β-Unsaturated carboxylic acid esters: alkyl acrylate (e.g., methyl acrylate, ethyl acrylate, butyl acrylate, cyclohexyl acrylate, 2-ethylhexyl acrylate, dodecyl acrylate and the like), substituted alkyl acrylate (e.g., 2-chloroethyl acrylate, benzyl acrylate, 2-cyanoethyl acrylate and the like), alkyl methacrylate (e.g., methyl methacrylate, butyl methacrylate, 2-ethylhexyl methacrylate, dodecyl methacrylate and the like), substituted alkyl methacrylate (e.g., 2-hydroxyethyl methacrylate, glycidyl methacrylate, glycerin monomethacrylate, 2-acetoxyethyl methacrylate, tetrahydrofurfuryl methacrylate, 2-methoxyethyl methacrylate, polypropylene glycol monomethacrylate (those having the number of moles added polyoxypropylene=2 to 100), 3-N,N-dimethylaminopropyl methacrylate, chloro-3-N,N,N-trimethylammoniopropyl methacrylate, 2-carboxyethyl methacrylate, 3-sulfopropyl methacrylate, 4-oxysulfobutyl methacrylate, 3-trimethoxysilylpropyl methacrylate, aryl methacrylate, 2-isocyanatoethyl methacrylate and the like), derivatives of unsaturated dicarboxylic acid (e.g., monobutyl maleate, dimethyl maleate, monomethyl itaconate, dibutyl itaconate and the like), polyfunctional esters (e.g., ethylene glycol diacrylate, ethylene glycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, 1,2,4-cyclohexane tetramethacrylate and the like).

(e) Amides of a β-unsaturated carboxylic acid: for example, acrylamide, methacrylamide, N-methylacrylamide, N,N-dimethylacrylamide, N-methyl-N-hydroxyethylmethacrylamide, N-tert-butylacrylamide, N-tert-octylmethacrylamide, N-cyclohexylacrylamide, N-phenylacrylamide, N-(2-acetoacetoxyethyl)acrylamide, N-acryloyl morpholine, diacetone acrylamide, itaconic acid diamide, N-methylmaleimide, 2-acrylamide-methylpropane sulfonate, methylene bisacrylamide, dimethacryloyl piperazine and the like.
(f) Unsaturated nitriles: acrylonitrile, methacrylonitrile and the like.
(g) Styrene and derivatives thereof: styrene, vinyl toluene, p-tert-butyl styrene, vinyl benzoate, methyl vinyl benzoate, α-methylstyrene, p-chloromethylstyrene, vinylnaphthalene, p-hydroxymethylstyrene, p-styrene sulfonate sodium salt, p-styrene sulfinate potassium salt, p-aminomethylstyrene, 1,4-divinylbenzene and the like.
(h) Vinyl ethers: methylvinyl ether, butylvinyl ether, methoxyethylvinyl ether and the like.
(i) Vinyl esters: vinyl acetate, vinyl propionate, vinyl benzoate, vinyl salicylate, chlorovinyl acetate and the like.
(j) Other polymerizable monomers: N-vinylimidazole, 4-vinylpyridine, N-vinylpyrrolidone, 2-vinyloxazoline, 2isopropenyloxazoline, divinyl sulfone and the like.

A copolymer with styrene, acrylic acid, and/or an acrylic ester is preferred. Further, in the light of availability of the resulting hydrophobic polymer as an aqueous dispersion having favorable dispersion stability, it is preferably a copolymer having styrene and acrylic acid as a monomer unit.

Although the proportion of copolymerization of the monomer represented by the formula (M) and other monomer is not particularly limited, the case in which copolymerization is carried out with the monomer represented by the formula (M) of preferably 10% by mass or greater and 70% by mass or less, more preferably 15% by mass or greater and 65% by mass or less, and still more preferably 20% by mass or greater and 60% by mass or less is preferred.

Specific examples of the preferred hydrophobic polymer include the following polymers. Hereinafter, the polymer is represented using the monomer material, with the value in parentheses is based on % by mass, and with the molecular weight of number average molecular weight. When a polyfunctional monomer is used, concept of the molecular weight can not be applied because a crosslinked structure is formed, therefore, description of “crosslinking” is added while omitting the description of the molecular weight(Mw) in such cases. Tg represents the glass transition temperature.
LP-1; Latex of -MMA (55) -EA (42) -MAA (3)—(Tg: 39° C., I/O value: 0.636, Mn: 535,000.)
LP-2; Latex of -MMA (47) -EA (50) -MAA (3)—(Tg: 29° C., I/O value: 0.636, Mn: 645,000.)
LP-3; Latex of -MMA (17) -EA (80) -MAA (3)—(Tg: −4° C., I/O value: 0.636, Mn: 563,000.)
LP-4; Latex of -EA (97) -MAA (3)—(Tg: −20° C., I/O value: 0.636, Mn: 482,000.)
LP-5; Latex of -EA (97) -AA (3)—(Tg: −21° C., I/O value: 0.648, Mn: 548,000.)
LP-6; Latex of -EA (90) -AA (10)—(Tg: −15° C., I/O value: 0.761, Mn: 721,000.)
LP-7; Latex of -MMA (50) -2EHA (35) -St (10) -AA (5)—(Tg: 34° C., I/O value: 0.461, Mn: 595,000.)
LP-8; Latex of -MMA (30) -2EHA (55) -St (10) -AA (5)—(Tg: 3° C., I/O value: 0.398, Mn: 490,000.)
LP-9; Latex of -MMA (10) -2EHA (75) -St (10) -AA (5)—(Tg: −23° C., I/O value: 0.339, Mn: 512,000.)
LP-10; Latex of -MMA (60) -BA (36) -AA (4)—(Tg: 29° C., I/O value: 0.581, Mn: 850,000.)
LP-11; Latex of -MMA (40) -BA (56) -AA (4)—(Tg: −2° C., I/O value: 0.545, Mn: 763,000.)
LP-12; Latex of -MMA (25) -BA (71) -AA (4)—(Tg: −22° C., I/O value: 0.519, Mn: 524,000.)
LP-13; Latex of -MMA (42) -BA (56) -AA (2)—(Mw: 540000, Tg: −4° C., I/O value: 0.530.)
LP-14; Latex of -St (40) -BA (55) -AA (5)—(Tg: −2° C., I/O value: 0.319, Mn: 818,000.)
LP-15; Latex of -St (25) -BA (70) -AA (5)—(Tg: −21° C., I/O value: 0.377, Mn: 650,000.)
LP-16; Latex of -MMA (58) -St (8) -BA (32) -AA (2)—(Tg: 34° C., I/O value: 0.51, Mn: 612000.)
LP-17; Latex of -MMA (50) -St (8) -BA (35) -HEMA (5) -AA (2)—(Tg: 27° C., I/O value: 0.542, Mn: 535,000.)
LP-18; Latex of -MMA (42) -St (8) -BA (43) -HEMA (5) -AA (2)—(Tg: 14° C., I/O value: 0,528, Mn: 490,000.)
LP-19; Latex of -MMA (24) -St (8) -BA (61) -HEMA (5) -AA (2)—(Tg: −12° C., I/O value: 0,498, Mn: 710,000.)
LP-20; Latex of -MMA (48) -St (8) -BA (27) -HEMA (15) -AA (2)—(Tg: 39° C., I/O value: 0.619, Mn: 840,000.)
LP-21; Latex of -EA (96) -AA (4)-(Tg: −21° C., I/O value: 0.664, Mn: 1,040,000.)
LP-22; Latex of -EA (46) -MA (50) -AA (4)—(Tg: −4° C., I/O value: 0.739, Mn: 730,000.)
LP-23; Latex of -EA (80) -HEMA (16) -AA (4)—(Tg: −9° C., I/O value: 0.775, Mn: 630,000.)
LP-24; Latex of -EA (86) -HEMA (10) -AA (4)—(Tg: −13° C., I/O value: 0.733, Mn: 728,000.)
LP-25; Latex of -St (45) -Bu (52) -MAA (3)—(Tg: −26° C., I/O value: 0.099, crosslinking.)
LP-26; Latex of -St (55) -Bu (42) -MAA (3)—(Tg: −9° C., I/O value: 0.105, crosslinking.)
LP-27; Latex of -St (60) -Bu (37) -MAA (3)—(Tg: 1° C., I/O value: 0.109, crosslinking.)
LP-28; Latex of -St (68) -Bu (29) -MAA (3)—(Tg: 17° C., I/O value: 0.114, crosslinking.)
LP-29; Latex of -St (75) -Bu (22) -MAA (3)—(Tg: 34° C., I/O value: 0.119, crosslinking.)
LP-30; Latex of -St (40) -BA (58) -AA (2)—(Tg: −8.1° C., I/O value: 0.293, Mn: 530,000.)
LP-31; Latex of -St (40) -BA (58) -MAA (2)—(Tg: −7.1° C., I/O value: 0.287, Mn: 570,000.)
LP-32; Latex of -St (57.2) -BA (27.7) -MMA (8.7) -HEMA (4.8) -AA (1.6) (Tg: 37.8° C., I/O value: 0.269, Mn: 590,000.)
LP-33; Latex of -St (49.6) -BA (40) -MMA (4) -HEMA (4.8) -AA (1.6) (Tg: 16.7° C., I/O value: 0.289, Mn: 812,000.)
LP-34; Latex of -St (80) -2EHA (18) -AA (2)—(Tg: 59.7° C., I/O value: 0.148, Mn: 640,000.)
LP-35; Latex of -St (70) -2EHA (28) -AA (2)—(Tg: 40.9° C., I/O value: 0.164, Mn: 550,000.)
LP-36; Latex of -St (10) -2EHA (38) -MMA (50) -AA (2)—(Tg: 25.6° C., I/O value: 0.427, Mn: 577,000.)
LP-37; Latex of -St (10) -2EHA (58) -MMA (30) -AA (2)—(Tg: −3.9° C., I/O value: 0.365, Mn: 517,000.)
LP-38; Latex of -St (10) -2EHA (78) -MMA (10) -AA (2)—(Tg: −28.1° C., I/O value: 0.308, Mn: 498,000.)
LP-39; Latex of -St (20) -2EHA (68) -MMA (10) -AA (2)—(Tg: −16.8° C., I/O value: 0.285, Mn: 540,000.)
LP-40; Latex of -St (30) -2EHA (58) -MMA (10) -AA (2)—(Tg: −4.4° C., I/O value: 0.263, Mn: 713,000.)
LP-4 1; Latex of -MMA (45) -BA (52) -itaconic acid (3)—(Tg: 4° C., I/O value: 0.560, Mn: 510,000.)
LP-42; Latex of -St (62) -Bu (35) -MAA (3)—(crosslinking, Tg: 5° C., I/O value: 0.103.)
LP-43; Latex of -St (68) -Bu (29) -AA (3)—(crosslinking, Tg: 17° C., I/O value: 0.114.)
LP-44; Latex of -St (71) -Bu (26) -AA (3)—(crosslinking, Tg: 24° C., I/O value: 0.116.)
LP-45; Latex of -St (70) -Bu (27) -IA (3)—(crosslinking, Tg: 23° C., I/O value: 0.117.)
LP-46; Latex of -St (75) -Bu (24) -AA (1)—(crosslinking, Tg: 29° C., I/O value: 0.091.)
LP-47; Latex of -St (60) -Bu (35) -DVB (3) -MAA (2)—(crosslinking, Tg: 6° C., I/O value: 0.092.)
LP-48; Latex of -St (70) -Bu (25) -DVB (2) -AA (3)—(crosslinking, Tg: 26° C., I/O value: 0.115.)
LP-49; Latex of -St (70.5) -Bu (26.5) -AA (3)—(crosslinking, Tg: 23° C., I/O value: 0.116.)
LP-50; Latex of -St (69.5) -Bu (27.5) -AA (3)—(crosslinking, Tg: 20.5° C., I/O value: 0.115.)
LP-51; Latex of -St (61.5) -isoprene (35.5) -AA (3)—(crosslinking, Tg: 17° C., I/O value: 0.108.)
LP-52; Latex of -St (67) -isoprene (28) -Bu (2) -AA (3)—(crosslinking, Tg: 27° C., I/O value: 0.112)

Abbreviations in the above structures represent the following monomer. MMA; methyl methacrylate, EA; ethyl acrylate, MA; methyl acrylate, MAA; methacrylic acid, 2EHA; 2-ethylhexyl acrylate, HEMA; hydroxyethyl methacrylate, St; styrene, Bu; butadiene, AA; acrylic acid, DVB; divinylbenzene, IA; itaconic acid.

The aforementioned aqueous dispersion of the hydrophobic polymer is commercially available, and the following polymer can be utilized. Examples of the acrylic polymer include Cevian A-4635, 4718, 4601 (foregoings, manufactured by Daicel Chemical Industries, Ltd.), Nipol Lx811, 814, 821, 820, 857 (foregoings, manufactured by Zeon Corporation) and the like; examples of the poly(esters) include FINETEX ES650, 611, 675, 850 (foregoings, manufactured by Dainippon Ink and Chemicals, Incorporated.), WD-size, WMS (foregoings, manufactured by Eastman Chemical Company) and the like; examples of the poly(urethanes) include HYDRAN AP10, 20, 30, 40 (foregoings, manufactured by Dainippon Ink and Chemicals, Incorporated.) and the like; examples of the rubbers include LACSTAR 7310K, 3307B, 4700H, 7132C (foregoings, manufactured by Dainippon Ink and Chemicals, Incorporated.), Nipol Lx416, 410, 438C, 2507 (foregoings, manufactured by Zeon Corporation) and the like; examples of the poly(vinyl chlorides) include G35 1, G576 (foregoings, manufactured by Zeon Corporation) and the like; examples of the poly(vinylidene chlorides) include L502, L513 (foregoings, manufactured by Asahi Kasei Corporation)and the like; examples of the poly(olefins) include Chemipearl S120, SA100 (foregoings, manufactured by Mitsui Chemicals Co., Ltd.) and the like.

Examples of the latex of the styrene-butadiene copolymer for use in the present invention include the aforementioned LP-42 to LP-50, commercially available LACSTAR-3307B, 7132C (foregoings, Dainippon Ink and Chemicals, Incorporated), Nipol Lx416 (manufactured by Zeon Corporation) and the like. Examples of the latex of the styrene-isoprene copolymer include the aforementioned LP-51, LP-52 and the like.

The aqueous dispersion of the hydrophobic polymer may be used alone, or two or more thereof may be blended as needed.

The content of the hydrophobic polymer is preferably 3% by mass or greater and 60% by mass or less, and more preferably 5% by mass or greater and 50% by mass or less per the entire coating liquid for second nonphotosensitive layer. The amount of coating of the hydrophobic polymer of the second nonphotosensitive layer is preferably 0.1 g/m² or greater and 10 g/m² or less, more preferably 0.2 g/m² or greater and 5 g/m² or less, and most preferably 0.5 g/m² or greater and 3 g/m² or less.

To the second nonphotosensitive layer in the present invention may be added the aforementioned hydrophilic polymer such as gelatin, polyvinyl alcohol, methyl cellulose, hydroxypropyl cellulose or carboxymethyl cellulose as needed.

A film formation aid may be added in order to control the minimum film formation temperature of the aqueous dispersion of the hydrophobic polymer. As the film formation aid, any one described above for the outermost layer may be used ad libitum. Moreover, it is preferred that a thickening agent is added to the coating liquid for forming the second nonphotosensitive layer. When the thickening agent is added, a hydrophobic layer having a uniform thickness can be formed. As the thickening agent, any one described above for the outermost layer may be used ad libitum. Also, the viscosity of the coating liquid for second nonphotosensitive layer to which the thickening agent was added is preferably 1 mPa.s or greater and 200 mPa.s or less, more preferably 10 mPa.s or greater and 100 mPa.s or less, and still more preferably 15 mPa.s or greater and 60 mPa.s or less at 40° C.

To the second nonphotosensitive layer may be added various additives in addition to the binder. Examples of the additive include surface active agents, pH adjusting agents, antiseptics, antifungal agents and the like.

(3) Image Forming Layer

(Explanation of Organic Silver Salt)

1) Composition

Although the organic silver salt which can be used in the present invention is a silver salt which is comparatively stable to a light, it serves as a silver ion donor upon heating at 80° C. or higher in the presence of a reducing agent and an exposed photosensitive silver halide, leading to formation of a silver image. The organic silver salt may be an arbitrary organic substance capable of supplying a silver ion which can be reduced by a reducing agent. Such nonphotosensitive organic silver salts are described in paragraph Nos. 0048 to 0049 of JP-A No. 1062899, page 18, line 24 to page 19 line 37 in EP-A No. 0803764, EP-A No. 0962812, JP-A Nos. 11-349591, 2000-7683 and 2000-72711, and the like. The silver salt of an organic acid, particularly, the silver salt of a long chain aliphatic carboxylic acid (having 10 to 30 carbon atoms, preferably 15 to 28 carbon atoms) is preferred. Preferable examples of the fatty acid silver salt include silver lignocerate, silver behenate, silver arachidate, silver stearate, silver oleate, silver laurate, silver caproate, silver myristate, silver palmitate, silver erucate and mixtures thereof. According to the present invention, use of the fatty acid silver having a silver behenate content of preferably 50 mol % or greater and 100 mol % or less, more preferably 85 mol % or greater and 100 mol % or less, and still more preferably 90 mol % or greater and 100 mol % or less is preferred among the fatty acid silver.

Furthermore, use of the fatty acid silver having a silver erucate content of 2 mol % or less, more preferably 1 mol % or less, and still more preferably 0.1 mol % or less is preferred.

It is preferred that the content of the silver stearate is 1 mol % or less. When the content of the silver stearate is 1 mol % or less, a silver salt of organic acid having low Dmin, high sensitivity and excellent image stability can be obtained. The content of the silver stearate above-mentioned, is preferably 0.5 mol % or less, more preferably, the silver stearate is not substantially contained.

Further, in the case the silver salt of organic acid includes silver arachidinic acid, it is preferred that the content of the silver arachidinic acid is 6 mol % or less in order to obtain a silver salt of organic acid having low Dmin and excellent image stability. The content of the silver arachidinate is more preferably 3 mol % or less.

2) Shape

There is no particular restriction on the shape of the organic silver salt usable in the present invention and it may needle-like, bar-like, tabular or flaky shape.

In the present invention, a flaky shaped organic silver salt is preferred. Short needle-like, rectangular, cuboidal or potato-like indefinite shaped particle with the major axis to minor axis ratio being 5 or less is also used preferably. Such organic silver particle has a feature less suffering from fogging during thermal development compared with long needle-like particles with the major axis to minor axis length ratio of more than 5. Particularly, a particle with the major axis to minor axis ratio of 3 or less is preferred since it can improve the mechanical stability of the coating film. In the present specification, the flaky shaped organic silver salt is defined as described below. When an organic acid silver salt is observed under an electron microscope, calculation is made while approximating the shape of an organic acid silver salt particle to a rectangular body and assuming each side of the rectangular body as a, b, c from the shorter side (c may be identical with b) and determining x based on numerical values a, b for the shorter side as below.
x=b/a

As described above, x is determined for the particles by the number of about 200 and those capable of satisfying the relation: x (average)≧1.5 as an average value x is defined as a flaky shape. The relation is preferably: 30≧x (average)≧1.5 and, more preferably, 15≧x (average)≧1.5. By the way, needle-like is expressed as 1≦x (average)<1.5.

In the flaky shaped particle, a can be regarded as a thickness of a tabular particle having a main plate with b and c being as the sides. a in average is preferably 0.01 μm to 0.3 μm and, more preferably, 0.1 μm to 0.23 μm. c/b in average preferably 1 to 9, more preferably, 1 to 6, further preferably, 1 to 4 and, most preferably, 1 to 3.

By controlling the sphere equivalent diameter to be 0.05 μm to 1 μm, it causes less coagulation in the photothermographic material and image stability is improved. The sphere equivalent diameter is preferably 0.1 μm to 1 μm. In the present invention, the sphere equivalent diameter can be measured by a method of photographing a sample directly by using an electron microscope and then image-processing negative images.

In the flaky shaped particle, the sphere equivalent diameter of the particle/a is defined as an aspect ratio. The aspect ratio of the flaky particle is, preferably, 1.1 to 30 and, more preferably, 1.1 to 15 with a viewpoint of causing less coagulation in the photothermographic material and improving the image stability.

It is preferred that the grain size distribution of the organic silver salt follows monodispersion. In the monodispersion, percentage of each value yielded from dividing the standard deviation of the short axis or long axis by the length of the short axis or long axis, respectively is preferably 100% or less, more preferably 80% or less, and still more preferably 50% or less. In the measurement method in connection with the shape of the organic silver salt, a transmission electron microscope may be used for determination on the organic silver salt dispersion. There exists another method for the measurement of the monodispersibility in which standard deviation of the volume weighted average diameter of the organic silver salt is determined, and the percentage obtained through dividing by the volume weighted average diameter (coefficient of variation) is preferably 100% or less, more preferably 80% or less, and still more preferably 50% or less. In the method of the measurement, for example, determination can be made from the particle size (volume weighted average diameter) obtained by irradiating a laser beam on the organic silver salt dispersed in a liquid, and measuring the auto-correlation function for the time dependent alteration of the fluctuation of the scattering light.

3) Preparing Method

Methods known in the art may be applied to the method for producing the organic silver salt used in the present invention, and to the dispersion method thereof. For example, reference can be made to JP-A No. 10-62899, EP-A Nos. 0803763A1 and 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870 and 2002-107868, and the like.

When coexistence of the photosensitive silver salt is rendered during dispersing the organic silver salt, the fog may be increased, and sensitivity is markedly reduced. Therefore, it is preferred that any photosensitive silver salt is not substantially included during the dispersion. In the present invention, the amount of the photosensitive silver salt in the aqueous dispersion liquid to be dispersed is preferably 1 mol % or less, and more preferably 0.1 mol % or less per mol of the organic acid silver salt 1 mol in the liquid. More preferably, any photosensitive silver salt is not added intentionally.

In the present invention, the photosensitive material can be produced by mixing the aqueous dispersion of the organic silver salt and the aqueous dispersion of the photosensitive silver salt. Although the proportion of mixing the organic silver salt and the photosensitive silver salt may be selected depending on the end, the proportion of the photosensitive silver salt to the organic silver salt is preferably in the range of 1 mol % or greater and 30 mol % or less, more preferably 2 mol % or greater and 20 mol % or less, and particularly preferably in the range of 3 mol % or greater and 15 mol % or less. In a method preferably used for adjusting the photographic characteristics, two or more aqueous dispersions of the organic silver salt and two or more aqueous dispersions of the photosensitive silver salt are admixed upon the mixing is executed.

4) Amount of Addition

Although the organic silver salt according to the present invention can be used in a desired amount, total amount of the coated silver also including the silver halide is preferably 0.1 g/m² or greater and 5.0 g/m² or less, more preferably 0.3 g/m² or greater and 3.0 g/m² or less, and still more preferably 0.5 g/m² or greater and 2.0 g/m² or less. In particular, for the purpose of improving the image storability, the total amount of the coated silver is preferably 1.8 g/m² or less, and more preferably 1.6 g/m² or less. When a preferred reducing agent according to the present invention is used, sufficient image density can be achieved even with such a low amount of silver.

(Explanation of Antifoggant)

Examples of the antifoggant, stabilizer and stabilizer precursor which may be used in the present invention include those described in paragraph No. 0070 of JP-A No. 10-62899 and page 20, line 57 to page 21, line 7 in EP-A No. 0803764; compounds described in JP-A Nos. 9-281637 and 9-329864; and compounds described in U.S. Pat. No. 6,083,681 and European Patent No. 1048975.

(1) Explanation of Polyhalogenated Compound

Hereinafter, the organic polyhalogenated compound that is a preferable antifoggant which can be used in the present invention is specifically explained. Examples of the preferred polyhalogenated compound according to the present invention include the compounds represented by the following formula (H).
Q-(Y)n-C(Z₁)(Z₂)X Formula (H)

In the formula (H), Q represents an alkyl group, an aryl group or a hetero cyclic group; Y represents a bivalent linking group; n represents 0 to 1; Z₁ and Z₂ represent a halogen atom; and X represents a hydrogen atom or an electron-attractive group. In the formula (H), Q is preferably an alkyl group having 1 to 6 carbon atoms, an aryl group having 6 to 12 carbon atoms or a hetero cyclic group having at least one nitrogen atom (pyridine, quinoline group or the like). In the formula (H), when Q is an aryl group, Q preferably represents a phenyl group having a substitution with an electron-attractive group having a Hammett substituent constant op of a positive value. In connection with the Hammett substituent constant, Journal of Medicinal Chemistry, 1973, Vol. 16, No. 11, 1207-1216 and the like can be referred to. Examples of such an electron-attractive group include e.g., halogen atoms, alkyl groups substituted with an electron-attractive group, aryl groups substituted with an electron-attractive group, heterocyclic groups, alkyl or aryl sulfonyl groups, acyl groups, alkoxycarbonyl groups, carbamoyl groups, sulfamoyl groups and the like. Examples of the particularly preferable electron-attractive group include halogen atoms, carbamoyl groups and aryl sulfonyl groups, and carbamoyl groups are particularly preferred. X is preferably an electron-attractive group. Preferred electron-attractive group is a halogen atom, an aliphatic aryl or heterocyclic sulfonyl group, an aliphatic aryl or heterocyclic acyl group, an aliphatic aryl or heterocyclic oxycarbonyl group, a carbamoyl group or a sulfamoyl group, more preferably a halogen atom, a carbamoyl group, and particularly preferably a bromine atom. Z₁ and Z₂ are preferably a bromine atom or an iodine atom, and more preferably a bromine atom. Y represents preferably —C(═O)—, —SO—, —SO₂—, —C(═O)N(R)—, —SO₂N(R)—, more preferably (═O)—, —SO₂—, —C(═O)N(R)—, and particularly preferably —SO₂—, —C(═O)N(R)—. R referred to herein represents a hydrogen atom, an aryl group or an alkyl group, more preferably a hydrogen atom or an alkyl group, and particularly preferably a hydrogen atom. The symbol n represents 0 or 1, and preferably 1. In the formula (H), when Q is an alkyl group, preferred Y is —C(═O)N(R)—, while when Q is an aryl group or a heterocyclic group, preferred Y is —SO₂—. Also, the form generated by removing hydrogen atoms from the compound represented by the formula (H), and binding of thus resulting residues to one another (generally, also referred to as bis form, tris form and tetrakis form) can be preferably used. In the formula (H), those having a dissociative group (e.g., COOH group or a salt thereof, SO₃H group or a salt thereof, PO₃H group or a salt thereof, or the like), a group including a quaternary nitrogenous cation (e.g., ammonium group, pyridinium group and the like), a polyethyleneoxy group, a hydroxyl group or the like as a substituent are also preferred.

Specific examples of the compound represented by the formula (H) are illustrated below.

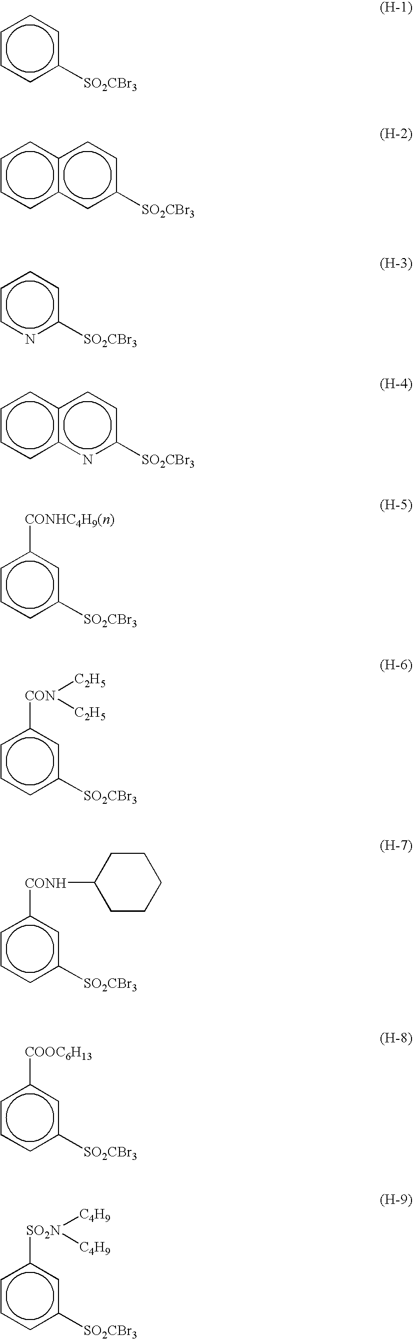

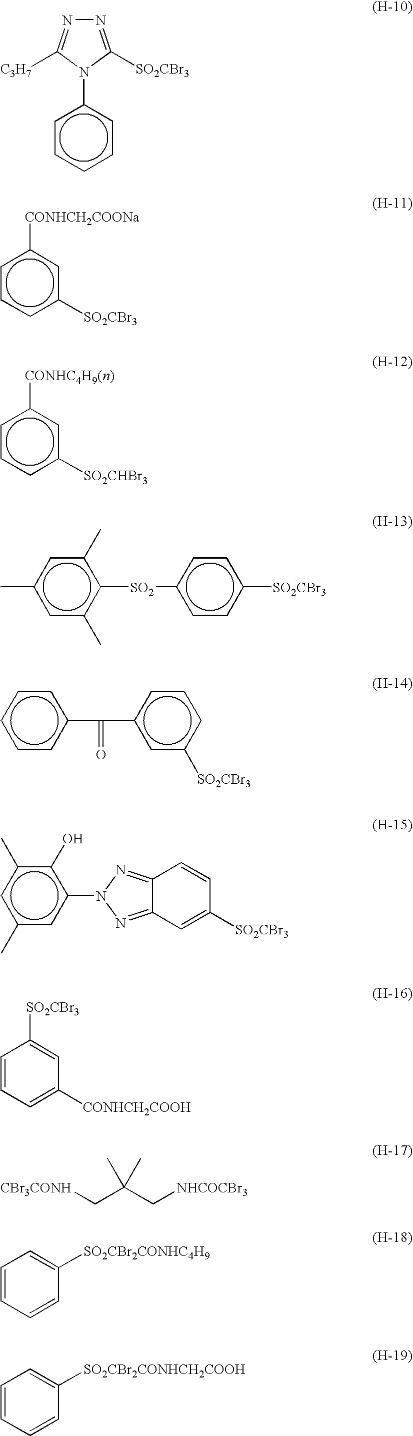

The polyhalogenated compounds which can be preferably used in the present invention except for those described above include illustrative compounds of the present invention in U.S. Pat. Nos. 3874946, 4756999, 5340712, 5369000, 5464737 and 6506548, JP-A-Nos. 50-137126, 5089020, 50-119624, 59-57234, 7-2781, 7-5621, 9-160164, 9-244177, 9-244178, 9-160167, 9-319022, 9-258367, 9-265150, 9-319022, 10-197988, 10-197989, 11-242304, 2000-2963, 2000-112070, 2000-284410, 2000-284412, 2001-33911, 2001-31644, 2001-312027 and 2003-50441. In particular, compounds specifically illustrated in JP-A Nos. 7-2781, 2001-33911 and 2001-312027 are included in the preferable examples.

The compound represented by the formula (H) in the present invention is preferably used in the range of 10⁻⁴ mol or greater and 1 mol or less, more preferably in the range of 10⁻³ mol or greater and 0.5 mol or less, and still more preferably in the range of 1×10⁻² mol or greater and 0.2 mol or less per mol of the nonphotosensitive silver salt in the image forming layer.

In the present invention, exemplary method for including the antifoggant in the photosensitive material includes the below method for including the reducing agent. Also in cases of the organic polyhalogenated compound, it is preferably added in a dispersion of solid fine particles.

(Other Antifoggant)

Examples of the other antifoggant include mercury (II) salts described in paragraph No. 0113 of JP-A No. 11 -65021, benzoic acids described in paragraph No. 0114 of the same document, salicylic acid derivatives in JP-A No. 2000-206642, formalin scavenger compounds represented by the formula (S) in JP-A No. 2000-221634, a triazine compound according to claim 9 in JP-A No. 11-352624, compounds represented by the formula (III) in JP-A No. 6-11791, 4-hydroxy-6-methyl-1,3,3a,7-tetrazaindene, and the like.

The photothermographic material of the present invention may contain an azolium salt for the purpose of preventing the fog. Examples of the azolium salt include compounds represented by the formula (XI) described in JP-A No. 59-193447, compounds described in JP-B No. 55-12581, and compounds represented by the formula (II) in JP-A No. 60-153039. Although the azolium salt may be added to any part of the photosensitive material, the layer to be added is preferably a layer of the side having the image forming layer. More preferably, the azolium salt is added to the image forming layer. The timing point of adding the azolium salt may be in any step of preparing the coating liquid, and may be in any step of from preparing the organic silver salt to preparing the coating liquid when it is added to the image forming layer, which is preferably from post the preparation of the organic silver salt to immediately before coating. The method for adding the azolium salt may be any one in which it is added in the state of powder, a solution or a dispersion of fine particles. Also, it may be added in a solution mixed with other additive such as a sensitizing pigment, a reducing agent or a color toner. According to the present invention, the amount of addition of the azolium salt may be of any value, however, it is preferably 1×10⁻⁶ mol or greater and 2 mol or less, and more preferably 1×10⁻³ mol or greater and 0.5 mol or less per mol of the silver.

(Explanation of Reducing Agent)

It is preferred that a reducing agent for the organic silver salt is added to the photothermographic material of the present invention. The reducing agent for the organic silver salt may be an arbitrary substance (preferably an organic substance) which reduces a silver ion into the metal silver. Examples of such a reducing agent are described in paragraph Nos. 0043 to 0045 of JP-A No. 11-65021, page 7, line 34 to page 18, line 12 in EP-A No. 0803764. In the present invention, the reducing agent is preferably a so-called hindered phenolic reducing agent having a substituent at the ortho position of a phenolic hydroxyl group, or a bisphenolic reducing agent. In the present invention, particularly preferred reducing agent is a compound represented by the following formula (R).

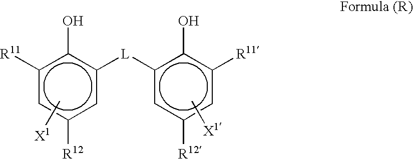

In the formula (R), R¹¹ and R^{11′} each independently represent an alkyl group having 1 to 20 carbon atoms. R¹² and R^{12′} each independently represent a hydrogen atom or a substituent which can be substituted in the benzene ring. L represents a —S— group, or a —CHR¹³— group. R¹³ represents a hydrogen atom or an alkyl group having 1 to 20 carbon atoms. X¹ and X^{1′} each independently represent a hydrogen atom or a substituent which can be substituted in the benzene ring.

The formula (R) is now explained in detail.

Hereinafter, when an alkyl group is referred to, a cycloalkyl group is also contained therein unless particularly noted.

1) R¹¹ and R^{11′}

R¹¹ and R^{11′} are each independently a substituted or unsubstituted alkyl group having 1 to 20 carbon atoms. Although the substituent of the alkyl group is not particularly limited, preferable examples include aryl groups, a hydroxy group, alkoxy groups, aryloxy groups, alkylthio groups, arylthio groups, acylamino groups, sulfoneamide groups, a sulfonyl group, a phosphoryl group, acyl groups, carbamoyl groups, ester groups, ureide groups, an urethane group, halogen atoms and the like.

2) R¹² and R^{12′}, X¹ and X^{1′}

R¹² and R^{12′} are each independently a hydrogen atom or a substituent which can be substituted in a benzene ring, and X¹ and X^{1′} also each independently represent a hydrogen atom or a substituent which can be substituted in a benzene ring. Preferred examples of the group which can be substituted in a benzene ring, respectively, include alkyl groups, aryl groups, halogen atoms, alkoxy groups and acylamino groups.

3) L

L represents a —S— group or a —CHR¹³— group. R¹³ represents a hydrogen atom or an alkyl group having 1 to 20 carbon atoms, and the alkyl group may have a substituent. Specific examples of the unsubstituted alkyl group of R¹³ include a methyl group, an ethyl group, a propyl group, a butyl group, a heptyl group, an undecyl group, an isopropyl group, a 1-ethylpentyl group, a 2,4,4-trimethylpentyl group, a cyclohexyl group, a 2,4-dimethyl-3-cyclohexenyl group, a 2,4-dimethyl-3-cyclohexenyl group and the like. Examples of the substituent of the alkyl group are similar to the substituent of R¹¹, which include halogen atoms, alkoxy groups, alkylthio groups, aryloxy groups, arylthio groups, acylamino groups, a sulfoneamide group, a sulfonyl group, a phosphoryl group, oxycarbonyl groups, carbamoyl groups, sulfamoyl groups and the like.

4) Preferable Substituent

Preferable examples of R¹¹ and R^{11′} include primary, secondary or tertiary alkyl groups having 1 to 15 carbon atoms, and specific examples include a methyl group, an isopropyl group, a t-butyl group, a t-amyl group, a t-octyl group, a cyclohexyl group, a cyclopentyl group, a 1-methylcyclohexyl group, a 1-methylcyclopropyl group and the like. More preferable examples of R¹¹ and R^{11′} include alkyl groups having 1 to 4 carbon atoms, and among them, a methyl group, a t-butyl group, a t-amyl group or a 1-methylcyclohexyl group is more preferred, while a methyl group or a t-butyl group is most preferred.

Preferable examples of R¹² and R^{12′} include alkyl groups having 1 to 20 carbon atoms, and specific examples include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, a methoxyethyl group and the like. More preferable examples include a methyl group, an ethyl group, a propyl group, an isopropyl group and a t-butyl group. Particularly preferably examples include a methyl group and an ethyl group.

X¹ and X^{1′} are preferably a hydrogen atom, a halogen atom, or an alkyl group, and more preferably a hydrogen atom.

L is preferably a —CHR¹³— group.

R¹³ is preferably a hydrogen atom or an alkyl group having 1 to 15 carbon atoms, wherein the alkyl group which is preferably used is a straight chain alkyl group as well as a cyclic alkyl group. Also, such an alkyl group having a C═C bond therein may be preferably used. Examples of the alkyl group include e.g., a methyl group, an ethyl group, a propyl group, an isopropyl group, a 2,4,4-trimethylpentyl group, a cyclohexyl group, a 2,4-dimethyl-3-cyclohexenyl group, a 3,5-dimethyl-3-cyclohexenyl group and the like. Particularly preferred R¹³ is a hydrogen atom, a methyl group, an ethyl group, a propyl group, an isopropyl group or a 2,4-dimethyl-3-cyclohexenyl group.

When R¹¹ and R^{11′} are a tertiary alkyl group while R¹² and R^{12′} are a methyl group, R¹³ is preferably a primary or secondary alkyl group having 1 to 8 carbon atoms (methyl group, ethyl group, propyl group, isopropyl group, 2,4-dimethyl-3-cyclohexenyl group and the like). When R¹¹ and R^{11′} are a tertiary alkyl group while R¹² and R^{12′} are an alkyl group other than a methyl group, R¹³ is preferably a hydrogen atom. When R¹¹ and R^{11′} are not a tertiary alkyl group, R¹³ is preferably a hydrogen atom or a secondary alkyl group, and particularly preferably a secondary alkyl group. Examples of the preferable group as the secondary alkyl group of R¹³ include an isopropyl group and a 2,4-dimethyl-3-cyclohexenyl group. The aforementioned reducing agent exhibits varying thermal development properties, developed silver color tone and the like depending on the combination of the R¹¹, R^{11′}, R¹², R^{12′} and R¹³. These can be adjusted by the combination of two or more reducing agents, therefore, two or more of them are preferably used in combination depending on the end.

Specific examples of the reducing agent in the present invention, in addition to the compounds represented by the formula (R) below, but the present invention is not limited thereto.

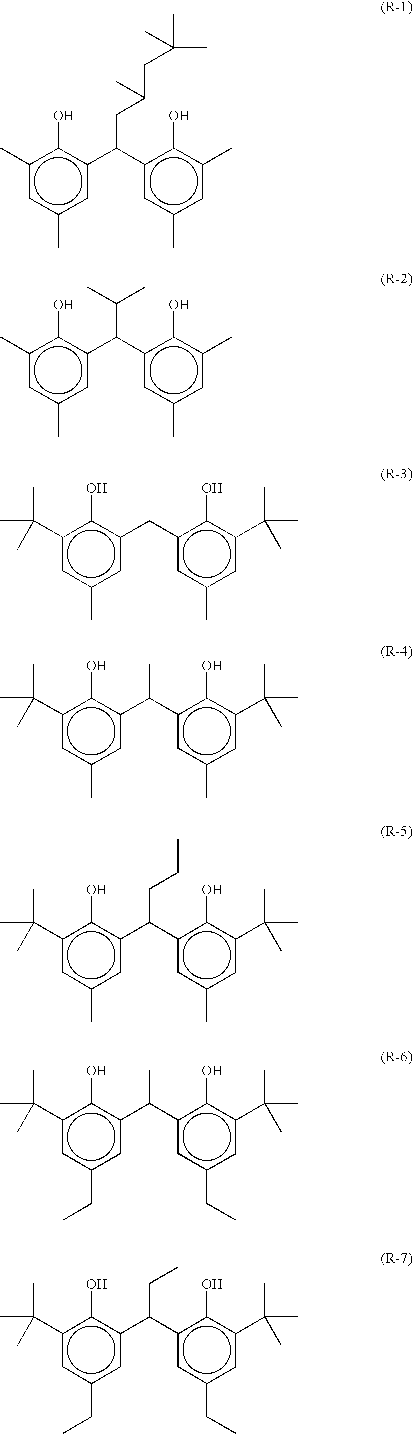

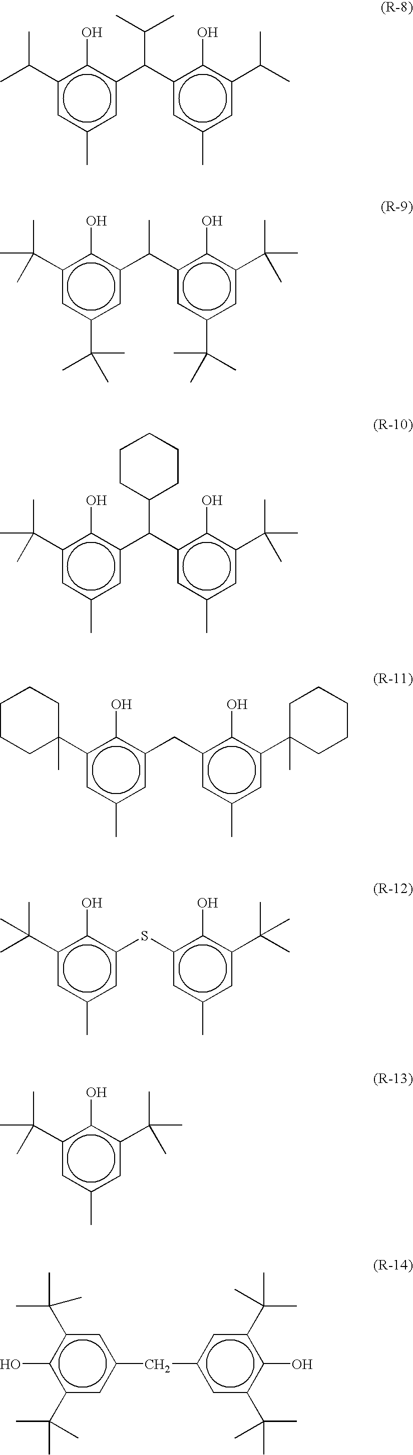

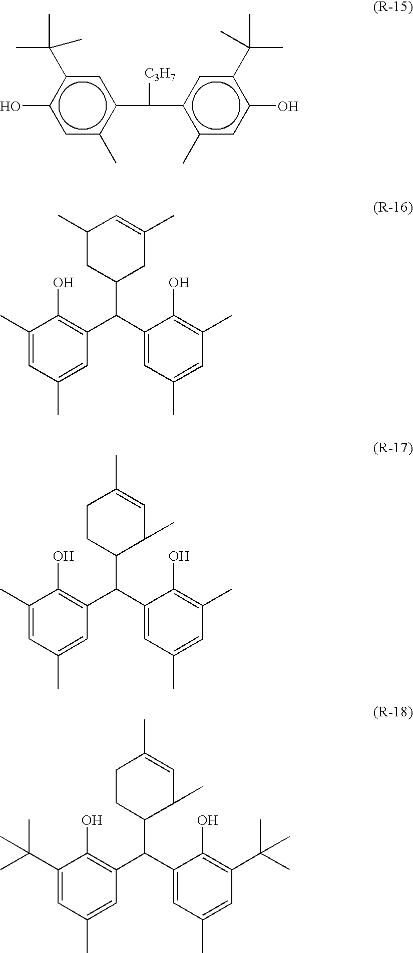

Examples of the preferred reducing agent in the present invention except for those described above include compounds described in JP-A Nos. 2001-188314, 2001-209145, 2001-350235 and 2002-156727, and EP-A No. 1278101.

In the present invention, the amount of addition of the reducing agent is, as the whole of the photosensitive material, preferably 0.1 g/m² or greater and 3.0 g/m² or less, more preferably 0.2 g/m² or greater and 2.0 g/m² or less, and still more preferably 0.3 g/m² or greater and 1.0 g/m² or less. The reducing agent is preferably contained in an amount of 5 mol % or greater and 50 mol % or less, more preferably 8 mol % or greater and 30 mol % or less, and still more preferably 10 mol % or greater and 20 mol % or less per mol of the silver in the side having the image forming layer.

The reducing agent may be contained in the coating liquid to permit it being contained in the photosensitive material by any method such as that via the solution state, emulsified dispersion state, solid fine particle dispersion state or the like. As a well known method of the emulsifying dispersion, there is a method of dissolving the reducing agent using an oil such as dibutyl phthalate, tricresyl phosphate, dioctyl sebacate or tri(2-ethylhexyl)phosphate, or an auxiliary solvent such as ethyl acetate or cyclohexanone, and mechanically producing the emulsified dispersion through adding a surface active agent such as sodium dodecylbenzene sulfonate, sodium oleoyl-N-methyltaurinate, sodium di(2-ethylhexyl)sulfosuccinate or the like. In this step, a polymer such as α-methylstyrene oligomer or poly(t-butylacrylamide) is also preferably added thereto for the purpose of adjusting the refractive index or viscosity of the oil droplet.

Also, as a solid fine particle dispersing method, there is a method of producing a solid dispersion by dispersing the powder of the reducing agent in a proper solvent such as water by a ball mill, a colloid mill, a vibration ball mill, a sand mill, a jet mill, a roller mill, or ultrasonic waves. In addition, in this case, a protective colloid (e.g., polyvinyl alcohol) or a surface active agent (e.g., anionic surface active agent such as sodium triisopropylnaphthalene sulfonate (a mixture of those each being different in substitution positions of three isopropyl groups)) may be used. The aforementioned mills usually use beads such as zirconia as a dispersion medium, and thus, Zr or the like eluted from the beads may be contaminated in the dispersion. The degree of the contamination is usually in the range of 1 ppm or greater and 1000 ppm or less although it may vary depending on the dispersion condition. When the content of Zr in the photosensitive material is 0.5 mg or less per gram of silver, it is practically permissible. It is preferred that an antiseptic agent (e.g., benzoisothiazolinone sodium salt) is contained in the aqueous dispersion. Particularly preferred is a solid particle dispersion method of the reducing agent, wherein the agent is added as fine particles having a mean particle size of 0.01 μm or greater and 10 μm or less, preferably 0.05 μm or greater and 5 μm or less, and more preferably 0.1 μm or greater and 2 μm or less. Herein, also other solid dispersion is preferably used after dispersing it to have the particle size to fall within this range.

(Explanation of Development Accelerator)

In the photothermographic material of the present invention, a sulfoneamide phenolic compound represented by the formula (A) described in JP-A Nos. 2000-267222 and 2000-330234 and the like; a hindered phenolic compound represented by the formula (II) described in JP-A No. 2001-92075; a hydrazine compound represented by the formula (I) described in JP-A Nos. 10-62895 and 11-15116 and the like, that represented by the formula (D) in JP-A No. 2002-156727, or that represented by the formula (1) described in JP-A No. 2002-278017; or a phenolic or naphtholic compound represented by the formula (2) described in JP-A No. 2001-264929 is preferably used as a development accelerator. Furthermore, a phenolic compound described in JP-A Nos. 2002-311533 and 2002-341484 are also preferred. In particular, a naphtholic compound described in JP-A No. 2003-66558 is preferred.

In the present invention, the development accelerator is used in the range of 0.1 mol % or greater and 20 mol % or less, preferably in the range of 0.5 mol % or greater and 10 mol % or less, and more preferably in the range of 1 mol % or greater and 5 mol % or less per the reducing agent.

Although the method of the introduction into the photosensitive material may be a similar method to that for the reducing agent, the development accelerator is particularly preferably added as a solid dispersion or an emulsified dispersion. When it is added as an emulsified dispersion, it is preferably added in the state of an emulsified dispersion through dispersing it using a solvent which has a high boiling point and which is a solid at an room temperature and an auxiliary solvent which has a low boiling point, or in the state of a so-called oil less emulsified dispersion without using a solvent having a high boiling point. According to the present invention, hydrazine compounds described in JP-A Nos. 2002-156727 and 2002-278017, and naphtholic compounds described in JP-A No. 2003-66558 are more preferred among the development accelerators illustrated above.

Particularly preferred development accelerators of the present invention are compounds represented by the following formulae (A-1) and (A-2).
Q₁-NHNH-Q₂ Formula (A-1)
wherein, Q₁ represents an aromatic group or a heterocyclic group coupling at a carbon atom to —NHNH-Q₂ and Q₂ represents a carbamoyl group, an acyl group, an alkoxycarbonyl group, an aryloxycarbonyl group, a sulfonyl group or a sulfamoyl group.

In formula (A-1), the aromatic group or the heterocyclic group represented by Q₁ is, preferably, 5 to 7 membered unsaturated ring. Preferred examples are a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isooxazole ring, and a thiophene ring. Condensed rings in which the rings described above are condensed to each other are also preferred.

The rings described above may have substituents and in a case where they have two or more substituents, the substituents may be identical or different with each other. Examples of the substituents can include halogen atoms, alkyl groups, aryl groups, carboamide groups, alkylsulfoneamide groups, arylsulfonamide groups, alkoxy groups, aryloxy groups, alkylthio groups, arylthio groups, carbamoyl groups, sulfamoyl groups, cyano groups, alkylsulfonyl groups, arylsulfonyl groups, alkoxycarbonyl groups, aryloxycarbonyl groups and acyl groups. In a case where the substituents are groups capable of substitution, they may have further substituents and examples of preferred substituents can include halogen atoms, alkyl groups, aryl groups, carbonamide groups, alkylsulfoneamide groups, arylsulfoneamide groups, alkoxy groups, aryloxy groups, alkylthio groups, arylthio groups, acyl groups, alkoxycarbonyl groups, aryloxycarbonyl groups, carbamoyl groups, cyano groups, sulfamoyl groups, alkylsulfonyl groups, arylsulfonyl groups and acyloxy groups.

The carbamoyl groups represented by Q₂ are carbamoyl groups preferably having 1 to 50 carbon atoms and, more preferably, having 6 to 40 carbon atoms, and examples can include not-substituted carbamoyl, methyl carbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbaoyl, N-3-pyridylcarbamoyl and N-benzylcarbamoyl.

The acyl group represented by Q₂is an acyl group, preferably, having 1 to 50 carbon atoms and, more preferably, 6 to 40 carbon atoms and can include, for example, formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl. Alkoxycarbonyl group represented by Q₂ is an alkoxycarbonyl group, preferably, of 2 to 50 carbon atom and, more preferably, of 6 to 40 carbon atoms and can include, for example, methoxycarbonyl, ethoxycarbonyl, isobutyloxycarbonyl, cyclehexyloxycarbonyl, dodecyloxycarbonyl and benzyloxycarbonyl.

The aryloxycarbonyl group represented by Q₂ is an aryloxycarbonyl group having preferably 7 to 50 carbon atoms, and more preferably 7 to 40 carbon atoms. Examples thereof include phenoxycarbonyl, 4-octyloxyphenoxycarbonyl, 2-hydroxymethylphenoxycarbonyl and 4-dodecyloxyphenoxycarbonyl. The sulfonyl group represented by Q₂ is a sulfonyl group having preferably 1 to 50 carbon atoms, and more preferably 6 to 40 carbon atoms. Examples thereof include methylsulfonyl, butylsulfonyl, octylsulfonyl, 2-hexadecylsulfonyl, 3-dodecyloxypropylsulfonyl, 2-octyloxy-5-tert-octylphenylsulfonyl and 4-dodecyloxyphenylsulfonyl.

The sulfamoyl group represented by Q₂ is a sulfamoyl group having preferably 0 to 50 carbon atoms, and more preferably 6 to 40 carbon atoms. Examples thereof include unsubstituted sulfamoyl, an N-ethylsulfamoyl group, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl and N-(2-tetradecyloxyphenyl)sulfamoyl. The group represented by Q₂ may further have a group illustrated as examples of the substituent of the 5- to 7-membered unsaturated ring represented by the above Q₁ at a position where substitution can be executed. When it has two or more substituents, those substituents may be the same or different.

Next, scope of the compound represented by the formula (A-1) is described. Q₁ is preferably a 5- to 6-membered unsaturated ring, and more preferred examples thereof include a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isooxazole ring, and a condensed ring of such a ring with a benzene ring or an unsaturated heterocycle. Also, Q₂ is preferably a carbamoyl group, and is particularly preferably a carbamoyl group having a hydrogen atom on its nitrogen atom.

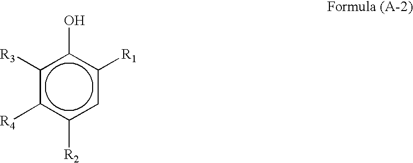

In the formula (A-2), R₁ represents an alkyl group, an acyl group, an acylamino group, a sulfoneamide group, an alkoxycarbonyl group or a carbamoyl group. R₂ represents a hydrogen atom, a halogen atom, an alkyl group, an alkoxy group, an aryloxy group, an alkylthio group, an arylthio group, an acyloxy group or a carbonic acid ester group. R₃ and R₄ each represent a group which can be substituted in a benzene ring illustrated as examples of the substituent in the formula (A-1). R₃ and R₄ may form a condensed ring through linking with each other.

R₁ is preferably an alkyl group having 1 to 20 carbon atoms (e.g., methyl group, ethyl group, isopropyl group, butyl group, tert-octyl group, cyclohexyl group and the like), an acylamino group (e.g., acetylamino group, benzoylamino group, methylureide group, 4-cyano phenylureide group and the like) or a carbamoyl group (n-butylcarbamoyl group, N,N-diethylcarbamoyl group, phenylcarbamoyl group, 2-chlorophenylcarbamoyl group, 2,4-dichlorophenylcarbamoyl group and the like), and more preferably an acylamino group (including ureide group, urethane group). R₂ is preferably a halogen atom (more preferably, chlorine atom or bromine atom), an alkoxy group (e.g., methoxy group, butoxy group, n-hexyloxy group, n-decyloxy group, cyclohexyloxy group, benzyloxy group and the like) or an aryloxy group (phenoxy group, naphthoxy group and the like).

R₃ is preferably a hydrogen atom, a halogen atom or an alkyl group having 1 to 20 carbon atoms, and most preferably a halogen atom. R₄ is preferably a hydrogen atom, an alkyl group or an acylamino group, and more preferably an alkyl group or an acylamino group. Examples of the preferred substituent thereof are similar to R₁. When R₄ is an acylamino group, it is also preferred that R₄ links to R₃ to form a carbostyril ring.

When R₃ and R₄ form a condensed ring through linking with each other in the formula (A-2), the condensed ring is particularly preferably a naphthalene ring. To the naphthalene ring may be bound the same substituent as the example of the substituent illustrated in the formula (A-1). When the formula (A-2) represents a naphtholic compound, R₁ is preferably a carbamoyl group. Among them, a benzoyl group is particularly preferred. R₂ is preferably an alkoxy group or an aryloxy group, and particularly preferably an alkoxy group.

Specific examples of the preferred development accelerator in the present invention are illustrated below. The present invention is not limited thereto.

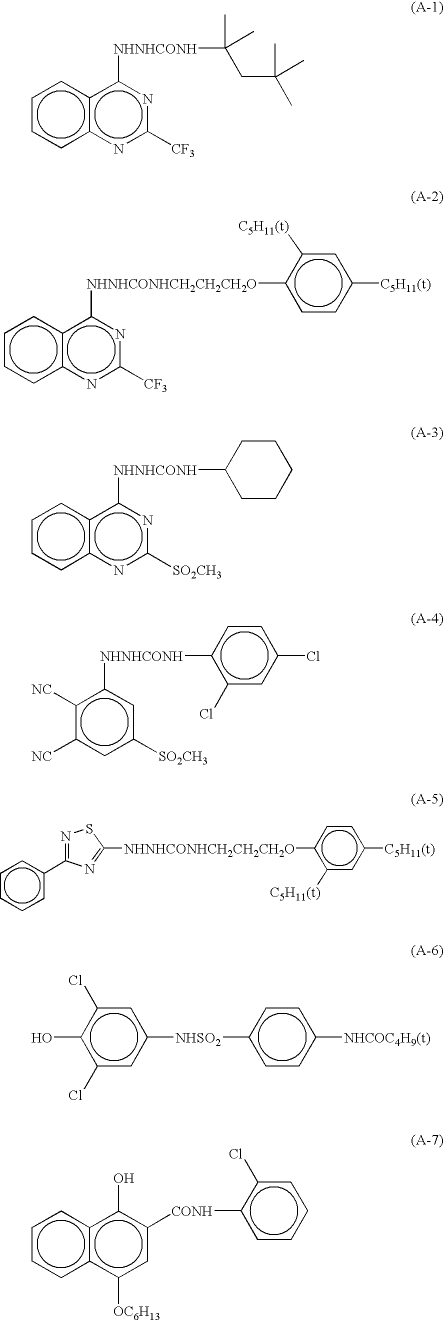

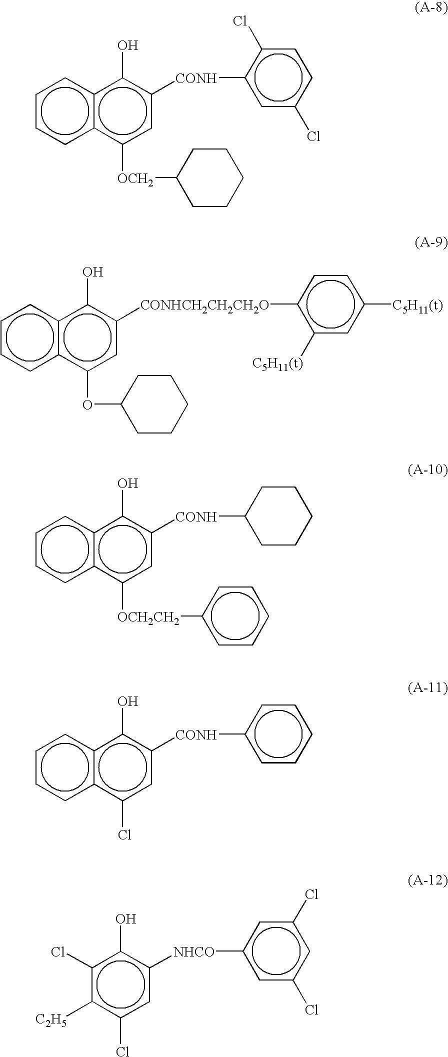

(Explanation of Hydrogen Bonding Compound)

When the reducing agent in the present invention has an aromatic hydroxyl group (—OH) or amino group (—NHR, wherein R is a hydrogen atom or an alkyl group), particularly in cases of the aforementioned bisphenols, it is preferred that a nonreducing compound having a group capable of forming a hydrogen bond with the group is used in combination.

Examples of the group which forms a hydrogen bond with the hydroxyl group or amino group include phosphoryl groups, sulfoxide groups, sulfonyl groups, carbonyl groups, amide groups, ester groups, urethane groups, ureide groups, tertiary amino groups, nitrogen-containing aromatic groups and the like. Among them, preferable examples include compounds having a phosphoryl group, a sulfoxide group, an amide group (not having an >N—H group, but being blocked as >N—Ra (wherein Ra is a substituent other than H)), an urethane group (not having an >N—H group, but being blocked as >N—Ra (wherein Ra is a substituent other than H)) or an ureide group (not having an >N—H group, but being blocked as >N—Ra (wherein Ra is a substituent other than H)). In the present invention, particularly preferred hydrogen bonding compound is a compound represented by the following formula (D).

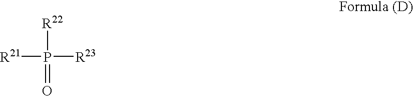

In the formula (D), R²¹ to R²³ each independently represent an alkyl group, an aryl group, an alkoxy group, an aryloxy group, an amino group or a heterocyclic group, and these groups may be unsubstituted, or may have a substituent.

Examples of the substituent when R²¹ to R²³ has a substituent include halogen atoms, alkyl groups, aryl groups, alkoxy groups, amino groups, acyl groups, acylamino groups, alkylthio groups, arylthio groups, sulfoneamide groups, acyloxy groups, oxycarbonyl groups, carbamoyl groups, sulfamoyl groups, sulfonyl groups, phosphoryl groups and the like. Preferred substituent is an alkyl group or an aryl group, and examples thereof include a methyl group, an ethyl group, an isopropyl group, a t-butyl group, a t-octyl group, a phenyl group, a 4-alkoxyphenyl group, a 4-acyloxyphenyl group and the like.

Specific examples of the alkyl group of R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, a 2-phenoxypropyl group and the like.

Specific examples of the aryl group of R²¹ to R²³ include a phenyl group, a cresyl group, a xylyl group, a naphthyl group, a 4-t-butylphenyl group, a 4-t-octylphenyl group, a 4-anisidyl group, a 3,5-dichlorophenyl group and the like.

Specific examples of the alkoxy group of R²¹ to R²³ include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, a benzyloxy group and the like.

Specific examples of the aryloxy group of R²¹ to R²³ include a phenoxy group, a cresyloxy group, an isopropylphenoxy group, a 4-t-butylphenoxy group, a naphthoxy group, a biphenyloxy group and the like.

Specific examples of the amino group of R²¹ to R²³ include a dimethylamino group, a diethylamino group, a dibutylamino group, a dioctylamino group, an N-methyl-N-hexylamino group, a dicyclohexylamino group, a diphenylamino group, an N-methyl-N-phenylamino group and the like.

R²¹ to R²³ are preferably an alkyl group, an aryl group, an alkoxy group or an aryloxy group. In the light of the effect of the present invention, at least one or more of R²¹ to R²³ is preferably an alkyl group or an aryl group, and more preferably, two or more thereof are an alkyl group or an aryl group. Moreover, in the light of availability at a low cost, R²¹ to R²³ are preferably the same group.

Hereinafter, specific examples of the hydrogen bonding compound including the compounds represented by the formula (D) in the present invention are illustrated, however, the present invention is not limited thereto.

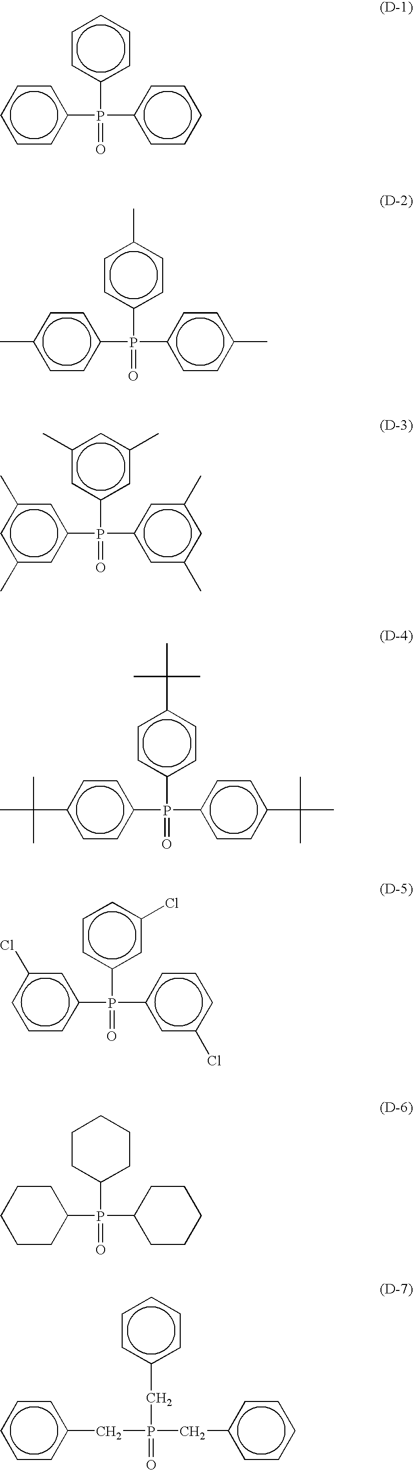

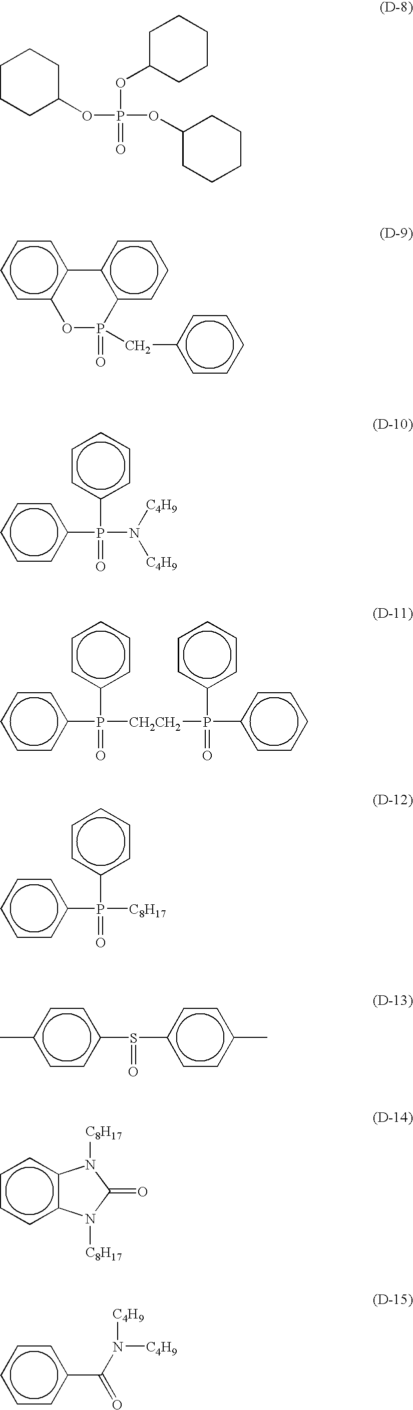

Specific examples of the hydrogen bonding compound include those described in European Patent No. 1096310, JP-A Nos. 2002-156727 and 2002-318431, in addition to those described above. The compound represented by the formula (D) in the present invention can be used in the photosensitive material through incorporating it in the solution state, emulsified dispersion state or solid dispersed fine particle dispersion state, similarly to the reducing agent. Preferably, the compound is used in the state of a solid dispersion. These compounds form a hydrogen bonding complex with a compound having a phenolic hydroxyl group or an amino group in the solution state, and in accordance with the type of the combination of the reducing agent and the compound of the formula (D) in the present invention, the compound can be isolated in the crystal state as a complex. It is particularly preferred in terms of achieving a stable performance to use thus isolated crystal powder as the solid fine particle dispersion. Also, a method of mixing the reducing agent and the compound of the formula (D) in the present invention in the state of powder, and forming the complex upon dispersion using a adequate dispersing agent with a sand grinder mill or the like can be preferably used. The compound of the formula (D) according to the present invention is used preferably in the range of 1 mol % or greater and 200 mol % or less, more preferably in the range of 10 mol % or greater and 150 mol % or less, and still more preferably in the range of 20 mol % or greater and 100 mol % per the reducing agent.

(Explanation of Silver Halide)

1) Halogen Composition

The photosensitive silver halide for use in the present invention is not particularly limited in terms of its halogen composition, but silver chloride, silver bromochloride, silver bromide, silver bromoiodide, silver bromochloriodoide or silver iodide can be used. Among them, preferred examples include silver bromide, silver bromoiodide and silver iodide. The distribution of the halogen composition in the particle may be uniform, or the halogen composition may vary in a stepwise manner or in a continuous manner. Further, silver halide particles having a core/shell structure can be preferably used. Double to quintuple structure type core/shell particles can be preferably used, and double to quadruple structure type core/shell particles can be more preferably used. Also, a technique of allowing localization of silver bromide or silver iodide on the surfaces of silver chloride, silver bromide or silver bromochloride particles can be preferably used. Moreover, in the photothermographic material having the image forming layer on both sides of the support, silver halide having high silver iodide content is preferred. The silver iodide content in the silver halide is preferably 40 mol % or greater and 100 mol % or less, more preferably 70 mol % or greater and 100 mol % or less, still more preferably 80 mol % or greater and 100 mol % or less, and particularly preferably 90 mol % or greater and 100 mol % or less, in view of the image storability against the light irradiation following the processing.

2) Method of Grain Formation

The method of forming photosensitive silver halide is well-known in the relevant art and, for example, methods described in Research Disclosure No. 10729, June 1978 and U.S. Pat. No. 3,700,458 can be used. Specifically, a method of preparing a photosensitive silver halide by adding a silver-supplying compound and a halogen-supplying compound in a gelatin or other polymer solution and then mixing them with an organic silver salt is used. Further, a method described in JP-A No. 11-119374 (paragraph Nos. 0217 to 0224) and methods described in JP-A Nos. 11-352627 and 2000-347335 are also preferred.

3) Grain Size

The grain size of the photosensitive silver halide is preferably small with an aim of suppressing clouding after image formation and, specifically, it is 0.20 μm or less, more preferably, 0.01 μm to 0.15 μm and, further preferably, 0.02 μm to 0.12 μm. The grain size as used herein means an average diameter of a circle converted such that it has a same area as a projection area of the silver halide grain (projection area of a main plane in a case of a tabular grain). In photothermographic material having the image forming layer on both sides of the support, the grain size of the photosensitive silver halide can be selected sufficient large grain size for the sake of achieving high sensitivity. In this case, the grain size of the photosensitive silver halide based on average sphere equivalent diameter is preferably 0.3 μm to 5.0 μm and, further preferably, 0.35 μm to 3.0 μm.

4) Grain Shape

The shape of the silver halide grain can include, for example, cubic, octahedral, tabular, spherical, rod-like or potato-like shape. The cubic grain is particularly preferred in the present invention. A silver halide grain rounded at corners can also be used preferably. While there is no particular restriction on the index of plane (Mirror's index) of an crystal surface of the photosensitive silver halide grain, it is preferred that the ratio of [100] face is higher, in which the spectral sensitizing efficiency is higher in a case of adsorption of a spectral sensitizing dye. The ratio of [100] face is preferably 50% or more, more preferably, 65% or more and, further preferably, 80% or more. The ratio of the Mirror's index [100) face can be determined by the method of utilizing the adsorption dependency of [111] face and [100] face upon adsorption of a sensitizing dye described by T. Tani; in J. Imaging Sci., vol. 29, page 165 (1985). The silver halide of a composition having high silver iodide content which is suitable for photothermographic material having the image forming layer on both sides of the support can take a complicate form and the preferred form can include, for example, a joined particle shown by R. L. JENKINS, et al., in J. of Phot. Sci. vol. 28 (1980), p 164 -FIG. 1. A plate particle shown in FIG. 1 can also be used preferably.

5) Heavy Metal

The photosensitive silver halide particle in the present invention may contain a metal or a metal complex belonging to groups 3 to 13 in the periodic table (showing groups 1 to 18). The metal or a the central metal of the metal complex belonging to groups 3 to 13 in the periodic table is preferably rhodium, ruthenium or iridium. The metal complex may be used alone, or two or more kinds of complexes having the same kind of metal or different kinds of metals may be used in combination. The content is preferably in the range of 1×10⁻⁹ mol or greater and 1×10⁻³ mol or less per mol of the silver. These heavy metals, metal complexes and methods for adding them are described in JP-A No. 7-225449, paragraph Nos. 0018 to 0024 of JP-A No. 1165021, and paragraph Nos. 0227 to 0240 of JP-A No. 11-119374.

In the present invention, a silver halide grain having a hexacyano metal complex is present on the outermost surface of the grain is preferred. The hexacyano metal complex includes, for example, [Fe(CN)₆]⁴⁻, [Fe(CN)₆]³−, [Ru(CN)₆]⁴−, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the present invention, hexacyano Fe complex is preferred.

Since the hexacyano complex exists in ionic form in an aqueous solution, paired cation is not important and alkali metal ion such as sodium ion, potassium ion, rubidium ion, cesium ion and lithium ion, ammonium ion, alkyl ammonium ion (for example, tetramethyl ammonium ion, tetraethyl ammonium ion, tetrapropyl ammonium ion, and tetra(n-butyl) ammonium ion), which are easily misible with water and suitable to precipitation operation of a silver halide emulsion are preferably used.

The hexacyano metal complex can be added while being mixed with water, as well as a mixed solvent of water and an appropriate organic solvent miscible with water (for example, alcohols, ethers, glycols, ketones, esters and amides) or gelatin.

The amount of addition of the hexacyano metal complex is preferably 1×10⁻³ mol or greater and 1×10⁻² mol or less, and more preferably 1×10⁻⁴ mol or greater and 1×10⁻³ mol or less per mol of the silver.

In order to allow the hexacyano metal complex to be present on the outermost surface of a silver halide grain, the hexacyano metal complex is directly added in any stage of: after completion of addition of an aqueous solution of silver nitrate used for grain formation, before completion of emulsion forming step prior to a chemical sensitization step, of conducting chalcogen sensitization such as sulfur sensitization, selenium sensitization and tellurium sensitization or noble metal sensitization such as gold sensitization; during washing step; during dispersion step; or before chemical sensitization step. In order not to grow the fine silver halide grain, the hexacyano metal complex is rapidly added preferably after the grain is formed, and it is preferably added before completion of the emulsion forming step.

Addition of the hexacyano complex may be started after addition of 96% by mass of an entire amount of silver nitrate to be added for grain formation, more preferably started after addition of 98% by mass and, particularly preferably, started after addition of 99% by mass.

When the hexacyano metal complex is added after adding the aqueous silver nitrate solution immediately before completing the formation of the particles, the silver halide particles can be adsorbed on the uppermost surface, and almost all thereof form an insoluble salt with the silver ion on the particle surface. Because the silver salt of this hexacyano iron (II) is a more insoluble salt than AgI, redissolution due to the fine particles can be prevented, thereby enabling the production of silver halide fine particles having a smaller particle size.

Metal atoms that can be contained in the silver halide grain used in the present invention (for example, [Fe(CN)₆]⁴⁻), desalting method of a silver halide emulsion and chemical sensitization method are described in paragraph Nos. 0046 to 0050 of JP-A No. 1184574, in paragraph Nos. 0025 to 0031 of JP-A No. 1165021, and paragraph Nos. 0242 to 0250 of JP-A No. 11-19374.

6) Gelatin

As the gelatin contained the photosensitive silver halide emulsion used in the present invention, various kinds of gelatins can be used. It is necessary to maintain an excellent dispersion state of a photosensitive silver halide emulsion in an organic silver salt containing coating solution, and gelatin having a molecular weight of 10,000 to 1,000,000 is preferably used. And phthalated gelatin is also preferably used. These gelatins may be used at grain formation step or at the time of dispersion after desalting treatment and it is preferably used at grain formation step.

7) Sensitizing Dye

As the sensitizing dye applicable in the present invention, those capable of spectrally sensitizing silver halide grains in a desired wavelength region upon adsorption to silver halide grains having spectral sensitivity suitable to spectral characteristic of an exposure light source can be selected advantageously. The sensitizing dyes and the addition method are disclosed, for example, JP-A No. 11-65021 (paragraph Nos. 0103 to 0109), as a compound represented by the formula (11) in JP-A No. 10-186572, dyes represented by the formula (I) in JP-A No. 11-119374 (paragraph No. 0106), dyes described in U.S. Pat. Nos. 5,510,236 and 3,871,887 (Example 5), dyes disclosed in JP-A Nos. 2-96131 and 59-48753, as well as in page 19, line 38 to page 20, line 35 of EP-A No. 0803764A1, and in JP-A Nos. 2001-272747, 2001-290238 and 2002-23306. The sensitizing dyes described above may be used alone or two or more of them may be used in combination. In the present invention, sensitizing dye can be added preferably after desalting step and before coating step, and more preferably after desalting step and before the completion of chemical ripening.

In the present invention, the sensitizing dye may be added at any amount according to the property of photosensitivity and fogging, but it is preferably added from 104 mol to 1 mol, and more preferably, from 10⁻⁴ mol to 10⁻¹ mol per one mol of silver in each case.

The photothermographic material of the present invention may also contain super sensitizers in order to improve spectral sensitizing effect. The super sensitizers usable in the present invention can include those compounds described in EP-A No. 587338, U.S. Pat. Nos. 3,877,943 and 4,873,184 and JP-A Nos. 5-341432, 11-109547, and 10-111543.

8) Chemical Sensitization

It is preferred that the photosensitive silver halide particle according to the present invention is chemically sensitized with a sulfur sensitization method, a selenium sensitization method or a tellurium sensitization method. The compound which is preferably used in the sulfur sensitization method, selenium sensitization method or tellurium sensitization method may be a known compound, and for example, the compound described in JP-A No. 7-128768 and the like may be used. The tellurium sensitization is particularly preferred in the present invention, and the compounds described in paragraph No. 0030 of JP-A No. 11-65021, as well as the compounds represented by the formulae (II), (III) and (IV) in JP-A No. 5-313284 are more preferably used.

The photosensitive silver halide particle in the present invention is preferably chemically sensitized with a gold sensitization method alone, or in combination with the aforementioned chalcogen sensitization. The gold sensitizer preferably has a gold valence of positive monovalent or positive trivalent. It is preferred that the gold sensitizer is a commonly used gold compound. Representative examples include chloroauric acid, bromoauric acid, potassium chloroaurate, potassium bromoaurate, auric trichloride, potassium auric thiocyanate, potassium iodo aurate, tetracyano auric acid, ammonium aurothiocyanate, pyridyl trichloro gold and the like. Also, gold sensitizers described in U.S. Pat. No. 5,858,637 and Japanese Patent Application No. 2001-79450 may be preferably used.

In the present invention, the chemical sensitization can be carried out at any time as long as it is after formation of the particles and before coating, which can be (1) before spectral sensitization, (2) concurrently with the spectral sensitization, (3) after the spectral sensitization, or (4) immediately before coating, following desalting. The amount of the sulfur, selenium and tellurium sensitizer used in the present invention may vary depending on the used silver halide particle, chemical ripening conditions and the like. However, the sensitizer is used in an amount of approximately 10⁻⁸ mol or greater and 10⁻² mol or less, and preferably approximately 10⁻⁷ mol or greater and 10⁻³ mol or less per mol of the silver halide. Although the amount of addition of the gold sensitizer may vary depending on a variety of conditions, rough standard may be 10⁻⁷ mol or greater and 10⁻³ mol or less, and more preferably 10⁻⁶ mol or greater and 5×10⁻⁻⁴ mol or less per mol of the silver halide. Conditions of the chemical sensitization according to the present invention are not particularly limited, however, in the preferred condition, the pH may be 5 to 8; the pAg may be 6 to 11; and the temperature may be approximately 40 to 95° C. To the silver halide emulsion for use in the present invention may be added a thiosulfonic acid compound according to the method described in EP-A No. 293,917.

In the photosensitive silver halide particle according to the present invention, a reducing agent is preferably used. Specific examples of the compound preferably used in the reduction sensitization method include ascorbic acid and aminoiminomethane sulfinic acid, and in addition thereto, stannous chloride, a hydrazine derivative, a borane compound, a silane compound, a polyamine compound or the like is preferably used. Addition of the reduction sensitizer may be conducted in any process, starting from the crystal growth to immediately before coating, during the preparation step in the photosensitive emulsion production steps. Also, the reduction sensitization is preferably carried out by ripening the emulsion through keeping it at a pH of 7 or higher, or at a pAg of 8.3 or less. Alternatively, it is also preferred that the reduction sensitization is carried out by introducing a single addition part of silver ions during the particle formation.

9) Compound in Which a One-Electron Oxidant Formed by One-Electron Oxidation can Release One Electron or More Electrons

The photothermographic material in the present invention preferably contains a compound in which a one-electron oxidant formed by one-electron oxidation can release one electron or more electrons. The compound is used alone or together with the various chemical sensitizers described above and can increase sensitivity of the silver halide.

The compound in which a one-electron oxidant formed by one-electron oxidation can release one electron or more electrons contained in the photosensitive material of the present invention is a compound selected from the following types 1 and 2.

Type 1 and Type 2 compounds contained in the photothermographic material of the present invention are to be described.

(Type 1)

A compound in which a one-electron oxidant formed by one-electron oxidation can further release one or more electrons accompanying successive bonding cleavage reaction.

(Type 2)

A compound in which a one-electron oxidant formed by one-electron oxidation can further release one or more electrons after successive bonding forming reaction.

At first the type 1 compound is described.

The type 1 compound in which a one-electron oxidant formed by one-electron oxidation can further release one electron accompanying successive bonding cleavage reaction can include those compounds which are referred to as “1-photon 2-electron sensitizing agent” or “deprotonating electron donating sensitizing agent” described in patent literatures such as JP-A No. 9-211769 (specific examples: compounds PMT-1 to S-37 described in Table E and Table F in pages 28-32), JP-A Nos. 9-211774, and 1195355 (specific examples: compounds INV 1 to 36), JP-W No. 2001-500996 (specific examples; compounds 1 to 74, 80 to 87, and 92 to 122), U.S. Pat. Nos. 5,747,235 and 5,747,236, EP No. 786692 A1 (specific examples: compounds INV 1 to 35), EP-A No. 893732 A1, U.S. Pat. Nos. 6,054,260 and 5,994,051. Further, preferred ranges for the compounds are identical with the preferred ranges described in the cited patent specifications.

The type 1 compound in which a one-electron oxidant formed by one-electron oxidation can further release one electron or more electrons accompanying successive bonding cleavage reaction can include those compounds represented by formula (1) (identical with formula (1) described in JP-A No. 2003-114487), formula (2) (identical with formula (2) described in JP-A No. 2003-114487), formula (3) (identical with formula (1) described in JP-A No. 2003-114488), formula (4) (identical with formula (2) described in JP-A No. 2003-114488), formula (5) (identical with formula (3) described in JP-A No. 2003-114488), formula (6) (identical with formula (1) described in JP-A No. 2003-75950), formula (7) (identical with formula (2) described in JP-A No. 2003-75950), formula (8) (identical with formula (1) described in JP-A No. 2004-239943, which has not been published at the time of the present application), and formula (9) (identical with formula (3) described in JP-A No. 2004-245929, which has not been published at the time of the present application) among the compounds capable of causing reaction represented by the chemical reaction formula (1) (identical with chemical reaction formula (1) described in Japanese Patent Application No. 2003-33446, which has not been published at the time of the present application). Further, preferred ranges for the compounds are identical with the preferred ranges described in the cited patent specifications. The disclosure of the above-described patent documents are incorporated by reference herein.

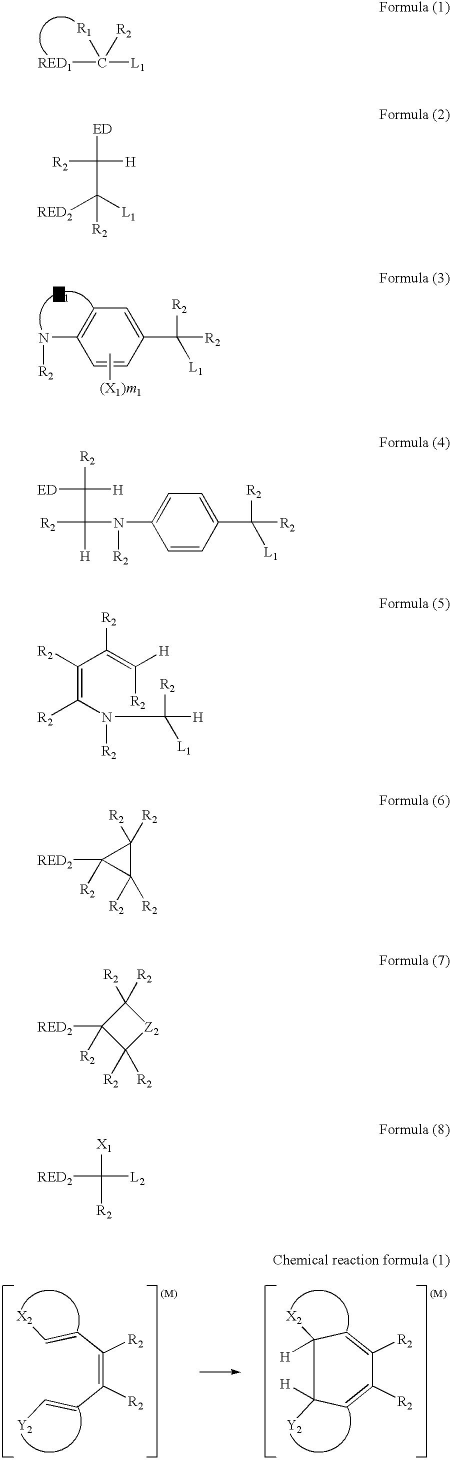

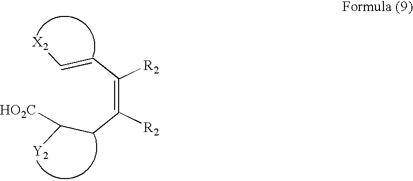

In the formulae, RED, and RED₂ represent a reductive group. R₁ represents a nonmetal atomic group which can form a cyclic structure corresponding to a tetrahydro form or an octahydro form of a 5-membered or 6-membered aromatic ring (including an aromatic heterocycle) together with a carbon atom (C) and RED₁. R₂ represents a hydrogen atom or a substituent. When multiple R₂ are present within a single molecule, these may be the same or different. L₁ represents a leaving group. ED represents an electron donating group. Z₁ represents an atomic group which can form a 6-membered ring with a nitrogen atom and two carbon atoms in the benzene ring. X₁ represents a substituent, and ml represents an integer number of 0 to 3. Z₂ represents —CR₁₁R₁₂—, —NR₁₃—, or —O—. R₁₁ and R₁₂ each independently represent a hydrogen atom or a substituent. R₁₃ represents a hydrogen atom, an alkyl group, an aryl group or a heterocyclic group. X₁ represents an alkoxy group, an aryloxy group, a heterocyclic oxy group, an alkylthio group, an arylthio group, a heterocyclic thio group, an alkylamino group, an aryl amino group or a heterocyclic amino group. L₂ represents a carboxy group or a salt thereof, or a hydrogen atom. X₂ represents a group which forms a 5-membered heterocycle with C═C. Y₂ represents a group which forms a 5-membered or 6-membered aryl group or heterocyclic group with C═C. M represents a radical, a radical cation, or a cation.

Next, type 2 compound is explained. Examples of the type 2 compound of whose one electron oxidized product generated by one electron oxidation can release one electron or more electrons accompanied by successive binding formation reaction include compounds represented by the formula (11) (equal to the formula (2) described in JP-A No. 2004-245929) that are compounds which can cause the reaction represented by the formula (10) (equal to the formula (1) described in JP-A No. 2003-140287) and the chemical reaction formula (1) (equal to the chemical reaction formula (1) described in JP-A No. 2004-245929). Preferred scope of these compounds is identical to the preferred scope described in the cited patent specification.

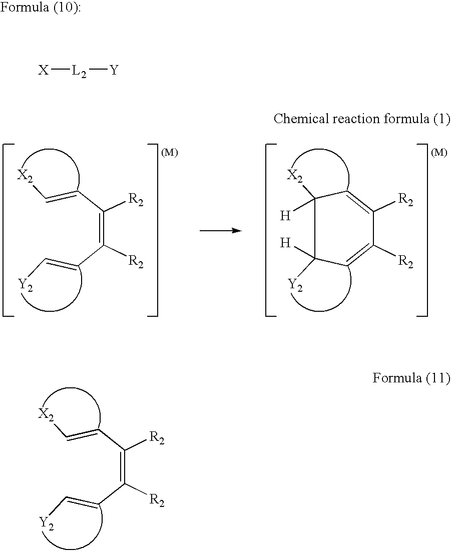

In the formulae, X represents a reductive group to be subjected to the one electron oxidation. Y represents a reactive group including a carbon-carbon double bond site, a carbon-carbon triple bond site, an aromatic group site, or a nonaromatic heterocyclic site of a benzo-condensed ring, which can form a new binding by a reaction with the one electron oxidized product produced upon one electron oxidation of X. L₂ represents a linking group that links between X and Y. R₂ represents a hydrogen atom or a substituent. When multiple R₂ are present within a single molecule, these may be the same or different. X₂ represents a group which forms a 5-membered heterocycle with C═C. Y₂ represents a group which forms a 5-membered or 6-membered aryl group or heterocyclic group with C═C. M represents a radical, a radical cation, or a cation.

Among the type 1 and type 2 compounds, preferred are “compound having an adsorptive group to silver halide in the molecule” or “compound having a partial structure of a spectral sensitizing dye in the molecule”. A typical absorptive group to the silver halide is a group described in the specification of JP-A No. 2003-156823, page 16, right column, line 1 to page 17, right column, line 12. The partial structure for the spectral sensitizing dye is a structure described in the above-mentioned specification, page 17, right column, line 34 to page 18, left column, line 6.

Among the type 1 and type 2 compounds, more preferred are “compound having at least one adsorptive group to silver halide in the molecule” and, further preferably, “compound having two or more absorptive groups to silver halide in the identical group”. In a case where two or more absorptive groups are present in a single molecule, the absorptive groups may be identical or different with each other.

Preferred adsorptive groups can include a mercapto-substituted nitrogen-containing heterocyclic group (for example, 2-mercaptothiadiazole group, 3-mercapto-1,2,4-triazole group, 5nercaptotetrazole group, 2-mercapto-1,3,4-oxathiazole group, 2-mercaptobenzoxazole group, 2-mercaptobenzthiazole group, 1,5-dimethyl-1,2,4-triazolium-3-thiorate group, etc.), or a nitrogen-containing hetero-ring group having —NH— group capable of forming imino silver (>NAg) as a partial structure of the heterocyclic (for example, benzotriazole group, benzimadazole group, indazole group, etc.). Particularly preferred are 5-mercaptotetrazole group, 3-mercapto-1,2,4-triazole group, and benzotriazole group and, most preferred are 3inercapto-1,2,4-triazole group and 5-mercaptotetrazole group.

Absporptive group having two or more mercapto groups in the molecule as the partial structure are also particularly preferred. The mercapto group (—SH), in a case where it is tautomerically isomerizable, may form a thion group. Preferred examples of adsorptive groups having two or more mercapto groups as the partial structure (for example, dimercapto substituted nitrogen-containing heterocyclic group) can include a 2,4-dimercaptopyrimidine group, 2,4-dimercaptotriazine group, and 3,5-dimercapto-1,2,4-triazole group.

Furthermore, a quaternary salt structure of nitrogen or phosphorus is also used preferably as an adsorptive group. The quaternary salt structure of nitrogen is specifically, an ammonio group (trialkylammonio group, dialkylaryl (or heteroaryl)ammonio group, alkyldiaryl(or heteroaryl)ammonio group or the like) or a group having a nitrogen-containing heterocyclic group which includes a quaternarized nitrogen atom. Examples of the quaternary salt structure of phosphorus include phosphonio groups (trialkylphosphonio group, dialkylaryl(or heteroaryl)phosphonio group, alkyldiaryl(or heteroaryl)phosphonio group, triaryl(or heteroaryl) phosphonio group and the like). The quaternary salt structure of nitrogen is more preferably used, and still more preferably, a nitrogen-containing aromatic heterocyclic group having a 5-membered ring or a 6-membered ring which includes a quaternarized nitrogen atom. Particularly preferably, a pyridinio group, a quinolinio group or an isoquinolinio group is used. These nitrogen-containing heterocyclic groups including a quaternarized nitrogen atom may have an arbitrary substituent.

Examples of the counter anion of the quaternary salt include a halogen ion, a carboxylate ion, a sulfonate ion, a sulfate ion, a perchloric ion, a carbonate ion, a nitrate ion, BF₄⁻, PF₆⁻, Ph₄B⁻ and the like. When a group having a negative charge such as a carboxylate group or the like is present within the molecule, an intramolecular salt may be formed therewith. As the counter anion which is not present in the molecule, a chlorine ion, a bromo ion or a methanesulfonate ion is particularly preferred.

Preferred structure of the compound represented by type 1 or 2 having a quaternary salt structure of nitrogen or phosphorus, as an adsorptive group, is represented by the formula (X).
(P-Q₁-)ᵢ-R(-Q₂-S)ⱼ Formula (X)

In the formula (X), P and R each independently represent a quaternary salt structure of nitrogen or phosphorus which is not a partial structure of the sensitizing pigment. Q₁ and Q₂ each independently represent a linking group, and specifically, represent a group of a single bond, an alkylene group, an arylene group, a heterocyclic group, each group of —O—, —S—, —NRN—, (═O)—, —SO₂—, —SO—, —P(═O)— alone, or a combination of these groups. R_{N} herein represents a hydrogen atom, an alkyl group, an aryl group or a heterocyclic group. S is a residue yielded from the compound represented by the type (1) or (2) through eliminating one atom. Symbols “i” and “j” are an integer number of one or more, which is selected from the scope to yield the value of i+j being 2 to 6. In preferred cases, i is 1 to 3, while j is 1 to 2, and in more preferred cases, i is 1 or 2, while j is 1. In a particularly preferred case, i is 1, while j is 1. The compound represented by the formula (X) preferably has the total carbon number being in the range of from 10 to 100. The total carbon number is more preferably from 10 to 70, still more preferably 11 to 60, and particularly preferably 12 to 50.

The compound of the type 1 and type 2 in the present invention may be used at any timing point of during preparation of the photosensitive silver halide emulsion, and in the step of the production of the photothermographic material. For example, it may be used during the formation of the photosensitive silver halide particle, the desalting step, upon chemical sensitization, before coating or the like. Also, the compound may be added by dividing for use of multiple times during these steps. Timing point of the addition is preferably, from the termination of the photosensitive silver halide particle formation to before the desalting step, upon the chemical sensitization (from immediately before initiating the chemical sensitization to immediately after the termination), or before coating, and is more preferably, from the chemical sensitization to before mixing with the nonphotosensitive organic silver salt.

The compounds of the type 1 and type 2 according to the present invention are preferably added after dissolving in a water soluble solvent such as water, methanol or ethanol, or a mixed solvent of the same. When they are dissolved in water, the compound which exhibits the increased solubility at a higher or lower pH may be dissolved at a higher or lower pH, which may be added thereafter.

Although the compounds of the type 1 and type 2 according to the present invention are preferably used in the image forming layer containing the photosensitive silver halide and the nonphotosensitive organic silver salt, they may be added to the protective layer or the intermediate layer with the image forming layer containing the photosensitive silver halide and the nonphotosensitive organic silver salt followed by permitting diffusion upon coating. Timing point of addition of these compounds may be either before or after sensitizing the pigment, and they may be contained in the silver halide emulsion layer (image forming layer) at the rate of preferably 1×10⁻⁹ to 5×10⁻¹ mol, and still more preferably 1×10⁻⁸ to 5×10⁻² mol per mol of the silver halide, respectively.

10) Adsorptive Redox Compound Having Adsorptive Group and Reducing Group

In the present invention, an adsorptive redox compound having the adsorptive group to the silver halide and the reducing group in the molecule is preferably contained. The adsorptive redox compound is preferably a compound represented by the following formula (I).
A-(W)ₙ-B Formula (I)

In formula (1), A represents a group that can be adsorbed to a silver halide (hereinafter referred as an adsorptive group), W represents a bivalent connection group, n represents 0 or 1 and B represents a reducing group.

The adsorptive group represented by A in formula (I) is a group directly adsorbing to the silver halide or a group promoting adsorption to the silver halide and it can include, specifically, a mercapto group (or a salt thereof), thion group (—C(═S)—), a heterocyclic group containing at least one atom selected from nitrogen atom, sulfur atom, selenium atom and tellurium atom, sulfide group, disulfide group, cationic group or ethynyl group.

The mercapto group (or a salt thereof) as the adsorptive group means the mercapto group (or a salt thereof) itself, as well as represents, more preferably, a heterocyclic group, aryl group or alkyl group substituted with at least one mercapto group (or the salt thereof). The heterocyclic group is at least a 5membered to 7-membered single or condensed aromatic or nonromatic heterocyclic group including, for example, imidazole ring group, thiazole ring group, oxazole ring group, benzimidazole ring group, benzothiazole ring group, benzoxazole ring group, triazole ring group, thiadiazole ring group, oxadiazole ring group, tetrazole ring group, purine ring group, pyridine ring group, quinoline ring group, isoquinoline ring group, pyrimidine ring group, and triazine ring group. Further, it may also be a heterocyclic group containing a quaternarized nitrogen atom, in which the substituting mercapto group may be dissociated to form a meso ion. When the mercapto group forms a salt, the counter ion can include, for example, a cation of an alkali metal, alkaline earth metal or heavy metal (Li⁺, Na⁺, K⁺, Mg²⁺, Ag⁺, Zn²⁺, and the like), ammonium ion, heterocyclic group containing quaternarized nitrogen atom, or phosphonium ion.

The mercapto group as the adsorptive group may also be tautomerically isomerized into a thion group.

The thione group as the adsorptive group can also include a linear or cyclic thioamide group, thioureido group, thiourethane group or dithiocarbamate ester group.

The heterocyclic group containing at least one atom selected from the nitrogen atom, sulfur atom, selenium atom and tellurium atom as the adsorptive group includes a nitrogen-containing heterocyclic group having —NH— group capable of forming imino silver (>NAg) as a partial structure of the heterocyclic ring, or a heterocyclic group having an —S— group, —Se— group, —Te— group or ═N— group capable of coordination bond to a silver ion by way of coordination bonding as a partial structure of the heterocyclic ring. Examples of the former can include, for example, benzotriazole group, triazole group, indazole group, pyrazole group, tetrazole group, benzoimidazole group, imidazole group, and purine group, and examples of the latter can include, for example, thiophene group, thiazole group, oxazole group, benzothiophene group, benzothiazole group, benzoxazole group, thiadiazole group, oxadiazole group, triazine group, selenoazole group, benzoselenoazole group, tellurazole group, and benzotellurazole group.

The sulfide group or disulfide group as the adsorptive group can include all of the groups having the —S— or —S—S— partial structure.

The cationic group as the adsorptive group means a group containing a quaternarized nitrogen atom, specifically, a group containing a nitrogen-containing heterocyclic group containing an ammonio group or quaternarized nitrogen atom. The nitrogen-containing heterocyclic group containing the quaternarized nitrogen atom can include, for example, pyridinio group, quinolinio group, isoquinolinio group, and imidazolio group.

The ethynyl group as the adsorptive group means —C≡CH group in which the hydrogen atom may be substituted.

The adsorptive group may have an optional substituent.

Further, specific examples of the adsorptive group can include those described in the specification of JP-A No. 1195355, in pages 4 to 7.

Preferred adsorptive group represented by A in formula (I) can include mercapto-substituted heterocyclic group (for example, 2-mercaptothiadiazole group, 2-mercapto-5-aminothiadiazole group, 3-nercapto-1,2,4-triazole group, 5-mercaptotetrazole group, 2-mercapto-1,3,4-oxadiazole group, 2-mercaptobenzimidazole group, 1,5-dimethyl-1,2,4-triazolium-3-thiorate group, 2,4-dimercapto pyrimidine group, 2,4-dimercapto triazine group, 3,5-dimercapto-1,2,4-triazole group, and 2,5-dimercapto-1,3-thiazole), or a nitrogen-containing heterocyclic group having —NH— group capable of forming imino silver (>NAg) as a partial structure of the heterocyclic ring (for example, benzotriazole group, benzimidazole group, and indazole group). More preferred adsorptive groups are 2-mercaptobenzimidazole group and 3,5-dimercapto-1,2,4-4-triazole group.

In the formula (I), W represents a bivalent linking group. The linking group may be any one as long as it does not adversely affect the photographic properties. For example, a bivalent linking group which is constructed from carbon atom, hydrogen atom, oxygen atom, nitrogen atom or sulfur atom can be utilized. Specific examples thereof include alkylene groups having 1 to 20 carbon atoms (e.g., methylene group, ethylene group, trimethylene group, tetramethylene group, hexamethylene group and the like), alkenylene groups having 2 to 20 carbon atoms, alkynylene groups having 2 to 20 carbon atoms, arylene groups having 6 to 20 carbon atoms (e.g., phenylene group, naphthylene group and the like), —CO—, —SO₂—, —O—, —S—, —NR₁—, and combinations of these linking groups, and the like. R₁ herein represents hydrogen atom, alkyl groups, heterocyclic groups or aryl groups. The linking group represented by W may have an arbitrary substituent.

In formula (I), the reducing group represented by B represents a group capable of reducing silver ion and can include, for example, residues derived by removing one hydrogen atom, from formyl group, amino group, triple bond group such as an acetylene group or propargyl group, mercapto group, hydroxyl amines, hydroxamic acids, hydroxy ureas, hydroxy urethanes, hydroxy semicarbazides, reductones (including reductone derivatives), anilines, phenols (including chroman-6-ols, 2,3-dihydrobenzofuran-5-ols, aminophenols, sulfoneamide phenols, and polyphenols such as hydroquinones, catechols, resorcinols, benzene triols and bisphenols), acyl hydrazines, carbamoyl hydrazides, and 3-pyrazolidone. They may have an optional substituent.

In formula (1), the oxidation potential for thereducing agent represented by B can be measured by a measuring method described in “Electrochemical Measuring Method” written by Akira Fujishima (published from Gihodo, pp 150-208) or “Experimental Chemical Course” edited by Chemical Society of Japan, 4th edition (vol. 9, pp 282-344, published from Maruzen). For example, it can be measured by a method of rotational disk volutammetry, specifically, by dissolving a specimen into a solution of methanol: pH 6.5, Britton-Robinson buffer=10% : 90% (vol %), passing a nitrogen gas for 10 min, and then measuring at 25° C. under 1000 rpm, at a sweeping velocity of 20 mV/sec while using a rotational disk electrode (RDE) made of glassy carbon as an operational electrode, using a platinum wire as a counter electrode and using a saturation calomel electrode as a reference electrode. A half-wave potential (E½) can be determined based on the obtained voltamogram.

The oxidation potential for the reducing group represented by B in the present invention, when measured by the measuring method described above, is preferably within a range from about −0.3 V to about 1.0 V. More preferably, it is within a range from about −0.1 V to about 0.8 V and, particularly preferably, is within a range from about 0 to about 0.7 V.

The reducing agent represented by B in formula (1) is preferably a residue, derived by removing one hydrogen atom from hydroxyl amines, hydroxamic acids, hydroxy ureas, hydroxy semi-carbazid, reductone, phenols, acyl hydrazines, carbamoyl hydrazines and 3-pyrazolidones.

The compound of formula (I) of the present invention may also be contained with a ballast group or a polymer chain used customarily as additives for static photography such as couplers. Further, the polymer can include those described, for example, in JP-A No. 1-100530.

The compound of formula (I) in the present invention may be a bis-form or tris-form. The molecular weight of the compound of formula (I) according to the present invention is, preferably, between 100 to 10,000, more preferably, between 120 to 1,000 and, particularly preferably, between 150 to 500.

Compounds of formula (1) according to the present invention are exemplified below but the present invention is not restricted to them.

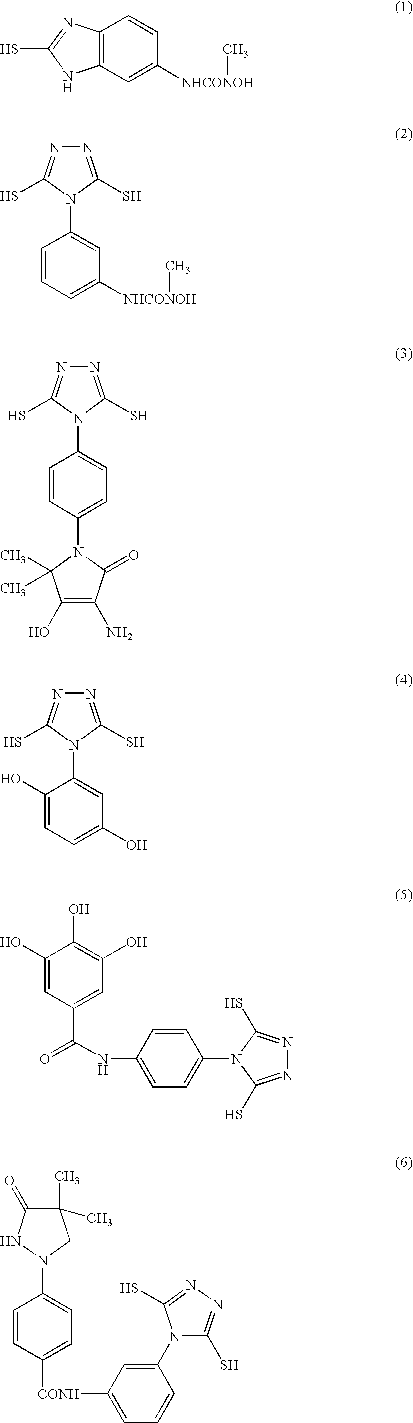

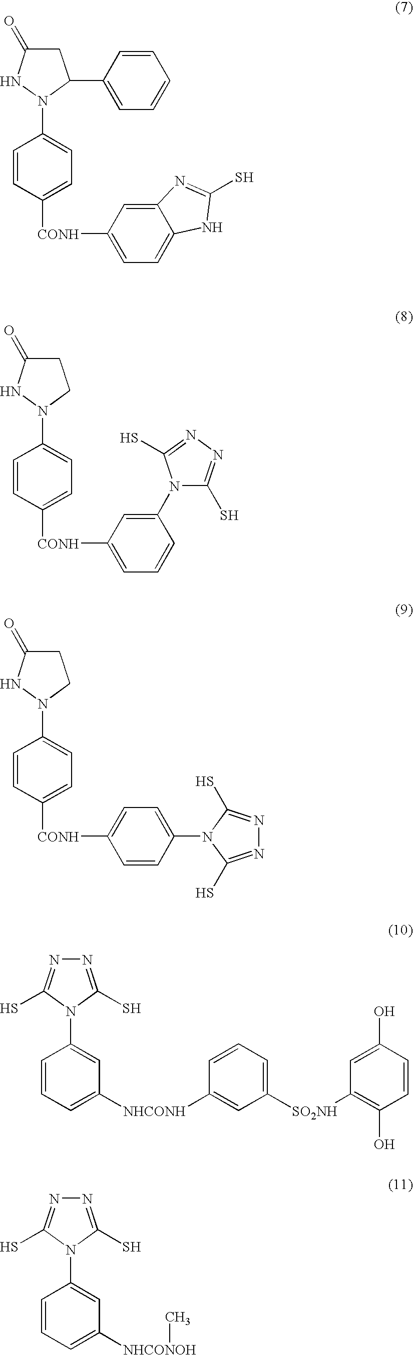

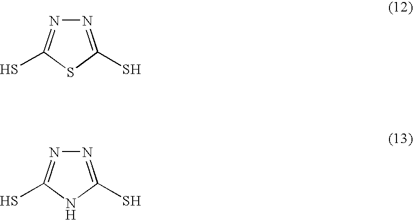

Further, also the specific compounds 1 to 30, 1″-1 to 1″-77 described in the specification of EP No. 1308776A2, pages 73 to 87 can also been mentioned as preferred examples of the compound having the adsorptive group and the reducing group in the present invention.

These compounds can be readily synthesized according to a known method. The compound of the formula (I) according to the present invention may be alone with one kind of the compound, or two or more compounds are also preferably used concurrently. When two or more kinds of the compounds are used, these may be added to the identical layer, or may be added to distinct layers. Also, they may be added with different methods, respectively.

The compound of the formula (I) according to the present invention is preferably added to the silver halide emulsion layer, and more preferably added during the preparation of the emulsion. When it is added during the preparation of the emulsion, it can be added at any timing point during the step, and examples thereof include during the step of forming the silver halide particle, prior to initiating the desalting step, during the desalting step, prior to initiating the chemical ripening, during the chemical ripening step, step before preparation of the completed emulsion. Also, the compound may be added by dividing for use of multiple times during these steps. Moreover, it is preferably used in the image forming layer, however, it may be added to the protective layer or the intermediate layer with the image forming layer which is adjacent thereto followed by permitting diffusion upon coating.

Although the preferred amount of the addition varies greatly depending on the aforementioned method of addition and the type of the compound to be added, it is generally 1×10⁻⁶ mol or greater and 1 mol or less, preferably 1×10⁻⁵ mol or greater and 5×10⁻¹ mol or less, and still more preferably 1×10⁻⁴ mol or greater and 1×10⁻¹ mol or less per mol of the photosensitive silver halide.

The compound of the formula (I) according to the present invention may be added after dissolving in a water soluble solvent such as water, methanol or ethanol, or a mixed solvent of the same. In this process, the pH may be adequately adjusted with an acid or a base, or coexistence with a surface active agent may be permitted. Moreover, it may be added in an emulsified dispersion to dissolve in an organic solvent having a high boiling point. Also, it may be added in the state of a solid dispersion.

11) Use of Multiple Silver Halides in Combination

The photosensitive silver halide emulsion in the photosensitive material for use in the present invention may be of only one kind, or of two or more kinds (e.g., those having different mean particle size, those having different halogen compositions, those having different crystal habits, those obtained under different chemical sensitization conditions) in combination. The gradation can be adjusted through using multiple kinds of the photosensitive silver halide having the different sensitivity. Relevant techniques are described in JP-A Nos. 57-119341, 53-106125, 47-3929, 48-55730, 46-5187, 50-73627, 57-150841 and the like. It is preferred that there exists the difference in sensitivity among the respective emulsions of 0.2 logE or greater.

12) Amount of Coating

The amount of addition of the photosensitive silver halide as indicated by the coating amount of the silver per m² of the photosensitive material is preferably 0.03 g/m² or greater and 0.6 g/m² or less, more preferably 0.05 g/m² or greater and 0.4 g/m² or less, and most preferably 0.07 g/m² or greater and 0.3 g/m² or less. Further, the amount of the photosensitive silver halide per mol of the organic silver salt is 0.01 mol or greater and 0.5 mol or less, more preferably 0.02 mol or greater and 0.3 mol or less, and still more preferably 0.03 mol or greater and 0.2 mol or less.

13) Mixing of Photosensitive Silver Halide and Organic Silver Salt

In connection with the method and conditions of mixing of separately prepared photosensitive silver halide and organic silver salt, there is a method in which the silver halide particle and the organic silver salt completed their preparation respectively are mixed with a high speed stirrer, a ball mill, a sand mill, a colloid mill, a vibration ball mill, a homogenizer or the like; a method in which the organic silver salt is prepared by mixing the prepared photosensitive silver halide at any timing point during preparation of the organic silver salt, or the like. However, the method is not particularly limited as long as the effect of the present invention is sufficiently achieved. Furthermore, in a preferred method for the purpose of adjusting photographic characteristics, mixing of two or more kinds of aqueous dispersion liquids of the organic silver salt and two or more kinds of aqueous dispersion liquids of the photosensitive silver salt is executed.

14) Mixing of Silver Halide into Coating Liquid

Preferred timing point of the addition of the silver halide into the coating liquid for image forming layer is from 180 min before the coating to immediately before the coating, and preferably from 60 min before to 10 seconds before the coating. However, the method and conditions of the mixing are not particularly limited as long as the effect of the present invention is sufficiently achieved. Specific examples of the mixing method include a method in which mixing is executed in a tank designed such that the average residence time calculated from the flow rate of the added solution and the amount of the solution supplied to a coater becomes a desired time, and a method in which a static mixer or the like is used as described in “Mixing in the Process Industries (Ekitai Kongo Gizyutu)”, chapter 8, N. Harnby, M. F. Edwards, A. W. Nienow, translated by Koji Takahashi (published by THE NIKKAN KOGYO SHIMBUN,LTD., 1989).

(Compound that Substantially Reduces Visible Light Absorption Derived from Photosensitive Silver Halide Following Thermal Development)

According to the present invention, in cases of the photothermographic material having image forming layers on both sides of the support, a silver halide having a high silver iodide content is preferably used as described above, however, the silver halide having a high silver iodide content is preferably used in combination with a compound which can substantially reduce the photometric absorption strength in the ultraviolet visible region derived from the photosensitive silver halide by a thermal development processing. In the present invention, it is particularly preferred that a silver iodide complex-forming agent is used as the compound that substantially reduces visible light absorption derived from the photosensitive silver halide following thermal development.

1) Silver Iodide Complex-Forming Agent

The silver iodide complex-forming agent in the present invention is capable of contributing to a Lewis acid base reaction in which at least one nitrogen atom or sulfur atom in the compound conducts electron donation to a silver ion as a donor atom of ligand (electron donor: Lewis base). Although stability of the complex is defined by a consecutive stability constant or entire stability constant, it depends on the combination of the silver ion, iodo ion, and silver complex-forming agent. As a general guiding principle, a great stability constant can be obtained by a chelating effect through the formation of an intramolecular chelate ring, or a procedure to increase the acid base dissociation constant of the ligand or the like.

Although action mechanisms of the silver iodide complex-forming agent in the present invention have not been distinctly elucidated, it is presumed that silver iodide is solubilized by forming a stable complex which comprises at least ternary components including an iodo ion and a silver ion. Although the silver iodide complex-forming agent of the present invention is poor in ability to solubilize silver bromide or silver chloride, it specifically acts on silver iodide.

Although details of the mechanisms involving in improvement of the image storability by the silver iodide complex-forming agent of the present invention are not clarified, it is believed that photosensitivity is reduced or disappeared by forming a complex by a reaction of at least a part of the photosensitive silver halide and the silver iodide complex-forming agent of the present invention upon thermal development, and that the image storability is greatly improved under irradiation of a light, in particular. In addition, as a consequence of concurrently caused reduction in clouding of the film due to silver halide, a significant feature to give clear and high-quality images is accomplished. Clouding of the film can be ascertained from the reduction in ultraviolet visible absorption of the spectral absorption spectrum.

In the present invention, the ultraviolet visible absorption spectrum of the photosensitive silver halide can be measured with a transmission method or a reflection method. When the absorption derived from the other compound added to the photothermographic material overlaps with the absorption of the photosensitive silver halide, a measure such as difference spectrum or elimination of the other compound with a solvent may be used alone or in combination to enable the observation of the ultraviolet visible absorption spectrum of the photosensitive silver halide.

Clear difference between the silver iodide complex-forming agent according to the present invention and conventional silver ion complex-forming agents is the requirement of an iodo ion for forming a stable complex. Conventional silver ion complex-forming agents have lytic action on salts including a silver ion such as nonphotosensitive organic silver salts such as silver bromide, silver chloride and silver behenate, however, the silver iodide complex-forming agent according to the present invention is greatly characteristic in lack of the action without existing silver iodide.

The silver iodide complex-forming agent of the present invention is preferably a 5 to 7-membered heterocyclic compound containing at least one nitrogen atom. When it is a compound not having a mercapto group, a sulfide group or a thione group as a substituent, the nitrogen-containing 5 to 7-membered heterocycle may be saturated or unsaturated, or may have other substituent. Furthermore, the substituent on the heterocycle may bind with each other to form a ring.

Preferable examples of the 5 to 7membered heterocyclic compound include pyrrole, pyridine, oxazole, isooxazole, thiazole, isothiazole, imidazole, pyrazole, pyrazine, pyrimidine, pyridazine, indole, isoindole, indolizine, quinoline, isoquinoline, benzoimidazole, 1H-imidazole, quinoxaline, quinazoline, cinnoline, phthalazine, naphthylidine, purine, pteridine, carbazole, acridine, phenanthridine, phenanthroline, phenazine, phenoxazine, phenothiazine, benzothiazole, benzooxazole, benzoimidazole, 1,2,4-triazine, 1,3,5-triazine, pyrrolidine, imidazolidine, pyrazolidine, piperidine, piperazine, morpholine, indoline, isoindoline and the like. More preferable examples include pyridine, imidazole, pyrazole, pyrazine, pyrimidine, pyridazine, indole, isoindole, indolizine, quinoline, isoquinoline, benzoimidazole, 1H-imidazole, quinoxaline, quinazoline, cinnoline, phthalazine, 1,8-naphthylidine, 1,10-phenanthroline, benzoimidazole, benzotriazole, 1,2,4-triazine, 1,3,5-triazine and the like. Particularly preferable examples include pyridine, imidazole, pyrazine, pyrimidine, pyridazine, phthalazine, triazine, 1,8-naphthylidine, 1,10-phenanthroline and the like.

These rings may have a substituent, and the substituent may be any one as long as it does not adversely affect the photographic properties. Preferred examples include halogen atoms (fluorine atom, chlorine atom, bromine atom or iodine atom), alkyl groups (including straight chain and branched, cyclic alkyl groups as well as bicycloalkyl group, active methine groups), alkenyl groups, alkynyl groups, aryl groups, heterocyclic groups (whichever position may be substituted), acyl groups, alkoxycarbonyl groups, aryloxycarbonyl groups, heterocyclic oxycarbonyl groups, carbamoyl groups, N-acylcarbamoyl groups, N-sulfonylcarbamoyl groups, N-carbamoylcarbamoyl groups, N-sulfamoylcarbamoyl groups, carbazoyl groups, carboxy groups or salts thereof, oxalyl groups, oxamoyl groups, cyano groups, carbonimidoyl groups, a formyl group, a hydroxy group, alkoxy groups (including groups having recurring ethyleneoxy groups or propyleneoxy groups unit), aryloxy groups, heterocycleoxy groups, acyloxy groups, (alkoxy or aryloxy)carbonyloxy groups, carbamoyloxy groups, sulfonyloxy groups, amino groups, (alkyl, aryl, or heterocyclic)amino groups, acylamino groups, sulfoneamide groups, ureide groups, thioureide groups, imide groups, (alkoxy or aryloxy)carbonyl amino groups, sulfamoylamino groups, semicarbazide groups, ammonio groups, oxamoylamino groups, Nalkyl or aryl)sulfonyl ureide groups, N-acylureide groups, N-acylsulfamoylamino groups, nitro groups, heterocyclic groups containing a quaternarized nitrogen atom (e.g., pyridinio group, imidazolio group, quinolinio group, isoquinolinio group), isocyano groups, imino groups, (alkyl or aryl)sulfonyl groups, (alkyl or aryl)sulfinyl groups, sulfo groups or salts thereof, sulfamoyl groups, N-acylsulfamoyl groups, N-sulfonylsulfamoyl groups or salts thereof, phosphino groups, phosphinyl groups, phosphinyloxy groups, phosphinylamino groups, silyl groups and the like.

The active methine group herein means a methine group substituted with two electron-attractive groups, The electron-attractive group herein means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group. The two electron-attractive groups may bind together to form a cyclic structure. Also, the salt herein means a cation of an alkali metal, an alkaline earth metal, a heavy metal or the like, or an organic cation such as an ammonium ion or a phosphonium ion. These substituents may be further substituted with any of these substituents.

These heterocycles may be further condensed with other ring. Furthermore, when the substituent is an anionic group (e.g., —CO₂⁻; —SO₃⁻, —S⁻ and the like), the nitrogen-containing heterocycle of the present invention may become a cation (e.g., pyridinium, 1,2,4-triazolium or the like) to form an intramolecular salt.

When the heterocyclic compound is a pyridine, pyrazine, pyrimidine, pyridazine, phthalazine, triazine, naphthylidine or phenanthroline derivative, it is more preferred that the acid dissociation constant (pKa) of the conjugate acid of the nitrogen-containing heterocyclic moiety in the acid dissociation equilibrium of the compound in a mixed solution of tetrahydrofuran/water (3/2) at 25° C. is 3 to 8. More preferably, the pKa is from 4 to 7.

Such a heterocyclic compound is preferably a pyridine, pyridazine or phthalazine derivative, and pyridine or phthalazine derivative is particularly preferred.

When these heterocyclic compounds have a mercapto group, a sulfide group or a thione group as a substituent, a pyridine, thiazole, isothiazole, oxazole, isooxazole, imidazole, pyrazole, pyrazine, pyrimidine, pyridazine, triazine, triazole, thiadiazole or oxadiazole derivative is preferred, and a thiazole, imidazole, pyrazole, pyrazine, pyrimidine, pyridazine, triazine or triazole derivative is particularly preferred.

For example, a compound represented by the following formula (21) or formula (22) can be utilized as the silver iodide complex-forming agent.

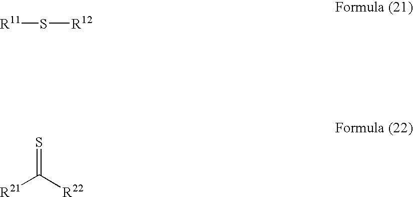

In the formula (21), R¹¹ and R¹² represent a hydrogen atom or a substituent. In the formula (22), R²¹ and R²² represent a hydrogen atom or a substituent. However, both of R¹¹ and R¹² are not a hydrogen atom together; and R²¹ and both of R²² are not a hydrogen atom together. Examples of the substituent herein include those illustrated as substituents of the aforementioned nitrogen-containing 5 to 7-membered heterocyclic silver iodide complex-forming agent.

Also, a compound represented by the following formula (23) may be preferably utilized.

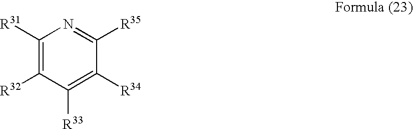

In the formula (23), R³¹ to R³⁵ each independently represent a hydrogen atom or a substituent. Examples of the substituent represented by R³¹ to R³⁵ include those illustrated as substituents of the aforementioned nitrogenontaining 5 to 7-membered heterocyclic silver iodide complex-forming agent. When the compound represented by the formula (23) has a substituent, preferable position of substitution is R³²—R³⁴. R³¹ to R³⁵ may bind with each other to form a saturated or unsaturated ring. Preferable examples thereof include halogen atoms, alkyl groups, aryl groups, carbamoyl groups, hydroxy group, alkoxy groups, aryloxy groups, carbamoyloxy groups, amino groups, acylamino groups, ureide groups, (alkoxy or aryloxy)carbonyl amino groups and the like.

The compound represented by the formula (23) has an acid dissociation constant (pKa) of the conjugate acid of the pyridine ring moiety in a mixed solution of tetrahydrofuran/water (3/2) at 25° C. of preferably from 3 to 8, and particularly preferably from 4 to 7.

In addition, a compound represented by the formula (24) is also preferred.

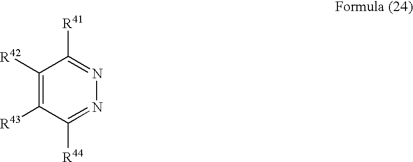

In the formula (24), R⁴¹ to R⁴⁴ each independently represent a hydrogen atom or a substituent. R⁴¹ to R⁴⁴ may bind with each other to form a saturated or unsaturated ring. Examples of the substituent represented by R⁴¹ to R⁴⁴ include those illustrated as substituents of the aforementioned nitrogen-containing 5 to 7-membered heterocyclic silver iodide complex-forming agent. Examples of the preferred group include alkyl groups, alkenyl groups, alkynyl groups, aryl groups, a hydroxy group, alkoxy groups, aryloxy groups, heterocycleoxy groups and a phthalazine ring formed with a benzo-condensed ring. When a hydroxyl group is substituted for the carbon which is adjacent to a nitrogen atom of the compound represented by the formula (24), an equilibrium is established with pyridazinone.

It is more preferred that the compound represented by the formula (24) forms a phthalazine ring represented by the following formula (25). It is particularly preferred that this phthalazine ring further has at least one substituent. Examples of R⁵¹ to R⁵⁶ in the formula (5) include those illustrated as substituents of the aforementioned nitrogen-containing 5 to 7membered heterocyclic silver iodide complex-forming agent. Examples of more preferred substituent include alkyl groups, alkenyl groups, alkynyl groups, aryl groups, a hydroxy group, alkoxy groups, aryloxy groups and the like. Preferable examples thereof include alkyl groups, alkenyl groups, aryl groups, alkoxy groups and aryloxy groups, and more preferably alkyl groups, alkoxy groups and aryloxy groups.

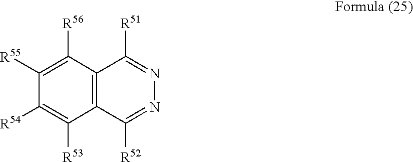

Also, compounds represented by the following formula (26) are included in preferred mode.

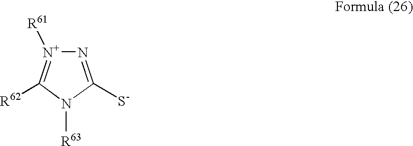

In the formula (26), R⁶¹ to R⁶³ each independently represent a hydrogen atom or a substituent. Examples of the substituent represented by R⁶² include those illustrated as substituents of the aforementioned nitrogen-containing 5 to 7-membered heterocyclic silver iodide complex-forming agent.

Examples of preferably used compound include those represented by the following formula (27).
R⁷¹—S-(L)ₙ-S—R⁷² Formula (27)

In the formula (27), R⁷¹ to R⁷² each independently represent a hydrogen atom or a substituent. L represents a bivalent linking group. n represents 0 or 1. Examples of the substituent represented by R⁷¹ to R⁷² include alkyl groups (including cycloalkyl groups), alkenyl groups (including cycloalkenyl groups), alkynyl groups, aryl groups, heterocyclic groups, acyl groups, aryloxycarbonyl groups, alkoxycarbonyl groups, carbamoyl groups, imide groups and complex substituents including the same, and the like. The bivalent linking group represented by L is a linking group having a length corresponding to preferably from 1 to 6 atoms, and more preferably from 1 to 3 atoms, which may additionally have a substituent.

Still another compound which is preferably used is a compound represented by the formula (28).

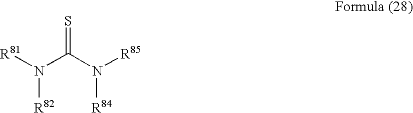

In the formula (28), R⁸¹ to R⁸⁴ each independently represent a hydrogen atom or a substituent. Examples of the substituent represented by R⁸¹ to R⁸⁴ include alkyl groups (including cycloalkyl groups), alkenyl groups (including cycloalkenyl groups), alkynyl groups, aryl groups, heterocyclic groups, acyl groups, aryloxycarbonyl groups, alkoxycarbonyl groups, carbamoyl groups, imide groups and the like.

Still more preferred compounds among the aforementioned silver iodide complex-forming agents are those represented by the formula (23), (24), (25), (26) or (27), and the compounds represented by the formula (23) or (25) are particularly preferred.

2) Specific Examples of Silver Iodide Complex-Forming Agent

Hereinafter, preferable examples of the silver iodide complex-forming agent according to the present invention are illustrated, but the present invention is not limited thereto.

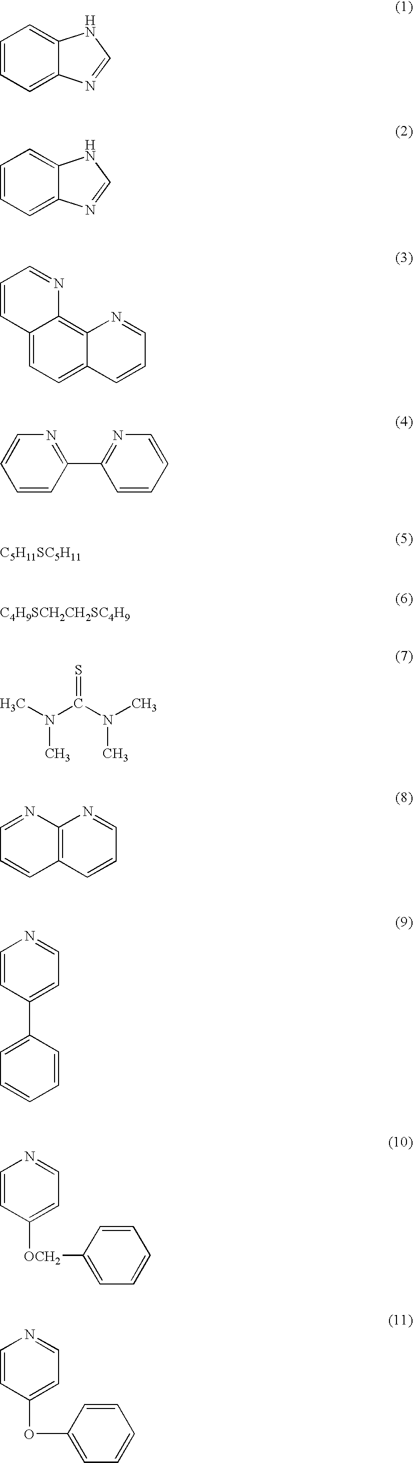

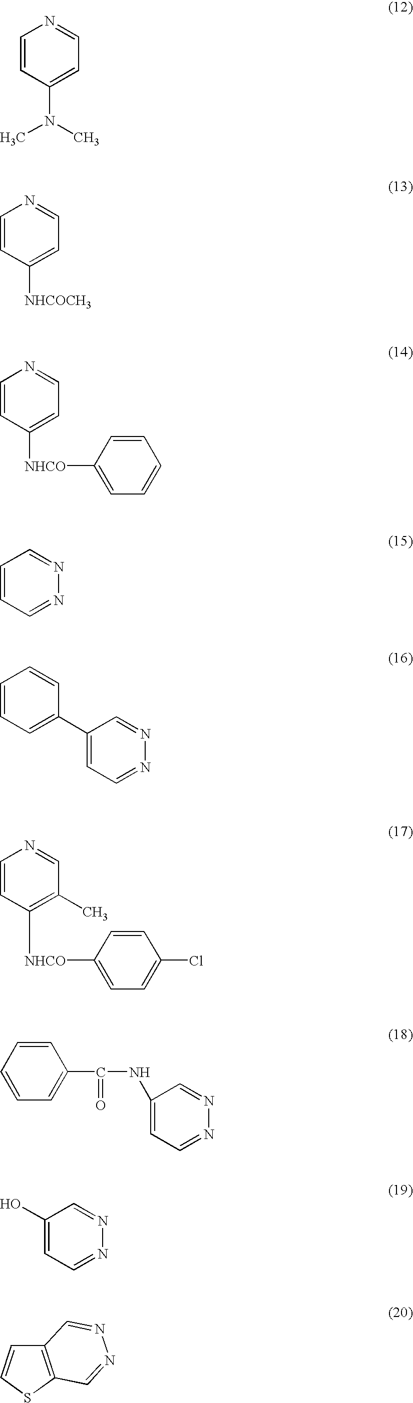

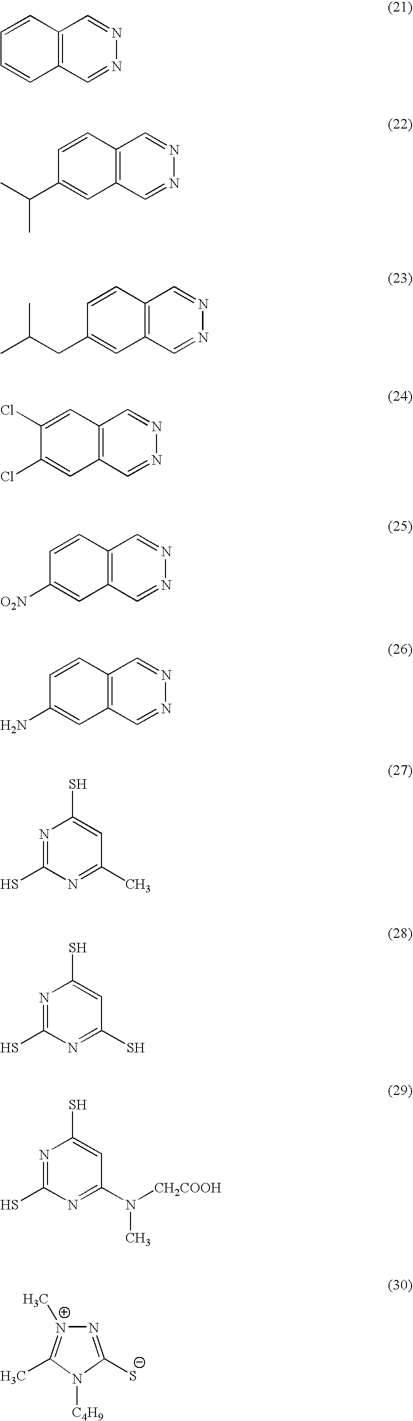

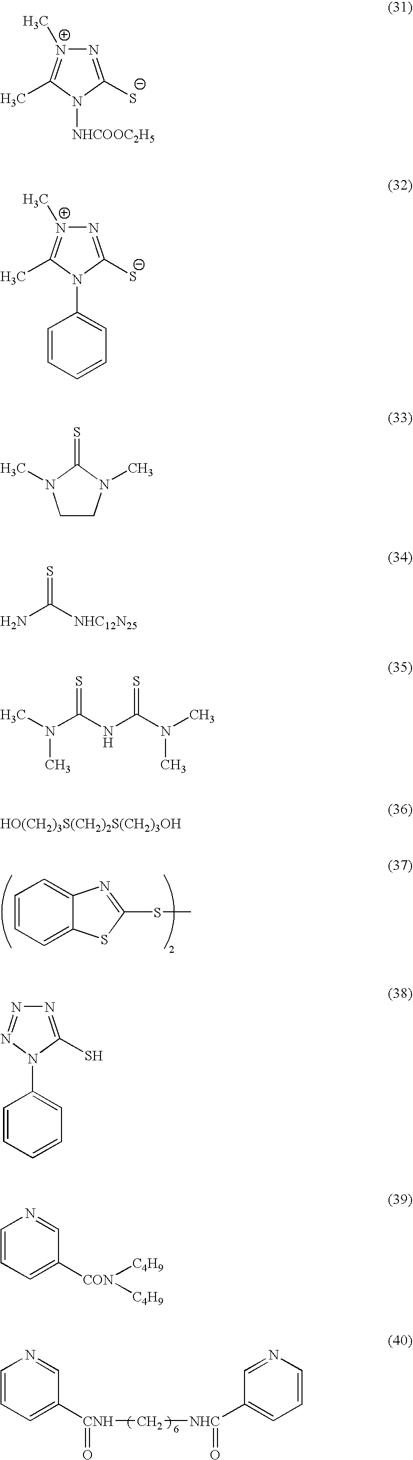

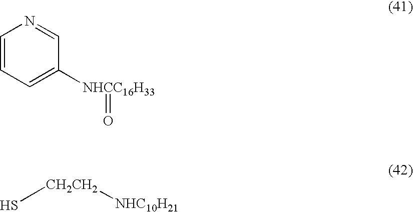

The silver iodide complex-forming agent according to the present invention may also be a compound which is common to a color toner when it serves as a conventionally known color toner. The silver iodide complex-forming agent according to the present invention may be used in combination with a color toner. Also, two or more kinds of silver iodide complex-forming agents may be used in combination.

3) Addition of Silver Iodide Complex-Forming Agent

The silver iodide complex-forming agent according to the present invention is preferably allowed to be present within a film in a state separated from the photosensitive silver halide by permitting it to exist in a state of solid within the film. It is also preferred to add to the adjacent layer. The boiling point of the compound in the silver iodide complex-forming agent of the present invention is preferably adjusted to fall within a suitable range such that it is dissolved upon heating at a temperature of the thermal development.

In the present invention, it is preferable that the absorption intensity of the UV visible absorption spectrum of the photosensitive silver halide after heat development is 80% or less when compared with that before the heat development. It is more preferably 40% or less and, particularly preferably, 10% or less.

The silver iodide complex forming agent in the present invention may be contained into the coating solution by any method such as in the form of solution, in the form of emulsified dispersion or in the form of solid fine particle dispersion and contained in the photosensitive material.

The well-known emulsifying dispersion method can include a method of dissolving by using an oil such as dibutyl phthalate, tricresyl phosphate, glyceryl triacetate or diethyl phthalate or an auxiliary solvent such as ethyl acetate and cyclohexanone, and preparing the emulsified dispersion mechanically.

Further, the fine solid particle dispersion method can include a method of dispersing a powder of the silver iodide complex forming agent in the present invention in an appropriate solvent such as water by a ball mill, colloid mill, vibration ball mill, sand mill, jet mill, roller mill or supersonic waves thereby preparing a solid dispersion. In this case, a protection colloid (for example, polyvinyl alcohol), a surface active agent (for example, anionic surface active agent such as sodium triisopropyl naphthalene sulfonate (mixture of those having different substitution positions for three isopropyl groups)) may be used. In the mills described above, beads of zirconia, etc. are generally used as the dispersion medium, and Zr or the like leaching from the beads may sometimes intrude into the dispersion. Depending on the dispersion condition, it is usually within a range of 1 ppm or more and 1000 ppm or less. When the content of Zr in the photosensitive material is 0.5 mg or less per 1 g of the silver, it causes no practical problem.

The liquid dispersion is preferably contained with a antiseptic (for example, sodium salt of benzoisothiazolinone).

The silver iodide complex forming agent in the present invention is preferably used as a solid dispersion.

The silver iodide complex forming agent in the present invention is preferably used within a range of 1 mol % or more and 5,000 mol % or less, more preferably, within a range of 10 mol % or more and 1000 mol % or less and, further preferably, within a range of 50 mol % or more and 300 mol % or less, based on the photosensitive silver halide.

(Explanation of Binder)

For the binder in the image forming layer according to the present invention, any polymer may be used. Suitable binder is transparent or translucent, and colorless in general, which may be a natural resin or a polymer and a copolymer, a synthetic resin or a polymer and a copolymer, as well as other medium that forms a film. Examples thereof include gelatin, rubbers, poly(vinyl alcohols), hydroxyethyl cellulose, cellulose acetates, cellulose acetate butyrates, poly(vinylpyrrolidones), casein, starch, poly(acrylic acids), poly(methylmethacrylic acids), poly(vinyl chlorides), poly(methacrylic acids), styrene-maleic anhydride copolymers, styrene-acrylonitrile copolymers, styrene-butadiene copolymers, poly(vinylacetals) (e.g., poly(vinylformal) and poly(vinylbutyral)), poly (esters), poly(urethanes), phenoxy resins, poly(vinylidene chlorides), poly(epoxides), poly(carbonates), poly(vinyl acetates), poly(olefins), cellulose esters and poly(amides). The binder may also be coated and formed from water or an organic solvent or an emulsion.

According to the present invention, the binder which can be used for the layer containing the organic silver salt has a glass transition temperature of preferably 0° C. or higher and 80° C. or lower (hereinafter, may be also referred to as “high Tg binder”), more preferably 10° C. or higher and 70° C. or lower, and still more preferably 15° C. or higher and 60° C. or lower.

Herein, Tg was calculated according to the following formula:
1/Tg=Σ(Xi/Tgi)
wherein the polymer is a copolymerized product of monomer components; the number of which being n, i=from 1 to n. Xi is a weight fraction of the “i th” monomer (ΣXi=1); and Tgi is a glass transition temperature (absolute temperature) of a single polymer of the “i th” monomer. However, Σ is summation of from i=1 to n. As the value of the glass transition temperature of the single polymer of each monomer (Tgi), the value in Polymer Handbook (3rd Edition) (attributed to J. Brandrup, E. H. Immergut (Wiley-Interscience, 1989)) was adopted.

Two or more kinds of binders may be used in combination as needed. Also, the binder having a glass transition temperature of 20° C. or higher and the binder having a glass transition temperature of lower than 20° C. may be used in combination. When two or more kinds of polymers having different Tg are used through blending, the weight average Tg thereof preferably falls within the range described above.

In the present invention, a coating film of the image forming layer is preferably formed by coating using a coating liquid in which 30% by mass or greater of the solvent accounts for water, followed by drying. In the present invention, when the image forming layer is formed by coating using a coating liquid in which 30% by mass or greater of the solvent accounts for water followed by drying, and when the binder in the image forming layer can be dissolved or dispersed in a water-based solvent (water solvent), performances are improved in cases where it comprises a polymer latex having an equilibrium moisture content of 2% by mass or less at 25° C. and at 60% RH, in particular. In the most preferred embodiment, it is prepared such that the ion conductance becomes 2.5 mS/cm or less. Examples of such a method of preparation include a method in which a purification treatment is carried out using a membrane having a separating capability after synthesis of the polymer.

The water-based solvent referred to herein in which the aforementioned polymer can be dissolved or dispersed is water or a mixture of water and a 70% by mass or less water miscible organic solvent. Examples of the water miscible organic solvent include e.g., alcohols such as methyl alcohol, ethyl alcohol and propyl alcohol, cellosolves such as methyl cellosolve, ethyl cellosolve and butyl cellosolve, ethyl acetate, dimethylformamide and the like.

In addition, the term of the water-based solvent is also applied herein to systems in which the polymer is not thermodynamically dissolved, but is present in a so-called dispersion state.

“Equilibrium water content (mass%) at 25° C., 60% RH” can be expressed as below by using weight WI for a polymer at a moisture controlled equilibrium under a 25° C., 60% RH atmosphere and weight WO for the polymer at 25° C. in an absolute dried state:
Equilibrium water content at 25° C., 60% RH={(W1−W0)/W0×100 (mass %)

For the definition and the measuring method of the water content, Polymer Engineering Course 14, Polymer Material Test Method (edited by Polymer Society, published from Chijin Shokan) can be referred to for instance.

The equilibrium water content of the binder polymer in the present invention at 25° C., 60% RH is, preferably, 2 mass % or less, more preferably, 0.01 mass % or more and 1.5 mass % or less and, further preferably, 0.02 mass % or more and 1 mass % or less.

In the present invention, a polymer dispersible in an aqueous solvent is particularly preferred. As an example of the dispersed state, either a latex in which fine particles of water insoluble hydrophobic polymer are dispersed, or a dispersion in which polymer molecules are dispersed in the state of molecules or forming micelles may be used, with the latex-dispersed particles being more preferred. The average grain size of the dispersed particles is within a range of 1 nm or more and 50000 nm or less, preferably, within a range of 5 nm or more and 1000 nm or less, more preferably, within a range from 10 nm to 500 nm and, further preferably, within a range of 50 nm or more and 200 nm or less. There is no particular restriction on the grain size distribution of the dispersed particles which may have a wide grain size distribution or a grain size distribution of mono dispersion. Use of two or more of particles having grain size distributions of mono dispersion in admixture is also a preferred method of use for controlling the physical property of the coating solution.

As a preferred embodiment of the polymers dispersible to the aqueous solvent in the present invention, hydrophobic polymers such as acrylic polymers, poly(esters), rubbers (for example SBR resin), poly(urethanes), poly(vinyl chlorides), poly(vinyl acetates), poly(vinylidene chlorides), or poly(olefins) can be used preferably. The polymer may be a linear polymer, branched polymer, or crosslinked polymer. It may be a so-called homopolymer in which single monomers are polymerized or a copolymer in which two or more kinds of monomers are polymerized. In the case of the copolymer, it may be either a random copolymer or a block copolymer. The molecular weight of the polymer, based on the number average molecular weight, is 5000 or more and 1,000,000 or less and, preferably, 10,000 or more and 200,000 or less. A polymer with excessively small molecular weight provides insufficient dynamic strength for the image forming layer, whereas a polymer of excessively large molecular weight is not preferred since the film-deposition property is poor. Further, the crosslinking polymer latex can be used particularly preferably.

(Specific Example of Polymer Latex)

Specific examples of the preferred polymer latex are shown below. They are expressed by using starting monomers and, in each of parentheses, numerical value means mass % and the molecular weight is a number average molecular weight. In a case of using polyfunctional monomers, since they form crosslinking structures and the concept of the molecular weight can not be applied, it is indicated as “crosslinking” with description for the molecular weight being omitted. Tg represents a glass transition temperature.
P-1; Latex of -MMA (70) -EA (27) -MAA (3)—(molecular weight: 37000, Tg: 61° C.)
P-2; Latex of -MMA (70) -2EHA (20) -St (5) -AA (5)—(molecular weight: 40000, Tg: 59° C.)
P-3; Latex of -St (50) -Bu (47) -MAA (3)—(crosslinking, Tg: −17° C.)
P4; Latex of -St (68) -Bu (29) -AA (3)—(crosslinking, Tg: 17° C.).
P-5; Latex of -St (71) -Bu (26) -AA (3)—(crosslinking, Tg: 24° C.)
P-6; Latex of -St (70) -Bu (27) -IA (3)—(crosslinking).
P-7; Latex of -St (75) -Bu (24) -AA (1)—(crosslinking, Tg: 29° C.)
P-8; Latex of -St (60) -Bu (35) -DVB (3) -MAA (2)—(crosslinking).
P9; Latex of -St (70) -Bu (25) -DVB (2) -AA (3)—(crosslinking).
P-10; Latex of -VC (50) -MMA (20) -EA (20) -AN (5) -AA (5)—(molecular weight: 80000)
P-11; Latex of -VDC (85) -MMA (5) -EA (5) -MAA (5)—(molecular weight: 67000)
P-12; Latex of -Et (90) -MAA (10)—(molecular weight: 12000).
P-13; Latex of -St (70) -2EHA (27) -AA (3) (molecular weight: 130000, Tg: 43° C.)
P-14; Latex of -MMA (63) -EA (35) -AA (2) (molecular weight: 33000, Tg: 47° C.)
P-15; Latex of -St (70.5) -Bu (26.5) -AA (3)—(crosslinking, Tg: 23° C.)
P-1 6; Latex of -St (69.5) -Bu (27.5) -AA (3)—(crosslinking, Tg: 20.5° C.)

The abbreviations for the structure represent the following monomers. MMA; methyl methacrylate, EA; ethyl acrylate, MAA: methacrylic acid, 2EHA: 2-ethylhexylacrylate, St; styrene, Bu; butadiene, AA; acrylic acid, DVB; divinyl benzene, VC; vinyl chloride, AN; acrylonitrile, VDC; vinylidene chloride, Et; ethylene, IA; itaconic acid.

The polymer latex described hereinabove is also available in the market, and the following polymers can be utilized. Examples of the acrylic polymer include Cevian A-4635, 4718 and 4601 (foregoings, manufactured by Daicel Chemical Industries, Ltd.), Nipol Lx811, 814, 821, 820 and 857 (foregoings, manufactured by Zeon Corporation) and the like; examples of the poly(esters) include FINETEX ES650, 611, 675 and 850 (foregoings, manufactured by Dainippon Ink and Chemicals, Incorporated.), WD-size, WMS (foregoings, manufactured by Eastman Chemical Company) and the like; examples of the poly(urethanes) include HYDRAN AP10, 20, 30 and 40 (foregoings, manufactured by Dainippon Ink and Chemicals, Incorporated.) and the like; examples of the rubbers include LACSTAR 7310K, 3307B, 4700H and 7132C (foregoings, manufactured by Dainippon Ink and Chemicals, Incorporated.), Nipol Lx416, 410, 438C and 2507 (foregoings, manufactured by Zeon Corporation) and the like; examples of the poly(vinyl chlorides) include G351 and G576 (foregoings, manufactured by Zeon Corporation) and the like; examples of the poly(vinylidene chlorides) include L502 and L513 (foregoings, manufactured by Asahi Kasei Corporation) and the like; examples of the poly(olefins) include Chemipearl S120 and SA100 (foregoings, manufactured by Mitsui Chemicals Co., Ltd.) and the like.

These polymer latexes may be used alone, or two or more thereof may be blended as needed.

(Preferable Latex)

The polymer latex for use in the present invention is particularly preferably a latex of a styrene-butadiene copolymer. The weight ratio of styrene monomer unit and butadiene monomer unit in the styrene-butadiene copolymer is preferably 40:60 to 95:5. Moreover, the proportion of the styrene monomer unit and the butadiene monomer unit occupying in the copolymer is preferably 60% by mass or greater and 99% by mass or less. Further, the polymer latex according to the present invention preferably contains acrylic acid or methacrylic acid in an amount of 1% by mass or greater and 6% by mass or less, more preferably 2% by mass or greater and 5% by mass or less per the summation of styrene and butadiene. It is preferred that the polymer latex according to the present invention contains acrylic acid. Preferred range of the molecular weight is similar to that described above.

Examples of the styrene-butadiene acid copolymer latex which is preferably used in the present invention include the aforementioned P-3 to P8, 15, and LACSTAR-3307B and 7132C, and Nipol Lx416 which are commercially available products, and the like.

A hydrophilic polymer such as gelatin, polyvinyl alcohol, methyl cellulose, hydroxypropyl cellulose or carboxymethyl cellulose may be added optionally to the image forming layer of the photosensitive material in the present invention. The addition amount of the hydrophilic polymer is, preferably, 30 mass % or less and, more preferably, 20 mass % or less based on the entire binder for the image forming layer.

The organic silver salt containing layer (that is, image forming layer) in the present invention is preferably formed by using the polymer latex. The amount of the binder in the image forming layer as the weight ratio of the entire binder/organic silver salt is preferably within a range from 1/10 to 10/1, more preferably, within a range from 1/3 to 5/1 and, further preferably, within a range from 1/1 to 3/1.

Furthermore, such an organic silver salt-containing layer is also a photosensitive layer (image forming layer) which contains a photosensitive silver halide that is usually a photosensitive silver salt, and the weight ratio of total binder/silver halide in such a case is in the range of from 400 to 5, and more preferably from 200 to 10.

The total amount of coating of binder in the image forming layer is preferably 0.2 g/m² or greater and 30 g/m² or less, more preferably 1 g/m² or greater and 15 g/m² or less, and most preferably 2 g/m² or greater and 10 g/m² or less. In the image forming layer of the invention, a crosslinker for the crosslinking and a surface active agent for the improvement of the coatability may also be added.

(Solvent for Preferred Coating Solution)

A solvent for the image forming layer coating solution of the photosensitive material in the present invention (for the sake of simplicity, the solvent and the dispersant are collectively referred to as the solvent) is preferably an aqueous solvent containing 30 mass % or more of water. As the ingredient other than water, any water miscible organic solvent such as methyl alcohol, ethyl alcohol, isopropyl alcohol, methyl cellosolve, ethyl cellosolve, dimethyl formamide, and ethyl acetate may be used. The water content in the solvent for the coating solution is, preferably, 50 mass % or more and, more preferably, 70 mass % or more. Examples of the preferred solvent composition can include, in addition to water, water/methyl alcohol=90/10, water/methyl alcohol=70/30, water/methyl alcohol/dimethylformamide=80/15/5, water/methyl alcohol/ethyl cellosolve=85/10/5, and water/methyl alcohol/isopropyl alcohol=85/10/5 (numerical value based on mass %). solvents which can be employed in the present invention are described in paragraph No. 0133 of JP-A No. 11-65021.

(Other Additives)

1) Mercapto, Disulfide and Thions

In the present invention, for controlling the development by suppressing or promoting development, for improving the spectral sensitizing efficiency and improving the storability before and after development, mercapto compounds, disulfide compounds and thion compounds can be contained. They are described in JP-A No. 10-62899, in column Nos. 0067 to 0069, the compound represented by formula (I) in JP-A No. 10-186572 and specific examples thereof, in column Nos. 0033 to 0052, and EP-A No. 0803764A1, page 20, lines 36 to 56. Among them, mercapto substituted heterocyclic aromatic compounds described in JP-A Nos. 9-297367, 9-304875, 2001-100358, 2002-303954 and 2002-303951 are preferred.

2) Color Toner

According to the photothermographic material of the present invention, a color toner is preferably added. The color toner is described in paragraph Nos. 0054 to 0055 of JP-A No. 10-62899, page 21, lines 23 to 48 in EP-A No. 0803764, and JP-A Nos. 2000-356317 and 2000-187298, and in particular, preferred examples include phthalazinones (phthalazinone, phthalazinone derivatives or metal salts; e.g., 4-(1-naphthyl)phthalazinone, 6-chlorophthalazinone, 5,7-dimethoxyphthalazinone and 2,3-dihydro-1,4-phthalazinedione); combinations of a phthalazinone and a phthalic acid (e.g., phthalic acid, 4-nethylphthalic acid, 4-nitrophthalic acid, diammonium phthalate, sodium phthalate, potassium phthalate and tetrachlorophthalic anhydride); phthalazines (phthalazine, phthalazine derivatives or metal salts; e.g., 4-(1-naphthyl)phthalazine, 6-isopropylphthalazine, 6-t-butylphthalazine, 6-chlorophthalazine, 5,7-dimethoxyphthalazine and 2,3-dihydrophthalazine); combinations of a phthalazine and a phthalic acid. Particularly preferred examples include combinations of a phthalazine and a phthalic acid. Among them, particularly preferable combination is a combination of 6-isopropylphthalazine and phthalic acid or 4-methylphthalic acid.

3) Plasticizer and Lubricant

In the present invention, known platicizers and lubricants can be used for improving the film property. Particularly, for improving the handlability during production and scratch resistance upon heat development, a lubricant such as liquid paraffin, long chained fatty acid, fatty acid amid, or fatty acid esters is used preferably. Particularly, liquid paraffin removed with low boiling point ingredients or fatty acid esters of a molecular weight of 1000 or more having a branched structure is preferred.

For the plasticizer and the lubricant usable in the image forming layer and the non-photosensitive layer, those compounds described, in JP-A No. 11-65021, in column No. 0117, JP-A No. 2000-5137, JP-A Nos. 2004-219794, 2004-219802, and 2004-334077 are preferred.

4) Dye and Pigment

For the image forming layer of the present invention, various kinds of dyes and pigments can be used with a view point of improving the color tone, preventing occurrence of interference fringe upon laser exposure and prevention of irradiation (for example, C.I. Pigment Blue 60, C.I. Pigment Blue 64, C.I. Pigment Blue 15:6). They are specifically described, for example, in WO98/36322, and JP-A Nos. 10-268465 and 11-338098.

5) Super Hard Toner

It is preferred that a super hard toner is added to the image forming layer for forming a super hard image suited for applications in printing and proofing. The super hard toner, method for adding it and amount of addition are described in paragraph No. 0118 of JP-A No. 11-65021, paragraph Nos. 0136 to 0193 of JP-A No. 11-223898, compounds of the formula (H), the formulae (1) to (3) and the formulae (A) and (B) in JP-A No. 2000-284399, while a super hard tone promoter is described in paragraph No. 0102 of JP-A No. 11-65021, and paragraph Nos. 0194 to 0195 of JP-A No. 11-223898.

For using formic acid or formate as a potent fogging agent, it is preferably contained into the side having the image forming layer containing the photosensitive silver halide in an amount of 5 mmol or less, and still more preferably 1 mmol or less per mol of the silver.

When the super hard toner is used in the photothermographic material of the present invention, an acid yielded by hydration of diphosphorus pentoxide or a salt thereof is preferably used in combination. Examples of the acid yielded by hydration of diphosphorus pentoxide or a salt thereof include metaphosphoric acid (salt), pyrophosphoric acid (salt), orthophosphoric acid (salt), triphosphoric acid (salt), tetraphosphoric acid (salt), hexametaphosphoric acid (salt) and the like. Examples of particularly preferably used acid yielded by hydration of diphosphorus pentoxide or a salt thereof include orthophosphoric acid (salt) and hexametaphosphoric acid (salt). Specific examples of the salt include sodium orthophosphate, sodium dihydrogen orthophosphate, sodium hexametaphosphate, ammonium hexametaphosphate and the like. The amount of the acid yielded by hydration of diphosphorus pentoxide or a salt thereof to be used (amount of coating per m² of the photosensitive material) may be a desired amount in accordance with the performances such as sensitivity or fog, however, the amount is preferably 0.1 mg/m² or greater and 500 mg/m² or less, and more preferably 0.5 mg/M² or greater and 100 mg/m² or less.

(Preparation and Coating of Coating Liquid)

The temperature for preparing the coating liquid for image forming layer in the present invention is preferably 30° C. or higher and 65° C. or lower, more preferably 35° C. or higher and 60° C. or lower, and still more preferably 35° C. or higher and 55° C. or lower. Furthermore, it is preferred that the temperature of the coating liquid for image forming layer immediately after adding the polymer latex is kept at 30° C. or higher and 65° C. or lower.

(4) Other Layer Construction and Component Substance

1) Antihalation Layer

In the photothermographic material of the present invention, an antihalation layer can be provided on the side far away from a light source with respect to the image forming layer.

The antihalation layers are described in paragraph Nos. 0123 to 0124 of JP-A No. 11-65021, JP-A Nos. 11-223898,9-230531, 10-36695, 10-104779, 11-231457, 11-352625 and 11-352626, and the like.

The antihalation layer contains an antihalation dye having absorption at an exposure wavelength. When the exposure wavelength is in the infrared region, an infrared absorption dye is used, and in that case, a dye having no absorption in the visible region may be preferably used.

When halation is prevented by using a dye having absorption in the visible region, it is preferred that the color of the dye does not substantially remain after image formation. For that purpose, a means of decoloring the dye by heat upon thermal development is preferably used, and in particular, it is preferred that a heat color fading dye and a base precursor are added to the nonphotosensitive layer to allow it to serve as an antihalation layer. These techniques are described in JP-A No. 11-231457 and the like.

The amount of addition of the color fading dye is determined depending on the attempted purpose of the dye. In general, it is used in such an amount that an optical density (absorbance) exceeding 0.1 is given when measured at a desired wavelength. The optical density is preferably from 0.15 to 2, and more preferably from 0.2 to 1. The amount of the dyes used for obtaining such optical density is approximately 0.001 g/m² or greater and 1 g/m² or less, in general.

Such decoloring of the dye allows the optical density after thermal development to decrease to 0.1 or less. Two or more kinds of color fading dyes may be used in combination in heat-decolorable recording materials or photothermographic materials. Similarly, two or more kinds of base precursors may be also used in combination. In heat decoloring using such a color fading dye and a base precursor, it is preferred in terms of heat decoloring properties and the like that a substance which lowers the melting point by 3° C. (deg) or more (e.g., diphenyl sulfone and 4-chlorophenyl(phenyl) sulfone), 2-naphthyl benzoate or the like by mixing with the base precursor as described in JP-A No. 11-352626 is used in combination.

2) Back Layer

The back layer applicable to the present invention is described in paragraph Nos. 0128 to 0130 of JP-A No. 11-65021.

In the present invention, for the purpose of improving the silver color tone and time dependent alteration of the images, a coloring agent having the absorption maximum at 300 to 450 nm can be added. Such coloring agents are described in JP-A Nos. 62-210458, 63-104046, 63-103235, 63-208846, 63-306436, 63-314535, 1-61745 and 2001-100363 and the like.

3) Matting Agent

In the present invention, a matting agent is preferably added for the purpose of improving the transferring properties. The matting agent is described in paragraph Nos. 0126 to 0127 of JP-A No.11-65021. When indicated by the amount coated per m² of the photosensitive material, the amount of the matting agent is preferably 1 mg/m² or greater and 400 mg/m² or less, and more preferably 5 mg/m² or greater and 300 mg/M² or less. In the present invention, the shape of the matting agent may be either regular or irregular, however, preferably used matting agent has a regular and spherical shape. The volume weighted average of sphere equivalent diameter of the matting agent used in the emulsion face is preferably 0.3 μm or greater and 10 μm or less, and more preferably 0.5 μm or greater and 7 μm or less. Furthermore, the coefficient of variation of the size distribution of the matting agent is preferably 5% or greater and 80% or less, and more preferably 20% or greater and 80% or less. The coefficient of variation herein is a value represented by (standard deviation of the particle size)/(mean value of the particle size)×100. In addition, two or more kinds of matting agents having different mean particle size may be used for the matting agent on the side containing the emulsion layer. In such cases, the difference between the particle size of the matting agent having the maximum mean particle size and of the matting agent having the minimum particle size is preferably 2 μm or greater and 8 μm or less, and more preferably 2 μm or greater and 6 μm or less. The volume weighted average of sphere equivalent diameter of the matting agent used in the back layer side is preferably 1 μm or greater and 15 μm or less, and more preferably 3 μm or greater and 10 μm or less. Furthermore, the coefficient of variation of the size distribution of the matting agent is preferably 3% or greater and 50% or less, and more preferably 5% or greater and 30% or less. In addition, two or more kinds of matting agents having different mean particle size may be used for the matting agent in the back layer side. In such cases, the difference between the particle size of the matting agent having the maximum mean particle size and of the matting agent having the minimum particle size is preferably 2 μm or greater and 14 μm or less, and more preferably 2 μm or greater and 9 μm or less.

The matting degree of the emulsion layer side may be any one, as long as no stardust trouble occurs. However, the Beck smoothness is preferably 30 seconds or greater and 2,000 seconds or less, and particularly preferably 40 seconds or greater and 1,500 seconds or less. The Beck smoothness can be readily determined by the Japanese Industrial Standard (JIS) P8119, “Smoothness Test Method of Paper and Paperboard with Beck Tester” and the TAPPI Standard T479.

In the present invention, the matting degree of the back layer as indicated by the Beck smoothness is preferably 1200 seconds or less and 10 seconds or greater, more preferably 800 seconds or less and 20 seconds or greater, and still more preferably 500 seconds or less and 40 seconds or greater.

In the present invention, the matting agent is preferably contained in the outermost surface layer, a layer which functions as the outermost surface layer, or a layer close to the outer surface, of the photosensitive material, and preferably included in a layer which functions as a so-called protection layer.

4) Polymer Latex

In particular, when the photothermographic material of the present invention is used for printing application in which changes in dimension may cause troubles, it is preferred that a polymer latex is used in the surface protective layer as well as a back layer. Such polymer latexes are described in “Synthetic Resin Emulsions (edited by Taira Okuda and Hiroshi Inagaki, published by Kobunshi Kankoukai (1978))”, “Application of Synthetic Latexes (edited by Takaaki Sugimura, Yasuo Kataoka, Soichi Suzuki and Keiji Kasahara, published by Kobunshi Kankoukai (1993))”, “Chemistry of Synthetic Latexes, (Soichi Muroi, published by Kobunshi Kankoukai (1970))” and the like, and specific examples thereof include a methyl methacrylate (33.5% by mass)/ethyl acrylate (50% by mass)/methacrylic acid (16.5% by mass) copolymer latex, a methyl methacrylate (47.5% by mass)/butadiene (47.5% by mass)/itaconic acid (5% by mass) copolymer latex, an ethyl acrylate/methacrylic acid copolymer latex, a methyl methacrylate (58.9% by mass)/2-ethylhexyl acrylate (25.4% by mass)/styrene (8.6% by mass)/2-hydroxyethyl methacrylate (5.1% by mass)/acrylic acid (2.0% by mass) copolymer latex, and a methyl methacrylate (64.0% by mass)/styrene (9.0% by mass)/butyl acrylate (20.0% by mass)/2-hydroxyethyl methacrylate (5.0% by mass)/acrylic acid (2.0% by mass) copolymer latex and the like. Further, as the binder for the surface protective layer, there may be applied techniques described in paragraph Nos. 0021 to 0025 of JP-A No. 2000-267226, and techniques described in paragraph Nos. 0023 to 0041 of JP-A No. 2000-19678. The proportion of the polymer latex in the surface protective layer is preferably 10% by mass or greater and 90% by mass or less, and particularly preferably 20% by mass or greater and 80% by mass or less, based on the total binder.

5) Film Surface pH

According to the photothermographic material of the present invention, the film surface pH before thermal development processing is preferably 7.0 or less, and more preferably 6.6 or less. Although there is no particular limitation on the lower limit thereof, it is approximately 3. Most preferable pH is in the range of from 4 to 6.2. It is preferred from the viewpoint of reducing the film surface pH that the film surface pH is adjusted with an organic acid such as a phthalic acid derivative, a nonvolatile acid such as sulfuric acid, or a volatile base such as ammonia. In particular, ammonia is readily volatilized and thus removable before the coating step or thermal development, so that it is preferred in terms of achieving low film surface pH. Also, use of ammonia in combination with a nonvolatile base such as sodium hydroxide, potassium hydroxide or lithium hydroxide is preferably employed. For reference, a method for measuring the film surface pH is described in paragraph No. 0123 of JP-A No. 2000-284399.

6) Film Hardener

A film hardener may be used in each layer of the image forming layer, the protective layer and the back layer in the present invention. Examples of the film hardener which are preferably used include those in each method described in T. H. James, “THE THEORY OF THE PHOTOGRAPHIC PROCESS FOURTH EDITION” (published by Macmillan Publishing Co., Inc. (1977)), pp. 77 to 87, i.e., chromium alum, 2,4-dichloro4-hydroxy-triazine sodium salt, N,N-ethylenebis(vinyl sulfonacetoamide) and N,N-propylenebis(vinyl sulfonacetoamide); and multivalent metal ions described in page 78, ibid.; polyisocyanates described in U.S. Pat. No. 4,281,060 and JP-A No. 6-208193; epoxy compounds described in U.S. Pat. No. 4,791,042; and vinyl sulfone compounds described in JP-A No. 62-89048.

The film hardener is added in a solution, and the solution is preferably added to the coating liquid for protective layer from 180 minutes before coating to immediately before coating, preferably from 60 minutes before coating to 10 seconds before coating. However, the mixing method and the mixing conditions are not particular limited as long as the effect of the present invention is sufficiently achieved. Specific examples of the mixing method include a method in which mixing is executed in a tank designed such that the average residence time calculated from the flow rate of the added solution and the amount of the solution supplied to a coater becomes a desired time, and a method in which a static mixer or the like is used as described in “Mixing in the Process Industries (Ekitai Kongo Gizyutu)”, chapter 8, N. Harnby, M. F. Edwards, A. W. Nienow, translated by Koji Takahashi (published by THE NIKKAN KOGYO SHIMBUN,LTD., 1989).

7) Surface Active Agent

Surface active agents which can be employed in the present invention are described in paragraph No. 0132 of JP-A No. 11-65021. In the present invention, is it preferred that a fluorochemical surface active agent is used. Specific examples of the fluorochemical surface active agent include compounds described in JP-A Nos. 10-197985, 2000-19680 and 2000-214554 and the like. Also, a polymer fluorochemical surface active agent described in JP-A No. 9-281636 is preferably used. In the photothermographic material of the present invention, use of any of the fluorochemical surface active agents described in JP-A Nos. 2002-82411, 2003-057780 and 2003-149766 is preferred. In particular, the fluorochemical surface active agents described in JP-A No. 2003-057780 are preferred in terms of electrostatic charge-adjusting capabilities, stability of the coated face state, and smoothness characteristics when coating and production is performed with a water-based coating liquid. In the present invention, the fluorochemical surface active agent can be used in any of the image forming layer side and the back layer side, and it is preferably used in both of those sides. Furthermore, use in combination with the conductive layer containing the metal oxide as described above is particularly preferred. In this case, sufficient performances can be achieved even though the amount of the fluorochemical surface active agent used in the side having a conductive layer is reduced or withdrawn. Preferable amount of the fluorochemical surface active agent for use is in the range of 0.1 mg/m² or greater and 100 mg/M² or less, more preferably in the range of 0.3 mg/m² or greater and 30 mg/m² or less, and still more preferably in the range of 1 mg/m² or greater and 10 mg/m² or less in the image forming layer side and the back layer side, respectively.

8) Antistatic Agent

In the present invention, it is preferred that a conductive layer comprising a metal oxide or a conductive polymer is provided. The antistatic layer may be combined with the undercoat layer, the back layer surface protective layer or the like, or may be provided separately. As the conductive material of the antistatic layer, a metal oxide having improved conductivity through introducing an oxygen defective heterogeneous metal atom into a metal oxide is preferably used. Preferable examples of the metal oxide include ZnO, TiO₂ and SnO₂. To ZnO is preferably added Al or In; to SnO₂ is preferably added Sb, Nb, P, a halogen element or the like; and to TiO₂ is preferably added Nb, Ta or the like. In particular, SnO₂ to which Sb is added is preferred. The amount of addition of the heterogeneous atom is preferably in the range of 0.01 mol % or greater and 30 mol % or less, and more preferably in the range of 0.1 mol % or greater and 10 mol % or less. The shape of the metal oxide may be any of spherical, acicular and platy, however, acicular particles having a ratio of long axis/short axis of 2.0 or greater, and preferably 3.0 to 50 are desired in the light of the effect to impart the conductivity. The amount of the metal oxide to be used is preferably in the range of 1 mg/m² or greater and 1000 mg/m² or less, more preferably in the range of 10 mg/M² or greater and 500 mg/m² or less, and still more preferably in the range of 20 mg/m² or greater and 200 mg/m² or less. The antistatic layer of the present invention may be provided on either the image forming layer side or the back layer side, however, it is preferred that the antistatic layer is provided between the support and the back layer. Specific examples of the antistatic layer are described in paragraph No. 0135 of JP-A No. 11-65021, JP-A Nos. 56-143430, 56-143431, 58-62646 and 56-120519, paragraph Nos. 0040 to 0051 of JP-A No. 11-84573, U.S. Pat. No. 5,575,957, and paragraph Nos. 0078 to 0084 of JP-A No. 11-223898.

9) Support

For a transparent support, a polyester, particularly polyethylene terephthalate, subjected to a thermal treatment at a temperature in the range of from 130 to 185° C. is preferably used for alleviating the internal distortion that may remain in the film upon biaxial stretching, and for obviating thermal contraction distortion generated during the thermal development processing. In cases of photothermographic materials for medical use, the transparent support may be colored with a blue dye (e.g., dye-1 described in Example of JP-A No. 8-240877), or may be uncolored. To the support may be applied an undercoating technique with a water soluble polyester described in JP-A No. 11-84574, a styrenebutadiene copolymer described in JP-A No. 10-186565, a vinylidene chloride copolymer described in JP-A No. 2000-39684, or the like. The moisture content of the support when the image forming layer or the back layer is coated on the support is preferably 0.5% by mass or less.

Supports which can be employed in the present invention are described in paragraph No. 0134 of JP-A No. 11-65021.

10) Other Additives

To the photothermographic material may be further added an antioxidant, a stabilizer, a plasticizer, an ultraviolet ray absorbing agent or a coating aid. The various additives are added to either the image forming layer or the nonphotosensitive layer. In connection with the additives, WO98/36322, EP-A No. 803764, JP-A Nos. 10-186567 and 10-18568 and the like may be the reference. Lubricants Surface active agents which can be employed in the present invention are described in paragraph Nos. 0061 to 0064 of JP-A No. 11-84573 and paragraph Nos. 0049 to 0062 of JP-A No. 2001-83679.

11) Coating Method

The photothermographic material of the present invention may be coated with any method. Specifically, a variety of coating operations including extrusion coating, slide coating, curtain coating, dip coating, knife coating, flow coating, or extrusion coating in which a hopper of the type described in U.S. Pat. No. 2,681,294 is used may be employed. The slide coating or extrusion coating described in “LIQUID FILM COATING” (published by CHAPMAN & HALL, (1997)), pp. 399 to 536, attributed to Stephen F. Kistler, Petert M. Schweizer is preferably employed, and the slide coating is particularly preferably employed. Examples of the shape of the slide coater for use in the slide coating are illustrated in page 427, FIG. 11b. 1, ibid. Also, two or more layers may be simultaneously coated according to the method described in pp. 399 to 536, ibid., and the method described in U.S. Pat. No. 2,761,791 and GB Patent No. 837,095, as desired. In the present invention, examples of particularly preferable coating method include those described in JP-A Nos. 2001-194748, 2002-153808, 2002-153803 and 2002-182333.

It is preferred that the coating liquid for image forming layer is a so-called thixotropic fluid. In connection with this technique, JP-A No. 11-52509 may be referred to. The coating liquid for image forming layer in the present invention has a viscosity at a shear rate of 0.1 S⁻¹ being preferably 400 mPa.s or greater and 100,000 mPa.s or less, and still more preferably 500 mPa.s or greater and 20,000 mPa.s or less. Furthermore, the viscosity at a shear rate of 1000 S⁻¹ is preferably 1 mPa.s or greater and 200 mPa.s or less, and still more preferably 5 mPa.s or greater and 80 mPa.s or less.

Upon preparation of the coating liquid, when two kinds of liquids are mixed, a known in-line blender or implant blender is preferably used. The preferred in-line blender according to the present invention is described in JP-A No. 2002-85948, and the preferred implant blender is described in JP-A No. 2002-90940. It is preferred that the coating liquid according to the present invention is subjected to a degassing treatment for keeping the coated surface state favorable. Preferable degassing treatment according to the present invention is a method described in JP-A No. 2002-66431. When the coating liquid is applied, decharging is preferably carried out for preventing the support from attachment of dust and dirt resulting from electrostatic charge. Examples of the method of decharging preferred in the present invention are described in JP-A No. 2002-143747. According to the present invention, it is important to precisely control the drying wind and drying temperature in order to dry the coating liquid for image forming layer having nonsetting properties. Preferred drying processes in the present invention are described in detail in JP-A Nos. 2001-194749 and 2002-139814. It is preferred that the photothermographic material of the present invention is subjected to a heating treatment immediately after coating and drying for the purpose of improving the film-forming performances. The temperature for the heating treatment is preferably in the range of from 60° C. to 100° C. as the film face temperature, while the heating time period is preferably in the range of from 1 second to 60 seconds. More preferably, the film face temperature is in the range of from 70 to 90° C., and the heating time period is in the range of from 2 to 10 seconds. Preferred heating method according to the present invention is described in JP-A No. 2002-107872. Moreover, for the continuous production of the photothermographic material of the present invention in a stable manner, methods of the production described in JP-A Nos. 2002-156728 and 2002-182333 are preferably employed.

It is preferred that the photothermographic material is of a monosheet type (type which enables images to be formed on the photothermographic material without using other sheet such as an image-receiving material).

12) Packaging Material

It is preferred that the photosensitive material of the present invention is packed with a packaging material having low oxygen permeability and/or moisture permeability in order to suppress the alteration of the photographic performances during unprocessed stock storage, or to restrain the curling, core set or the like. The oxygen permeability at 25° C. is preferably 50 ml/atm·m² day or less, more preferably 10 ml/atm·m²day or less, and still more preferably 1.0 ml/atm·m² day or less. The moisture permeability is preferably 10 g/atm·m²·day or less, more preferably 5 g/atm·m²·day or less, and still more preferably 1 g/atm·m²·day or less.

Specific examples of the packaging material having low oxygen permeability and/or moisture permeability include, e.g., the packaging materials described in JP-A Nos. 8-254793 and 2000-206653.

13) Other Available Techniques

Examples of techniques which can be utilized for the photothermographic material of the present invention also include those described in EP-A Nos. 803764, and 883022, WO98/36322, JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 1184574, 1165021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-020699, 2001-275471, 2001-275461, 2000-313204, 2001-292844, 2000-324888, 2001-293864, 2001-348546 and 2000-187298.

In instances of multicolor photothermographic materials, each image forming layer is generally held distinctively with each other through using a functional or nonfunctional barrier layer among respective photosensitive layers as described in U.S. Pat. No. 4,460,681. In the construction of the multicolor photothermographic materials, a combination of these two layers for each color may be included, or as described in U.S. Pat. No. 4,708,928, all components may be included in a single layer.

The methods to obtaining color images which can be employed in the present invention are described in paragraph No. 0136 of JP-A No. 11-65021.

3. Image-Forming Method

The photothermographic material of the present invention can be used in any method irrespective of the exposure conditions.

1) Laser Exposure

Red to infrared emitting He—Ne laser, red semiconductor laser, or blue to green emitting Ar⁺, He—Ne, He—Cd laser, blue semiconductor laser can be used. Red to infrared semiconductor laser is preferred, and the peak wavelength of the laser beam is 600 nm to 900 nm, and preferably 620 nm to 850 nm. In recent years, integrated modules of SHG (Second Harmonic Generator) chip and semiconductor laser as well as blue semiconductor laser were developed, and thus laser output devices for shorter wavelength region have attracted the attention. Blue color semiconductor laser has been expected for increasing demand hereafter because image recording with high definition is possible, and increased recording density, as well as stable output with longer operating life are enabled. Peak wavelength of the blue color laser light is from 300 nm to 500 nm, and particularly preferably from 400 nm to 500 nm. Laser light which oscillates in a longitudinal multi mode by a method such as high frequency superposition is also preferably employed.

2) X-ray Exposure

The photothermographic material of the present invention can form an image by an X-ray for use in medical diagnoses and the like. The method for forming images by an X-ray preferably includes the following steps.
(1) step of obtaining a construct for image-formation by providing the photothermographic material between a pair of X-ray intensifying screens;
(2) step of disposing a subject between the construct for image-formation and an X-ray source,
(3) step of irradiating an X-ray having an energy level of in the range of 25 kVp to 125 kVp onto the subject,
(4) step of recovering the photothermographic material from the construct,
(5) step of heating the recovered photothermographic material at a temperature in the range of 90° C. or higher and 180° C. or lower.

It is preferred that the photothermographic material used in the construct is prepared such that an image obtained by subjecting to stepwise exposure with an X-ray followed by thermal development exhibits a characteristic performance curve on an orthogonal coordinate having coordinate axes with an equal unit length of the optical density (D) and the exposure amount (log E), in which average gamma (γ) that is yielded from the point of minimum density (Dmin)+density of 0.1 and the point of minimum density (Dmin)+density of 0.5 is from 0.5 to 0.9, while average gamma (γ) that is yielded from the point of minimum density (Dmin)+density of 1.2 and the point of minimum density (Dmin)+density of 1.6 is from 3.2 to 4.0. When a photothermographic material having such a characteristic performance curve is used in an X-ray photograph system, an X-ray image having excellent photographic characteristics exhibiting a characteristic performance curve with an extremely elongated bottom part and with a middle density part having high gamma value is obtained. On behalf of such photographic characteristics, advantages such as: favorable depictiveness in a mediastinal part with less amount of X-ray transmission and in the low density area such as heart shadow; generation of density which is readily visible in the image of lung area where a large amount of an X-ray is transmitted; and achievement of favorable contrast are brought.

The photothermographic material exhibiting such a preferable characteristic performance curve as described above can be readily produced by, for example, a method in which respective image forming layers on both sides of the support are constructed from two or more photosensitive silver halide emulsion layers having different sensitivity. Particularly, it is preferred that the image forming layer is provided using a highly sensitive emulsion for the upper layer, and poorly sensitive emulsion exhibiting photographic characteristics of super hard tone for the bottom layer. Difference in sensitivity between the photosensitive silver halide emulsions of respective layers when such an image forming layer including two layers is employed is 1.5 fold or greater and 20 fold or less, and preferably 2 fold or greater and 15 fold or less. Proportion of the amount of emulsion used in forming each layer may vary depending on the difference in sensitivity of the used emulsion and covering power. In general, as the difference in sensitivity is great, proportion of use of the emulsion with higher sensitivity should be reduced. For example, when the difference in sensitivity is two fold, it is preferred that the proportion of use of each emulsion, i.e., highly sensitive emulsion vs. poorly sensitive emulsion, on the basis of the amount of silver is adjusted to fall within the range of 1:20 or greater and 1:50 or less in instances where the covering power is almost identical.

For the techniques in connection with crossover cut (double-sided photosensitive material) and antihalation (single-sided photosensitive material), a dye and a dye mordant may be used, or a dye described in JP-A No. 2-68539, from page 13, left and bottom column line 1 to page 14, left and bottom column line 9.

Next, the fluorescent intensifying paper (radioactive ray intensifying screen) according to the present invention is explained. The radioactive ray intensifying screen has a basic structure including a support and a fluorescent material layer formed on one side thereof. The fluorescent material layer is a layer obtained by dispersing a fluorescent material in a bonding agent (binder). A transparent protective film is usually provided on the surface of this fluorescent material layer on the opposite side to the support (the surface which does not face the support), and protects the fluorescent material layer from chemical deterioration or physical impact.

Examples of preferred fluorescent material according to the present invention are illustrated below: tungstate salt-based fluorescent materials (CaWO₄, MgWO₄, CaWO₄:Pb and the like), terbium activated rare earth acid sulfide-based fluorescent materials [Y₂O₂S:Tb, Gd₂O₂S:Tb, La₂O₂S:Tb, (Y,Gd)₂O₂S:Tb, (Y,Gd)O₂S:Tb,Tm and the like], terbium activated rare earth phosphate-based fluorescent materials (YPO₄:Tb, GdPO₄:Tb, LaPO₄:Tb and the like), terbium activated rare earth oxyhalide-based fluorescent materials (LaOBr:Tb, LaOBr:Tb,Tm, LaOCl:Tb, LaOCl:Tb,Tm, LaOBr:Tb, GdOBr:Tb, GdOCl:Tb and the like), thulium activated rare earth oxyhalide-based fluorescent materials (LaOBr:Tm, LaOCl:Tm and the like), barium sulfate-based fluorescent materials [BaSO₄:Pb, BaSO₄:Eu²⁺, (Ba,Sr)SO₄:Eu²⁺ and the like], bivalent europium activated alkaline earth metal phosphate salt-based fluorescent materials [(Ba₂PO₄)₂:Eu²⁺, (Ba₂PO₄)₂:Eu²⁺ and the like], bivalent europium activated alkaline earth metal fluorinated halide-based fluorescent materials [BaFCl:Eu²⁺, BaFBr:Eu²⁺, BaFCl:Eu²⁺,Tb, BaFBr:Eu²⁺,Tb, BaF₂BaClKCl:Eu²⁺, (Ba,Mg)F₂BaClKCl:Eu²⁺ and the like], iodide-based fluorescent materials (CsI:Na, CsI:Tl, Nal, KI:Tl and the like), sulfide-based fluorescent materials [ZnS:Ag(Zn,Cd)S:Ag, (Zn,Cd)S:Cu, (Zn,Cd)S:Cu,Al and the like], hafnium phosphate-based fluorescent material s(HfP₂O₇:Cu and the like), YTaO₄, and materials including any of various activators added thereto as a luminescence center. However, the fluorescent material which may be used in the present invention is not limited thereto, but any fluorescent material which results in emission in visible or near ultraviolet region upon irradiation of a radioactive ray can be used.

The fluorescent intensifying paper for use in the present invention is preferably filled with a fluorescent material in a gradient particle size structure. Particularly, it is preferred that the fluorescent material particles having a larger particle size are coated on the side of the surface protective layer, while the fluorescent material particles having a smaller particle size are coated on the side of the support. It is preferred that the smaller particle size is in the range of 0.5 μm or greater and 2.0 μm or less, while the larger particle size in the range of 10 μm or greater and 30 μm or less.

As the image-forming method using the photothermographic material of the present invention, a method in which an image is formed preferably in combination with a fluorescent material having a main peak at 400 nm or less can be employed. A method in which an image is formed in combination with a fluorescent material having a main peak at 380 nm or less is more preferred. Either the double-sided photosensitive material or the single-sided photosensitive material can be used in the construct. As the screen having a main emission peak at 400 nm or less, screens described in JP-A No. 6-11804 and WO93/01521 may be used but not limited thereto. As the techniques involving crossover cut of the ultraviolet ray (double-sided photosensitive material) and antihalation (single-sided photosensitive material), techniques described in JP-A No. 8-76307 can be employed. Dyes described in JP-A No. 2001-144030 are particularly preferred as the ultraviolet ray absorbing dye.

2) Thermal Development

Although the photothermographic material of the present invention may be developed with any method, it is usually developed by elevating the temperature of the photothermographic material which had been exposed imagewise. The temperature for the development is preferably 80° C. or higher and 250° C. or lower, still preferably 100° C. or higher and 140° C. or lower, and still more preferably 110° C. or higher and 130° C. or lower. Time period for the development is preferably 1 second or greater and 60 seconds or less, more preferably 3 seconds or greater and 30 seconds or less, still more preferably 5 seconds or greater and 25 seconds or less, and particularly preferably 7 seconds or greater and 15 seconds or less.

In the process for the thermal development, either a drum type heater or a plate type heater may be used, however, the plate type heater processes are more preferred. Preferable process for the thermal development by a plate type heater may be a process described in JP-A No. 11-133572, which discloses a thermal developing device in which a visible image is obtained by bringing a photothermographic material with a formed latent image into contact with a heating means at a thermal development region, wherein the heating means comprises a plate heater, and plurality of retainer rollers are oppositely provided along one surface of the plate heater, the thermal developing device is characterized in that thermal development is performed by passing the photothermographic material between the retainer rollers and the plate heater. It is preferred that the plate heater is divided into 2 to 6 sections, with the leading end having the lower temperature by 1 to 10° C. For example, 4 sets of plate heaters which can be independently controlled the temperature are used, and are controlled so that they respectively become 112° C., 119° C., 121° C., and 120° C. Such a process is described also in JP-A No.54-30032, which allows for excluding moisture and organic solvents included in the photothermographic material out of the system, and also allows for suppressing the change of shapes of the support of the photothermographic material upon rapid heating of the photothermographic material.

For downsizing the thermal developing machine as well as reduction in thermal development time period, it is preferred that more stable control of the heater can be accomplished, and in addition, it is desired that light exposure is started from the leading end of one photosensitive material sheet followed by thermal development which is started before completing the light exposure up to the posterior end. Preferable imagers which enable a rapid processing according to the present invention are described in for example, JP-A Nos. 2002-289804 and 2002-287668. When such an imager is used, the thermal developing processing can be performed in 14 seconds with a plate type heater having three sections which are controlled to be 107° C.-121° C.-121° C. Thus, the output time period for the first sheet can be reduced to about 60 seconds. For such a rapid developing processing, to use the photothermographic material—2 of the present invention in combination, which is highly sensitive and less susceptible to the room temperature, is preferred.

3) System

A laser imager for medical use having an exposure station and a heat development station can include Fuji Medical Dry Imager FM-DPL. The system is described in Fuji Medical Review No. 8, page 39-55 and the techniques thereof can be utilized. Further, it is also applicable as the photothermographic material for the laser imager in “AD network” proposed by Fuji Film Medical Co. Ltd. as a network system adaptable to DICOM Standards.

4. Application Use of the Present Invention

The photothermographic material of the present invention forms black and white images by silver images and is used preferably as photothermographic materials for use in medical diagnosis, photothermographic materials for use in industrial photography, photothermographic materials for use in printing, and photothermographic materials for use in COM.

### EXAMPLES

Hereinafter, the present invention is explained in more detail by way of Examples, however, the present invention is not limited thereto.

### Example 1

(Production of PET Support)

1) Film Manufacturing

PET having IV (intrinsic viscosity) of 0.66 (measured in phenol/tetrachloroethane=6/4 (weight ratio) at 25° C.) was obtained according to a conventional method using terephthalic acid and ethylene glycol. The product was pelletized, dried at 130° C. for 4 hours, melted at 300° C., and extruded from a T-die and rapidly cooled to form an unstretched film.

The film was stretched along the longitudinal direction by 3.3 times using rollers of different peripheral speeds, and then stretched along the transverse direction by 4.5 times using a tenter. The temperatures used for these operations were 110° C. and 130° C., respectively. Then, the film was subjected to thermal fixation at 240° C. for 20 seconds, and relaxed by 4% along the transverse direction at the same temperature. Thereafter, the chuck of the tenter was released, and both edges of the film were knurled. Then the film was rolled up at 4 kg/cm² to obtain a roll having the thickness of 175 μm.

2) Surface Corona Discharge Treatment

Both surfaces of the support were treated at room temperature at 20 m/minute using Solid State Corona Discharge Treatment Machine Model 6KVA manufactured by Piller GmbH. It was found that treatment of 0.375 kV·A·minute/m² was executed, judging from the readings of current and voltage on that occasion. The frequency upon this treatment was 9.6 kHz, and the gap clearance between the electrode and dielectric roll was 1.6 mm.

3) Undercoating

Formula (1) (for undercoat layer on the image forming layer side)

| | | |
|---|---|---|
| Pesresin A-520 manufactured by Takamatsu Oil & Fat Co., | 46.8 | g |
| Ltd. (30% by mass solution) | | |
| Vylonal MD-1200 manufactured by Toyobo Co., Ltd. | 10.4 | g |
| Polyethylene glycol monononylphenyl ether | 11.0 | g |
| (average ethylene oxide number = 8.5) 1% | | |
| by mass solution | | |
| MP-1000 manufactured by Soken Chemical & Engineering | 0.91 | g |
| Co., Ltd. (PMMA polymer fine particle, mean | | |
| particle diameter of 0.4 μm) | | |
| Distilled water | 931 | ml |

Formula (2) (for first layer on the back side)

| | | |
|---|---|---|
| Styrene-butadiene copolymer latex | 130.8 | g |
| (solid mattingr content of 40% by mass, styrene/butadiene | | |
| weight ratio = 68/32) | | |
| 8% by mass aqueous solution of 2,4-dichloro-6- | 5.2 | g |
| hydroxy-S-triazine sodium salt | | |
| 1% by mass aqueous solution of sodium | 10 | ml |
| laurylbenzenesulfonate | | |
| Polystyrene particle dispersion | 0.5 | g |
| (mean particle size of 2 μm, 20% by mass) | | |
| distilled water | 854 | ml |

Formula (3) (for second layer on the back face side)

| | | |
|---|---|---|
| SnO₂/SbO (9/1 of weight ratio, mean particle | 84 | g |
| diameter of 0.5 μm, 17% by mass dispersion) | | |
| Gelatin | 7.9 | g |
| METOLOSE TC-5 manufactured by Shin-Etsu Chemical | 10 | g |
| Co., Ltd. (2% by mass aqueous solution) | | |
| 1% by mass aqueous solution of sodium | 10 | ml |
| dodecylbenzenesulfonate | | |
| NaOH (1% by mass) | 7 | g |
| Proxel (manufactured by Avecia Limited) | 0.5 | g |
| distilled water | 881 | ml |

Both surfaces of the aforementioned biaxially stretched polyethylene terephthalate support having a thickness of 175 μm were subjected to the corona discharge treatment as described above. Thereafter, the aforementioned formula (1) of the coating liquid for the undercoat was coated on one surface (image forming layer side) with a wire bar so that the amount of wet coating became 6.6 ml/m² (per one side), and dried at 180° C. for 5 minutes. Then, the aforementioned formula (2) of the coating liquid for the undercoat was coated on the reverse side (back layer side) with a wire bar so that the amount of wet coating became 5.7 ml/m², and dried at 180° C. for 5 minutes. Furthermore, the aforementioned formula (3) of the coating liquid for the undercoat was coated on the reverse side (back layer side) with a wire bar so that the amount of wet coating became 8.4 ml/m², and dried at 180° C. for 6 minutes. Accordingly, an undercoated support was produced.

(Back Layer)

1) Preparation of Coating Liquid for Back Layer

(Preparation of Fluid Dispersion of Solid Fine Particles of Base Precursor (a))

A base precursor compound—1 in an amount of 2.5 kg, and 300 g of a surface active agent (trade name: DEMOL N, manufactured by Kao Corporation), 800 g of diphenyl sulfone, 1.0 g of benzoisothiazolinone sodium salt and distilled water were added to give the total amount of 8.0 kg and mixed. The mixed liquid was subjected to beads dispersion using a horizontal sand mill (UVM-2: manufactured by IMEX Co., Ltd.). Process for dispersion included feeding the mixed liquid to UVM-2 packed with zircoria beads having a mean particle diameter of 0.5 mm with a diaphragm pump, followed by dispersing under a condition at the inner pressure of 50 hPa or higher until desired mean particle diameter could be achieved.

The dispersion was dispersed until the ratio of the optical density at 450 nm and the optical density at 650 nm for the spectral absorption of the dispersion (D450/D650) became 3.0 upon spectral absorption measurement. Thus resulting dispersion was diluted in distilled water so that the concentration of the base precursor became 25% by mass, and filtrated (with a polypropylene filter having a mean fine pore diameter of 3 μm) for eliminating dust to put into practical use.

2) Preparation of Fluid Dispersion of Dye Solid Fine Particles

A cyanine dye compound—1 in an amount of 6.0 kg, and 3.0 kg of sodium p-dodecylbenzenesulfonate, 0.6 kg of DEMOL SNB, a surface active agent manufactured by Kao Corporation, and 0.15 kg of an antifoaming agent (trade name: SURFYNOL 104E, manufactured by Nissin Chemical Industry Co., Ltd.) were mixed with distilled water to give the total liquid amount of 60 kg. The mixed liquid was subjected to dispersion with 0.5 mm zirconia beads using a horizontal sand mill (UVM-2: manufactured by IMEX Co., Ltd.).

The dispersion was dispersed until the ratio of the optical density at 650 nm and the optical density at 750 nm for the spectral absorption of the dispersion (D650/D750) became 5.0 or greater upon spectral absorption measurement. Thus resulting dispersion was diluted in distilled water so that the concentration of the cyanine dye became 6% by mass, and filtrated with a filter (mean fine pore diameter: 1 μm) for eliminating dust to put into practical use.

3) Preparation of Coating Liquid for Antihalation Layer

A vessel was kept at a temperature of 40° C., and thereto were added 40 g of gelatin, 0.1 g of benzoisothiazolinone and 490 ml of water to allow gelatin dissolved. Additionally, 2.3 ml of an aqueous 1 mol/L solution of sodium hydroxide, 40 g of the aforementioned fluid dispersion of the dye solid fine particles, 90 g of the aforementioned fluid dispersion of the base precursor solid fine particles (a), 12 ml of an aqueous 3 mass % sodium of polystyrenesulfonate solution, and 180 g of a 10% by mass solution of an SBR latex were admixed. Just prior to the coating, 80 ml of a 4% by mass aqueous solution of N,N-ethylenebis(vinylsulfone acetamide) was admixed to give a coating liquid for the antihalation layer.

4) Preparation of Coating Liquid for Protective Layer of Back Layer Side

<<Preparation of Coating Liquid for Protective Layer of Back Layer Side—1>>

A vessel was kept at a temperature of 40° C., and thereto were added 40 g of gelatin, 35 mg of benzoisothiazolinone and 840 ml of water to allow gelatin dissolved. Additionally, 5.8 ml of a 1 mol/l aqueous sodium hydroxide solution, 5 g of a 10% by mass emulsion of liquid paraffin, 5 g of a 10% by mass emulsion of trimethylolpropane triisostearate, 10 ml of a 5% by mass aqueous solution of sulfosuccinic acid di(2-ethylhexyl) sodium salt, 20 ml of a 3% by mass aqueous solution of sodium polystyrenesulfonate, 2.4 ml of a 2% by mass solution of a fluorochemical surface active agent (F-1), 2.4 ml of a 2% by mass solution of a fluorochemical surface active agent (F-2), and 32 g of a 19% by mass solution of latex-1 were admixed. Just prior to the coating, 25 ml of a 4% by mass aqueous solution of N,N-ethylenebis(vinylsulfone acetamide) was admixed to give a coating liquid for the back face preventive layer.

4) Coating of Back Layer

The back layer side of the undercoated support as described above was subjected to simultaneous superposition coating so that the coating liquid for the antihalation layer gives the coating amount of gelatin of 0.52 g/m², and so that the coating liquid for the back layer side protective layer gives the coating amount of gelatin of 1.7 g/m², followed by drying to produce a back layer.

(Image Forming Layer, Intermediate Layer, and Surface Protective Layer)

1. Preparation of Materials for Coating

1) Silver Halide Emulsion

<Preparation of Silver Halide Emulsion 1>>

A liquid prepared by adding 3.1 ml of a 1% by mass potassium bromide solution to 1421 ml of distilled water followed by further adding 3.5 ml of sulfuric acid having a concentration of 0.5 mol/L and 31.7 g of phthalated gelatin was kept at a liquid temperature of 30° C. while stirring in a stainless steel reaction pot, and thereto was added the whole of: a solution A prepared through diluting 22.22 g of silver nitrate by adding distilled water to give the volume of 95.4 ml; and a solution B prepared through diluting 15.3 g of potassium bromide and 0.8 g of potassium iodide in distilled water to give the volume of 97.4 ml, over 45 seconds at a constant flow rate. Thereafter, 10 ml of a 3.5% by mass aqueous solution of hydrogen peroxide was added thereto, and 10.8 ml of a 10% by mass aqueous solution of benzoimidazole was further added. Moreover, a solution C prepared through diluting 51.86 g of silver nitrate by adding distilled water to give the volume of 317.5 ml and a solution D prepared through diluting 44.2 g of potassium bromide and 2.2 g of potassium iodide in distilled water to give the volume of 400 ml were added thereto. Total amount of the solution C was added at a constant flow rate over 20 minutes, and the solution D was added with a double jet method while maintaining the pAg at 8.1. Hexachloroiridium (III) potassium salt was added in its entirety to give 1×10⁻⁴ mol per mol of silver at 10 minutes post initiation of the addition of the solution C and the solution D. Moreover, at 5 seconds after completing the addition of the solution C, a potassium iron (II) hexacyanide aqueous solution was added in a total amount of 3×10⁻⁴ mol per mol of silver. The mixture was adjusted to give the pH of 3.8 with sulfuric acid having a concentration of 0.5 mol/L. Thereafter, stirring was terminated, and the mixture was subjected to precipitation/desalting/water washing steps. The mixture was adjusted to the pH of 5.9 with sodium hydroxide having the concentration of 1 mol/L to produce a silver halide dispersion having a pAg of 8.0.

The silver halide dispersion was kept at 38° C. while stirring, and thereto was added 5 ml of a 0.34% by mass methanol solution of 1,2-benzoisothiazoline-3-one, followed by elevating the temperature to 47° C. in 40 minutes thereafter. In 20 minutes after elevating the temperature, a solution of sodium benzene thiosulfonate in methanol was added at 7.6×10⁻⁵ mol per mol of silver. Additional 5 minutes later, a tellurium sensitizer C in a methanol solution was added at 2.9×10⁻⁴ mol per mol of silver and subjected to ripening for 91 minutes. Thereafter, a methanol solution of a spectral sensitizing pigment A and sensitizing pigment B with a molar ratio of 3:1 was added thereto to give 1.2×10⁻³ mol in total of the sensitizing pigments A and B per mol of silver. One minute later, 1.3 ml of a 0.8% by mass N,N′-dihydroxy-N″-diethylmelamine solution in methanol was added thereto, and in additional 4 minutes thereafter, 5-methyl-2-mercaptobenzoimidazole in a methanol solution at 4.8×10⁻³ mol per mol of silver, 1-phenyl-2-heptyl-5-mercapto-1,3,4-triazole in a methanol solution at 5.4×10⁻³ mol per mol of silver, and 1-(3-methylureidophenyl)-5-mercaptotetrazole in an aqueous solution at 8.5×10⁻³ mol per mol of silver were added thereto to produce a silver halide emulsion 1.

Particles in thus prepared silver halide emulsion were silver bromoiodide particles having a mean sphere equivalent diameter of 0.042 μm, a coefficient of variation of the sphere equivalent diameter of 20%, which uniformly include iodine at 3.5 mol %. Particle size and the like were determined from the average of 1000 particles using an electron microscope. The {100} face ratio of this particle was found to be 80% using a Kubelka Munk method.

<<Preparation of Silver Halide Emulsion 2>>

Preparation of silver halide emulsion 2 was conducted in a similar manner to the preparation of the silver halide emulsion 1 except that: the temperature of the liquid upon formation of the particles was altered from 30° C. to 47° C.; the solution B was changed to that prepared through diluting 15.9 g of potassium bromide in distilled water to give the volume of 97.4 ml; the solution D was changed to that prepared through diluting 45.8 g of potassium bromide in distilled water to give the volume of 400 ml; timing point of adding the solution C was changed to 30 min; and addition of potassium iron (II) hexacyanide was deleted. The precipitation/desalting/water washing/dispersion were carried out similarly to the silver halide emulsion 1. Furthermore, the spectral sensitization, chemical sensitization, and addition of 5-methyl-2-mercaptobenzoimidazole and 1-phenyl-2-heptyl-5-mercapto-1,3,4-triazole was executed similarly to the emulsion 1 except that: the amount of the tellurium sensitizer C to be added was changed to 1.1×10⁻⁴ mol per mol of silver; the amount of the methanol solution of the spectral sensitizing pigment A and the sensitizing pigment B with a molar ratio of 3:1 to be added was changed to 7.0×10⁻⁴ mol in total of the sensitizing pigment A and the sensitizing pigment B per mol of silver; the addition of 1-phenyl-2-heptyl-5-mercapto-1,3,4-triazole was changed to give 3.3×10^{31 3} mol per mol of silver; and the addition of 1-(3-methylureidophenyl)-5-mercaptotetrazole was changed to give 4.7×10⁻³ mol per mol of silver to produce a silver halide emulsion 2. The emulsion particles in the silver halide emulsion 2 were pure cubic silver bromide particles having a mean sphere equivalent diameter of 0.080 μm and a coefficient of variation of the sphere equivalent diameter of 20%.

<<Preparation of Silver Halide Emulsion 3>>

Preparation of a silver halide emulsion 3 was conducted in a similar manner to the preparation of the silver halide emulsion 1 except that the temperature of the liquid upon formation of the particles was altered from 30° C. to 27° C. In addition, the precipitation/desalting/water washing/dispersion was carried out similarly to the silver halide emulsion 1. The silver halide emulsion 3 was obtained similarly to the emulsion 1 except that: the addition of the spectral sensitizing pigment A and spectral sensitizing pigment B was changed to the state of a solid dispersion (aqueous solution containing gelatin) at a molar ratio of 1:1 with the amount to be added being 6.0×10⁻³ mol in total of the sensitizing pigment A and sensitizing pigment B per mol of silver; the amount of the tellurium sensitizer C to be added was changed to 5.2×10⁻³ mol per mol of silver; and bromoauric acid at 5×10⁻³ mol per mol of silver and potassium thiocyanate at 2×10⁻³ mol per mol of silver were added at 3 minutes following the addition of the tellurium sensitizer. The emulsion particles in the silver halide emulsion 3 were silver bromoiodide particles having a mean sphere equivalent diameter of 0.034 μm and a coefficient of variation of the sphere equivalent diameter of 20%, which uniformly include iodine at 3.5 mol %.

<<Preparation of Mixed Emulsion A for Coating Liquid>>

The silver halide emulsion 1 at 70% by mass, the silver halide emulsion 2 at 15% by mass and the silver halide emulsion 3 at 15% by mass were dissolved, and thereto was added benzothiazolium iodide at 7×10⁻³ mol per mol of silver in a 1% by mass aqueous solution. Moreover, compounds 1, 2 and 3 whose one electron oxidized form produced by one electron oxidation can release one or more electrons were added in an amount to be 2×10⁻³ mol per mol of silver in the silver halide, respectively. Adsorptive redox compounds 1 and 2 having an adsorptive group and a reducing group were added thereto in an amount to be 5×10⁻³ mol per mol of the silver halide, respectively. Further, water was added thereto to give the content of silver halide of 38.2 g per kg of the mixed emulsion for a coating liquid, and 1-(3-methylureidophenyl)-5mercaptotetrazole was added to give 0.34 g per kg of the mixed emulsion for a coating liquid.

2) Preparation of Organic Silver Salt Dispersion

<<Preparation of Organic Silver Salt Dispersion B>>

<Preparation of Recrystallized Behenic Acid>

Behenic acid manufactured by Henkel Co. (trade name: Edenor C2285R) in an amount of 100 kg was admixed with 1200 kg of isopropyl alcohol, and dissolved at 50° C. The mixture was filtrated through a 10 μm filter, and cooled to 30° C. to allow recrystallization. Cooling speed for the recrystallization was controlled to be 3° C./hour. Thus resulting crystal was subjected to centrifugal filtration, and washing was conducted with 100 kg of isopropyl alcohol followed by drying. Thus resulting crystal was esterified, and subjected to GC-FID measurement to give the results of the content of behenic acid being 96 mol %, and in addition thereto, lignoceric acid at 2 mol %, arachidic acid at 2 mol % and erucic acid at 0.001 mol % were included.

<Preparation of Organic Silver Salt Dispersion B>

Recrystallized behenic acid in an amount of 88 kg, 422 L of distilled water, 49.2 L of an aqueous NaOH solution at the concentration of 5 mol/L, 120 L of t-butyl alcohol were admixed, and a reaction was allowed with stirring at 75° C. for 1 hour to give a sodium behenate solution B. Separately, 206.2 L of an aqueous solution of 40.4 kg of silver nitrate (pH 4.0) was provided, and kept at a temperature of 10° C. A reaction vessel charged with 635 L of distilled water and 30 L of t-butyl alcohol was kept at a temperature of 30° C., and thereto were added the entire amount of the sodium behenate solution B and the entire amount of the aqueous silver nitrate solution with sufficient stirring at a constant flow rate over 93 minutes and 15 seconds, and 90 minutes, respectively. Upon this operation, during first 11 minutes following the initiation of adding the aqueous silver nitrate solution, the added material was restricted to the aqueous silver nitrate solution alone. The addition of the sodium behenate solution B was thereafter started, and during 14 minutes and 15 seconds following the completion of adding the aqueous silver nitrate solution, the added material was restricted to the sodium behenate solution B alone. During this operation, the temperature inside of the reaction vessel was set to be 30° C, and the temperature outside was controlled so that the liquid temperature could be kept constant. In addition, the temperature of a pipeline for the addition system of the sodium behenate solution B was kept constant by circulation of warm water outside of a double wall pipe, so that the temperature of the liquid at an outlet in the leading edge of the nozzle for addition was adjusted to be 75° C. Further, the temperature of a pipeline for the addition system of the aqueous silver nitrate solution was kept constant by circulation of cool water outside of a double wall pipe. Position at which the sodium behenate solution B was added and the position at which the aqueous silver nitrate solution was added were arranged symmetrically with a shaft for stirring located at a center. Moreover, both of the positions were adjusted to avoid contact with the reaction liquid.

After completing the addition of the sodium behenate solution B, the mixture was left to stand while stirring at the temperature as it is for 20 minutes. The temperature of the mixture was then elevated to 35° C. over 30 minutes followed by ripening for 210 minutes. Immediately after completing the ripening, solid mattingrs were filtered out with centrifugal filtration. The solid mattingrs were washed with water until the electric conductivity of the filtrated water became 30 μS/cm. An organic silver salt was thus obtained. The resulting solid mattingrs were stored as a wet cake without dehydration. Evaluation of the shape of the resulting silver behenate particles by an electron micrography revealed a crystal having a=0.21 μm, b=0.4 μm and c=0.4 μm on the average value, with a mean aspect ratio of 2.1, and a coefficient of variation of the sphere equivalent diameter of 11% (a, b and c are as defined herein).

To the wet cake corresponding to 260 kg of a dry solid mattingr content, were added 19.3 kg of polyvinyl alcohol (trade name: PVA-217) and water to give the total amount of 1000 kg. Then, a slurry was obtained from the mixture using a dissolver blade. Additionally, the slurry was subjected to preliminary dispersion with a pipeline mixer (manufactured by MIZUHO Industrial Co., Ltd.: type PM-10).

Next, a stock liquid after the preliminary dispersion was treated three times using a dispersing machine (trade name: Microfluidizer M610, manufactured by Microfluidex International Corporation, using type Z Interaction Chamber) with the pressure controlled to be 1150 kg/cm² to give a silver behenate dispersion. For the cooling manipulation, coiled heat exchangers were equipped fore and aft of the interaction chamber respectively, and accordingly, the temperature for the dispersion was set to be 18° C. by adjusting the temperature of the cooling medium.

3) Preparation of Reducing Agent Dispersion

<<Preparation of Reducing Agent—2 Dispersion>>

To 10 kg of a reducing agent—2 (6,6′-di-t-butyl-4,4′-dimethyl-2,2′-butylidenediphenol)) and 16 kg of a 10% by mass aqueous solution of modified polyvinyl alcohol (manufactured by Kuraray Co., Ltd., Poval MP203) was added 10 kg of water, and thoroughly mixed to give a slurry. This slurry was fed with a diaphragm pump, and was subjected to dispersion with a horizontal sand mill (UVM-2: manufactured by IMEX Co., Ltd.) packed with zirconia beads having a mean particle diameter of 0.5 mm for 3 hours and 30 minutes. Thereafter, 0.2 g of benzoisothiazolinone sodium salt and water were added thereto, thereby adjusting the concentration of the reducing agent to be 25% by mass. This fluid dispersion was heated at 40° C. for 1 hour, followed by a subsequent heat treatment at 80° C. for 1 hour to obtain a reducing agent—2 dispersion. Particles of the reducing agent included in thus resulting reducing agent dispersion had a median diameter of 0.50 μm, and a maximum particle diameter of 1.6 μm or less. The resultant reducing agent dispersion was subjected to filtration with a polypropylene filter having a pore size of 3.0 μm to remove foreign substances such as dust, and stored.

4) Preparation of Hydrogen Bonding Compound—1 Dispersion

To 10 kg of a hydrogen bonding compound—1 (tri(4-1-butylphenyl)phosphineoxide) and 16 kg of a 10% by mass aqueous solution of modified polyvinyl alcohol (manufactured by Kuraray Co., Ltd., Poval MP203) was added 10 kg of water, and thoroughly mixed to give a slurry. This slurry was fed with a diaphragm pump, and was subjected to dispersion with a horizontal sand mill (UVM-2: manufactured by IMEX Co., Ltd.) packed with zirconia beads having a mean particle diameter of 0.5 mm for 4 hours. Thereafter, 0.2 g of benzoisothiazolinone sodium salt and water were added thereto, thereby adjusting the concentration of the hydrogen bonding compound to be 25% by mass. This fluid dispersion was heated at 40° C. for 1 hour, followed by a subsequent heat treatment at 80° C. for 1 hour to obtain a hydrogen bonding compound—1 dispersion. Particles of the hydrogen bonding compound included in thus resulting hydrogen bonding compound dispersion had a median diameter of 0.45 μm, and a maximum particle diameter of 1.3 μm or less. The resultant hydrogen bonding compound dispersion was subjected to filtration with a polypropylene filter having a pore size of 3.0 μm to remove foreign substances such as dust, and stored.

5) Preparation of Development Accelerator—1 Dispersion

To 10 kg of a development accelerator—1 and 20 kg of a 10% by mass aqueous solution of modified polyvinyl alcohol (manufactured by Kuraray Co., Ltd., Poval MP203) was added 10 kg of water, and thoroughly mixed to give a slurry. This slurry was fed with a diaphragm pump, and was subjected to dispersion with a horizontal sand mill (UVM-2: manufactured by IMEX Co., Ltd.) packed with zirconia beads having a mean particle diameter of 0.5 mm for 3 hours and 30 minuets. Thereafter, 0.2 g of benzoisothiazolinone sodium salt and water were added thereto, thereby adjusting the concentration of the development accelerator to be 20% by mass. Accordingly, a development accelerator—1 dispersion was obtained. Particles of the development accelerator included in thus resulting development accelerator dispersion had a median diameter of 0.48 μm, and a maximum particle diameter of 1.4 μm or less. The resultant development accelerator dispersion was subjected to filtration with a polypropylene filter having a pore size of 3.0 μm to remove foreign substances such as dust, and stored.

6) Preparation of Dispersions of Development Accelerator—2 and Color Tone-Adjusting Agent—1

In connection with solid dispersion of the development accelerator—2 and color tone-adjusting agent—1, they were also dispersed in a similar manner to the development accelerator—1, and thus, 20% by mass and 15% by mass of dispersion was obtained, respectively.

7) Preparation of Polyhalogenated Compound

<<Preparation of Organic Polyhalogenated Compound—1 Dispersion>>

An organic polyhalogenated compound—1 (tribromomethane sulfonylbenzene) in an amount of 10 kg, 10 kg of a 20% by mass aqueous solution of modified polyvinyl alcohol (manufactured by Kuraray Co., Ltd., Poval MP203), 0.4 kg of a 20% by mass aqueous solution of sodium triisopropylnaphthalenesulfonate and 14 kg of water were added, and thoroughly admixed to give a slurry. This slurry was fed with a diaphragm pump, and was subjected to dispersion with a horizontal sand mill (UVM-2: manufactured by IMEX Co., Ltd.) packed with zirconia beads having a mean particle diameter of 0.5 mm for 5 hours. Thereafter, 0.2 g of benzoisothiazolinone sodium salt and water were added thereto, thereby adjusting the concentration of the organic polyhalogenated compound to be 26% by mass. Accordingly, an organic polyhalogenated compound—1 dispersion was obtained. Particles of the organic polyhalogenated compound included in thus resulting polyhalogenated compound dispersion had a median diameter of 0.41 μm, and a maximum particle diameter of 2.0 μm or less. The resultant organic polyhalogenated compound dispersion was subjected to filtration with a polypropylene filter having a pore size of 10.0 μm to remove foreign substances such as dust, and stored.

<Preparation of Organic Polyhalogenated Compound—2 Dispersion>>

An organic polyhalogenated compound—2 (N-butyl-3-tribromomethane sulfonylbenzoamide) in an amount of 10 kg, 20 kg of a 10% by mass aqueous solution of modified polyvinyl alcohol (manufactured by Kuraray Co., Ltd., Poval MP203) and 0.4 kg of a 20% by mass aqueous solution of sodium triisopropylnaphthalenesulfonate were added, and thoroughly admixed to give a slurry. This slurry was fed with a diaphragm pump, and was subjected to dispersion with a horizontal sand mill (UVM-2: manufactured by IMEX Co., Ltd.) packed with zirconia beads having a mean particle diameter of 0.5 mm for 5 hours. Thereafter, 0.2 g of benzoisothiazolinone sodium salt and water were added thereto, thereby adjusting the concentration of the organic polyhalogenated compound to be 30% by mass. This fluid dispersion was heated at 40° C. for 5 hours to obtain an organic polyhalogenated compound—2 dispersion. Particles of the organic polyhalogenated compound included in thus resulting polyhalogenated compound dispersion had a median diameter of 0.40 μm, and a maximum particle diameter of 1.3 μm or less. The resultant organic polyhalogenated compound dispersion was subjected to filtration with a polypropylene filter having a pore size of 3.0 μm to remove foreign substances such as dust, and stored.

8) Preparation of Phthalazine Compound—1 Solution

Modified polyvinyl alcohol MP203 manufactured by Kuraray Co., Ltd., in an amount of 8 kg was dissolved in 174.57 kg of water, and then thereto were added 3.15 kg of a 20% by mass aqueous solution of sodium triisopropyl naphthalenesulfonate and 14.28 kg of a 70% by mass aqueous solution of a phthalazine compound—1 (6-isopropyl phthalazine) to prepare a 5% by mass solution of the phthalazine compound—1.

9) Preparation of Mercapto Compound

<<Preparation of Mercapto Compound—2 Aqueous Solution>>

A mercapto compound—2 (1-(3-methylureidophenyl)-5-mercaptotetrazole) in an amount of 20 g was dissolved in 980 g of water to give a 2.0% by mass aqueous solution.

10) Preparation of Pigment—1 Dispersion

C.I. Pigment Blue 60 in an amount of 64 g and 6.4 g of DEMOL N manufactured by Kao Corporation were added to 250 g water and thoroughly mixed to give a slurry. Zirconia beads having a mean particle diameter of 0.5 mm were provided in an amount of 800 g, and charged in a vessel with the slurry. Dispersion was performed with a dispersing machine (¼G sand grinder mill: manufactured by IMEX Co., Ltd.) for 25 hours. Thereto was added water to adjust so that the concentration of the pigment became 5% by mass to obtain a pigment—1 dispersion. Particles of the pigment included in thus resulting pigment dispersion had a mean particle diameter of 0.21 μm.

11) Preparation of SBR Latex Solution

SBR latex was prepared as described below.

To a polymerization tank of a gas monomer reaction apparatus (manufactured by Taiatsu Techno Corporation, type TAS-2J) were charged 287 g of distilled water, 7.73 g of a surface active agent (Pionin A-43-S (manufactured by TAKEMOTO OIL & FAT CO.,LTD.): solid mattingr content of 48.5% by mass), 14.06 ml of 1 mol/liter NaOH, 0.15 g of ethylenediamine tetraacetate tetrasodium salt, 255 g of styrene, 11.25 g of acrylic acid, and 3.0 g of tert-dodecyl mercaptan, followed by sealing of the reaction vessel and stirring at a stirring rate of 200 rpm. After conducting degassing with a vacuum pump followed by repeating nitrogen gas replacement several times, thereinto was injected 108.75 g of 1,3-butadiene, and the inner temperature was elevated to 60° C. Thereto was added a solution of 1.875 g of ammonium persulfate dissolved in 50 ml of water, and the mixture was stirred for 5 hours as it stands. The temperature was further elevated to 90° C., followed by stirring for 3 hours. After completing the reaction, the inner temperature was lowered to reach to the room temperature, and thereafter the mixture was treated by adding 1 mol/liter NaOH and NH₄OH to give the molar ratio of Na⁺ ion:NH⁴⁺ ion=1: 5.3, and thus, the pH of the mixture was adjusted to 8.4. Thereafter, filtration with a polypropylene filter having the pore size of 1.0 μm was conducted to remove foreign substances such as dust followed by storage. Accordingly, an SBR latex was obtained in an amount of 774.7 g. Upon the measurement of halogen ion by an ion chromatography, concentration of chloride ion was revealed to be 3 ppm. As a result of the measurement of concentration of the chelating agent by high performance liquid chromatography, it was revealed to be 145 ppm.

The aforementioned latex had a mean particle diameter of 90 nm, Tg of 17° C., solid mattingr concentration of 44% by mass, the equilibrium moisture content at 25° C., 60% RH of 0.6% by mass, ionic conductance of 4.80 mS/cm (measurement of the ionic conductance performed using a conductivity meter CM-30S manufactured by Toa Electronics Ltd., for the latex stock solution (44% by mass) at 25° C.).

2. Preparation of Coating Liquid

1) Preparation of Coating Liquid for Image Forming Layer

The organic silver salt dispersion B obtained as described above in an amount of 1000 g, 135 ml of water, 36 g of the pigment—1 dispersion, 25 g of the organic polyhalogenated compound—1 dispersion, 39 g of the organic polyhalogenated compound—2 dispersion, 171 g of the phthalazine compound—1 solution, 1060 g of the SBR latex (Tg: 17° C.) solution, 153 g of the reducing agent—2 dispersion, 55 g of the hydrogen bonding compound—1 dispersion, 4.8 g of the development accelerator—1 dispersion, 5.2 g of the development accelerator—2 dispersion, 2.1 g of the color tone adjusting agent—1 dispersion, and 8 ml of the mercapto compound—2 aqueous solution were serially added. The coating liquid for the image forming layer prepared by adding 140 g of the silver halide mixed emulsion A thereto followed by thorough mixing just prior to the coating was fed directly to a coating die, and was coated. Viscosity of the coating liquid for the image forming layer was measured with a type B viscometer from Tokyo Keiki, and was revealed to be 40 [mPa.s] at 40° C. (No. 1 rotor, 60 rpm). Viscosity of the coating liquid at 38° C. when it was measured using RheoStress RS150 manufactured by Haake was 30, 43, 41, 28, and 20 [mPa.s], respectively, at the shear rate of 0.1, 1, 10, 100, 1000 [1/second]. The amount of zirconium in the coating liquid was 0.30 mg per g of silver.

2) Preparation of Coating Liquid for Intermediate Layer

<<Preparation of Coating Liquid for Intermediate Layer—1>>

To 1000 g of polyvinyl alcohol PVA-205 (manufactured by Kuraray Co., Ltd.), 163 g of the pigment—1 dispersion, 33 g of a 18.5% by mass aqueous solution of a blue dye compound—1 (manufactured by Nippon Kayaku Co., Ltd.: Kayafecto turquoise RN liquid 150), 27 ml of a 5% by mass aqueous solution of sulfosuccinic acid di(2-ethylhexyl) sodium salt and 4200 ml of a 19% by mass solution of a methyl methacrylate/styrene/butyl acrylate/hydroxyethyl methacrylate/acrylic acid copolymer (weight ratio of the copolymerization of 57/8/28/5/2) latex (hereinafter, referred to as latex-1. Mn; 600,000, Tg 48° C.), were added 27 ml of a 5% by mass aqueous solution of aerosol OT (manufactured by American Cyanamid Co.), 135 ml of a 20% by mass aqueous solution of phthalic acid diammonium salt and water to give total amount of 10000 g. The mixture was adjusted with NaOH to give the pH of 7.5. Accordingly, a coating liquid for the intermediate layer was prepared, which was fed to a coating die to provide the rate of 8.9 ml/m². Viscosity of the coating liquid was 58 [mPa.s] as measured with a type B viscometer at 40° C. (No. 1 rotor, 60 rpm).

<<Preparation of Coating Liquids for Intermediate Layer—2 to 5>>

Coating liquids for intermediate layer—2 to 5 were prepared as in the preparation of the coating liquid for intermediate layer—1 except that the binder shown in Table 1 was used in stead of the polyvinyl alcohol PVA-205, and the methyl methacrylate/styrene/butyl acrylate/hydroxyethyl methacrylate/acrylic acid copolymer.

3) Preparation of Coating Liquid for First Layer of Surface Protective Layers

In 840 ml of water were dissolved 100 g of inert gelatin and 10 mg of benzoisothiazolinone, and thereto were added 180 g of a 19% by mass solution of latex-1, 46 ml of a 15% by mass methanol solution of phthalic acid and 5.4 ml of a 5% by mass aqueous solution of sulfosuccinic acid di(2-ethylhexyl) sodium salt, and were mixed. Immediately before coating, 40 ml of a 4% by mass chromium alum which had been mixed with a static mixer was fed to a coating die so that the amount of the coating liquid became 26.1 ml/m².

Viscosity of the coating liquid was 20 [mPa.s] as measured with a type B viscometer at 40° C. (No. 1 rotor, 60 rpm).

4) Preparation of Coating Liquid for Second Layer of Surface Protective Layers

<<Preparation of Coating Liquid for Second Layer of Surface Protective Layers—1>>

In 800 ml of water were dissolved 100 g of inert gelatin and 10 mg of benzoisothiazolinone, and therewith were mixed 180 g of a 19% by mass solution of latex-1, 40 ml of a 15% by mass methanol solution of phthalic acid, 5.5 ml of a 1% by mass solution of a fluorochemical surface active agent (F-1), 5.5 ml of a 1% by mass aqueous solution of a fluorochemical surface active agent (F-2), 28 ml of a 5% by mass aqueous solution of sulfosuccinic acid di(2-ethylhexyl) sodium salt, 4 g of polymethyl methacrylate fine particles (mean particle diameter of 0.7 μm) and 21 g of polymethyl methacrylate fine particles (mean particle diameter of 4.5 μm) to give a coating liquid for the surface protective layer, which was fed to a coating die so that the amount of coated gelatin became the amount described in Table 1.

Viscosity of the coating liquid was 19 [mPa.s] as measured with a type B viscometer at 40° C. (No. 1 rotor, 60 rpm).

<<Preparation of Coating Liquids for Second Layer of Surface Protective Layers—2 to 14>>

Coating liquids for second layer of surface protective layers—2 to 14 were prepared as in the preparation of the coating liquid for second layer of surface protective layers—1 except that the binder shown in Table 1 was used in stead of the inert gelatin, and the latex-1.

3. Production of Photothermographic Material

1) Production of Photothermographic Material—1

The opposite side to the back layer side was subjected to simultaneous superposition coating by a slide bead coating method in the order of the coating liquid for image forming layer—1, the coating liquid for intermediate layer—1, the coating liquid for first layer of surface protective layers, and the coating liquid for second layer of surface protective layers—1 starting from the undercoated face, and thus a sample of the photothermographic material was produced. In this method, the temperature was adjusted to 31° C. for the coating liquids for the image forming layer and intermediate layer, to 36° C. for the coating liquid for first layer of surface protective layers, and to 37° C. for the coating layer for second layer of surface protective layers.

The coating amount of each compound in the image forming layer (g/m²) then is as follows.

| | |
|---|---|
| Silver behenate | 5.27 |
| Pigment (C. I. Pigment Blue 60) | 0.036 |
| Polyhalogenated compound-1 | 0.14 |
| Polyhalogenated compound-2 | 0.28 |
| Phthalazine compound-1 | 0.18 |
| SBR latex | 9.43 |
| Reducing agent-2 | 0.77 |
| Hydrogen bonding compound-1 | 0.28 |
| Development accelerator-1 | 0.019 |
| Development accelerator-2 | 0.016 |
| Color tone adjusting agent-1 | 0.006 |
| Mercapto compound-2 | 0.003 |
| Silver halide (on the basis of Ag content) | 0.13 |

Conditions in coating and drying are as follows.

Coating was performed at a speed of 160 m/min, with the length of a gap between the leading end of the coating die and the support being 0.10 to 0.30 mm, and with the pressure in the vacuum chamber set to be lower than atmospheric pressure by 196 to 882 Pa. The support was decharged by ionic wind prior to coating.

In the subsequent cooling zone, the coating liquid was cooled with the wind having a dry-bulb temperature of 10 to 20° C. Thereafter, conveyance with no contact was carried out, and the coated support was dried with drying wind having a dry-bulb temperature of 23 to 45° C. and a wet-bulb temperature of 15 to 21° C. in a helical type contactless drying apparatus.

After drying, moisture conditioning was performed at 25° C. in the humidity of 40 to 60% RH. Then, the film surface was heated to be 70 to 90° C. After heating, the film surface was cooled to 25° C.

2) Production of Photothermographic Materials—2 to 18

Photothermographic materials—2 to 18 were produced in a similar manner to the production of the photothermographic material—1 except that the coating liquid for intermediate layer and the coating liquid for second layer of surface protective layers were coated according to the combination shown in Table 1. The coating amount of each compound in the image forming layer (g/m²) then is similar to that in the photothermographic material—1.

The chemical structures of the compounds used in the Examples are illustrated below.

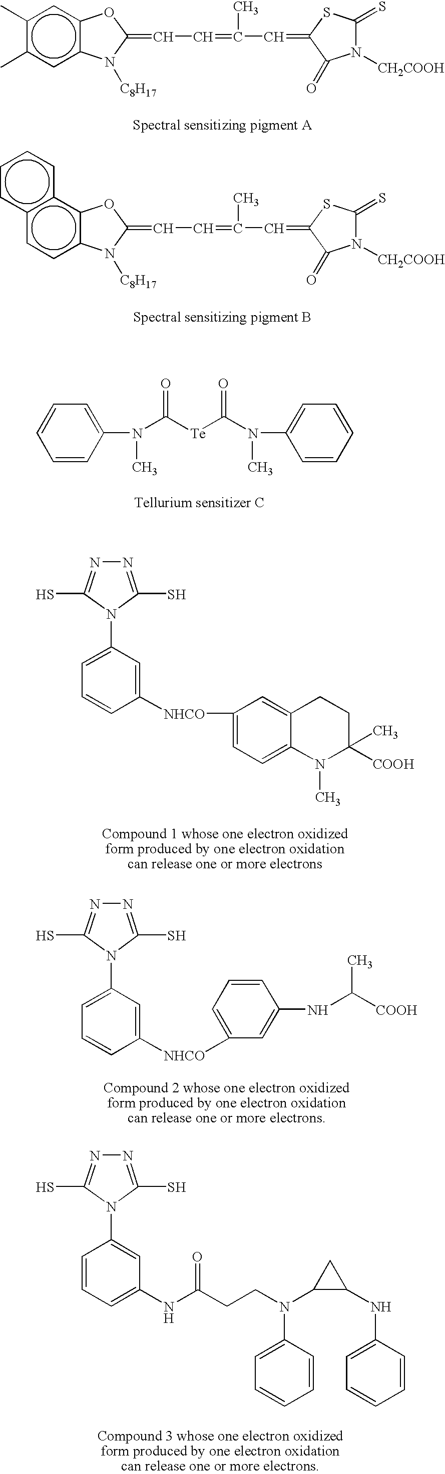

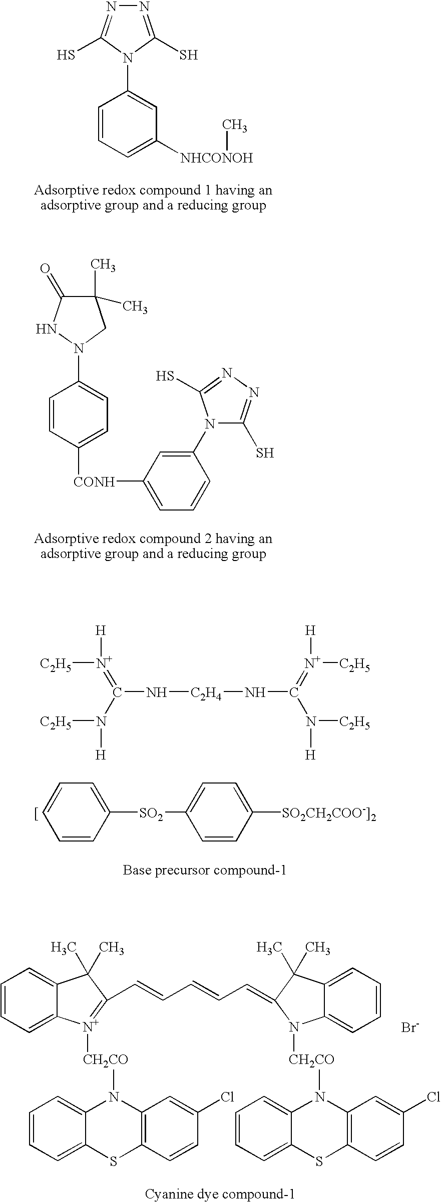

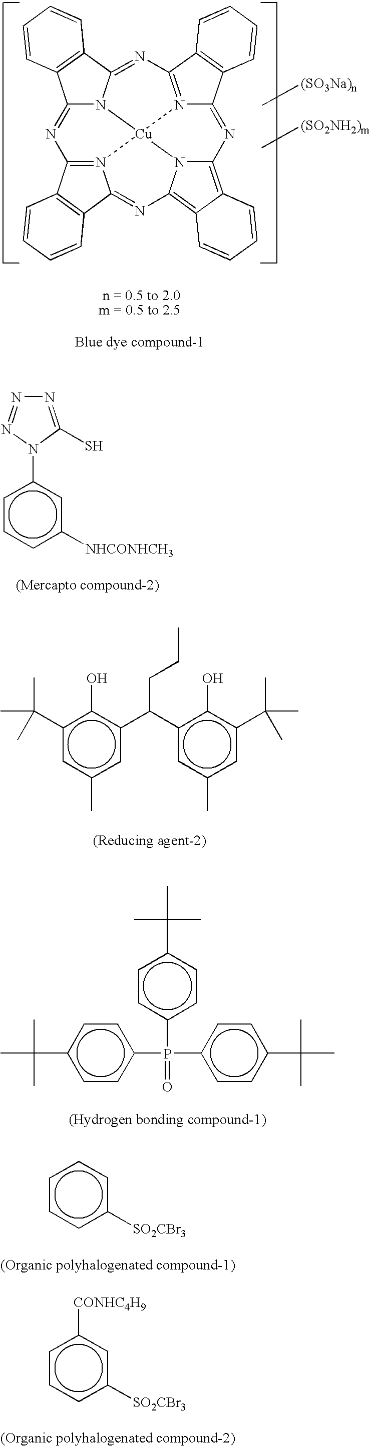

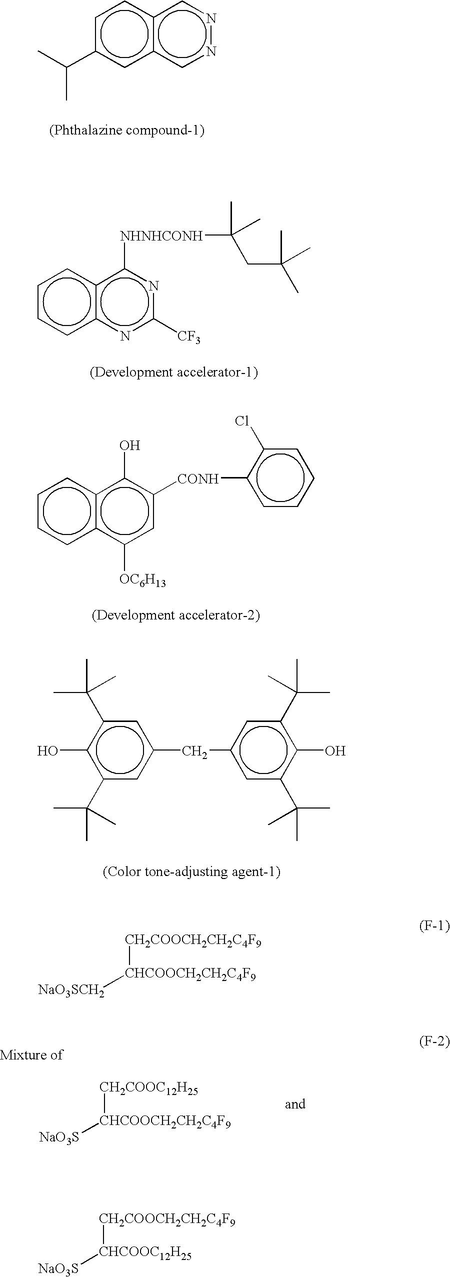

4. Evaluation of Photographic Performance

1) Preparation

The resulting sample was cut into a size of 14×17-in (length of 43 cm×width of 35 cm), wrapped with the following packaging material under an atmosphere of 25° C. and 50% RH, and stored for 2 weeks at an room temperature.

2) Packaging Material

PET 10 μm/PE 12 μm/aluminum foil 9 μm/Ny 15 μm/polyethylene 50 μm containing carbon at 3% by mass, Oxygen permeability: 0.02 ml/atm·m² 25° C. day, Moisture permeability: 0.10 g/atm·m² 25° C. day.

3) Light Exposure and Development of Photosensitive Material

Photothermographic materials—1 to 18 were subjected to light exposure and thermal development (14 seconds in total with 3 panel heaters set to be 107° C.-121° C.-121° C.) with Dry Laser Imager DRYPIX7000 manufactured by FujiFilm Medical Co., Ltd., (equipped with 660 nm semiconductor laser having the maximum output of 50 mW (IIIB)). Evaluation of thus resulting images was carried out with a densitometer.

4) Evaluation of Photographic Performance

<Evaluation of Unprocessed Stock Storability>

Each sample was stored under a condition of 25° C.-40% RH and 40° C.-70% RH or 50° C.-70% RH for additional 7 days, and thereafter, subjected to exposure and thermal development according to the aforementioned process in an atmosphere of 25° C.-55% RH to obtain an image. The conditions of 40° C.-70% RH and 50° C.-70% RH are forced conditions for evaluating storage stability following producing the photothermographic material until subjecting to the exposure and development. Table 1 shows the case (A) in which measurement was conducted after storing at 40° C.-70% RH, and the case (B) in which measurement was conducted after storing at 50° C.-70% RH.

For the evaluation of unprocessed stock storability, changes in minimum density (Dmin) were measured. In comparison with Dmin of the sample stored at 25° C.-40% RH, the difference in Dmin of the sample stored at 40° C.-70% RH (ADmin (A)) and the difference in Dmin of the sample stored at 50° C.-70% RH (ADmin (B)) were measured. The rate of change was determined according to the following formula, and presented in Table 1. Smaller ΔDmin (%) shows more excellent unprocessed stock storability.
ΔDmin (%)=[ΔDmin (B)−ΔDmin (A)]/ΔDmin (A)×100

<Evaluation of Image Storability>

Light was sufficiently irradiated on the photothermographic material following the exposure and thermal development, and humidity conditioning was carried out at 25° C.-70% RH for 3 hours. Thereafter, the material was enclosed in a bag, and left to stand under an atmosphere at 60° C. for 24 hrs. Ratio of change in minimum density then was evaluated with the rate of change in minimum density from that of the sample left to stand under an atmosphere of 25° C.-40% RH for 24 hrs (ΔDmin). Smaller ΔDmin shows more excellent image storability.

<Evaluation of Coating Capability>

According to the method explained in above section “Light exposure and development of photosensitive material” a gray image was obtained by adjusting the amount of exposure such that the average density became 1.2. Each sample thus treated was visually observed with a transmitted beam. Accordingly, sensory evaluation was made for unevenness of the density on the surface, and scored as follows.
b 3: Absence of unevenness of the density, or presence of unevenness which does not mattingr in a practical sense.
2: Absence of defects for a film such as a trace of crack on the surface, but presence of unevenness of the density.
1: Presence of defects for a film such as a trace of crack, leading to inadequacy for practical use.

<Evaluation of Rate of Water Absorption>

Water absorption was rendered to a sample prepared by forming a film of the polymer used as the binder in the outermost layer (coating amount: 15 g/m²) at 25° C. for 10 min. On the basis of the absorbed water content, values calculated by the following formula were categorized as follows:
percentage of water absorption(%)=absorbed water content (g/m²)/coating amount of polymer (g/m²)×100.
A: Percentage of water absorptionis from 0.3% to 10% which is in the range of the present invention.
B: Less than 0.3%.
C: Greater than 10%.

Results of evaluation are shown in Table 1.

TABLE 1

| | Outermost Layer | | | Nonphotosensitive | | | | | | | |
|---|---|---|---|---|---|---|---|---|---|---|---|
| | (Second Layer | | | Layer (First layer | | | | | | | |
| Photo- | of Surface | | | of Surface | | | | | | | |
| Ther- | Protective Layers) | | | Protective Layers) | | Intermediate | | | | | |
| mog- | Coating | | Percentage | Coating | | Layer | | Unprocessed | | | |
| raphic | Liquid | | of Water | liquid | | Coating | | Stock | Image | Coating | |
| Material | No. | Binder | Absorption | No. | Binder | liquid No. | Binder | Storability | Storability | Capability | Notes |
| 1 | 1 | gelatin: | C | 1 | gelatin:latex-1 | 1 | PVA: | 18% | 12% | 3 | Comparative |
| | | latex-1^{(note 1)} | | | | | latex-1 = | | | | Example |
| | | | | | | | 10:8 | | | | |
| 2 | 2 | CKP-1 | C | 1 | gelatin:latex-1 | 1 | PVA: | 16% | 11% | 2 | Comparative |
| | | | | | | | latex-1 = | | | | Example |
| | | | | | | | 10:8 | | | | |
| 3 | 3 | CKP-2 | C | 1 | gelatin:latex-1 | 1 | PVA: | 16% | 11% | 2 | Comparative |
| | | | | | | | latex-1 = | | | | Example |
| | | | | | | | 10:8 | | | | |
| 4 | 4 | CKP-3 | C | 1 | gelatin:latex-1 | 1 | PVA: | 17% | 12% | 2 | Comparative |
| | | | | | | | latex-1 = | | | | Example |
| | | | | | | | 10:8 | | | | |
| 5 | 5 | SBR | B | 1 | gelatin:latex-1 | 1 | PVA: | 20% | 15% | 1 | Comparative |
| | | latex^{(note 2)} | | | | | latex-1 = | | | | Example |
| | | | | | | | 10:8 | | | | |
| 6 | 6 | KP-1 | A | 1 | gelatin:latex-1 | 1 | PVA: | 8% | 5% | 3 | Present |
| | | | | | | | latex-1 = | | | | invention |
| | | | | | | | 10:8 | | | | |
| 7 | 7 | KP-2 | A | 1 | gelatin:latex-1 | 1 | PVA: | 9% | 6% | 3 | Present |
| | | | | | | | latex-1 = | | | | invention |
| | | | | | | | 10:8 | | | | |
| 8 | 8 | KP-3 | A | 1 | gelatin:latex-1 | 1 | PVA: | 8% | 5% | 3 | Present |
| | | | | | | | latex-1 = | | | | invention |
| | | | | | | | 10:8 | | | | |
| 9 | 9 | KP-7 | A | 1 | gelatin:latex-1 | 1 | PVA: | 8% | 5% | 3 | Present |
| | | | | | | | latex-1 = | | | | invention |
| | | | | | | | 10:8 | | | | |
| 10 | 10 | KP-8 | A | 1 | gelatin:latex-1 | 1 | PVA: | 9% | 6% | 3 | Present |
| | | | | | | | latex-1 = | | | | invention |
| | | | | | | | 10:8 | | | | |
| 11 | 11 | KP-9 | A | 1 | gelatin:latex-1 | 1 | PVA: | 8% | 5% | 3 | Present |
| | | | | | | | latex-1 = | | | | invention |
| | | | | | | | 10:8 | | | | |
| 12 | 12 | KP-14 | A | 1 | gelatin:latex-1 | 1 | PVA: | 9% | 5% | 3 | Present |
| | | | | | | | latex-1 = | | | | invention |
| | | | | | | | 10:8 | | | | |
| 13 | 13 | KP-15 | A | 1 | gelatin:latex-1 | 1 | PVA: | 8% | 7% | 3 | Present |
| | | | | | | | latex-1 = | | | | invention |
| | | | | | | | 10:8 | | | | |
| 14 | 14 | KP-18 | A | 1 | gelatin:latex-1 | 1 | PVA: | 8% | 5% | 3 | Present |
| | | | | | | | latex-1 = | | | | invention |
| | | | | | | | 10:8 | | | | |
| 15 | 8 | KP-3 | A | 1 | gelatin:latex-1 | 2 | SBR | 6% | 3% | 3 | Present |
| | | | | | | | latex | | | | invention |
| 16 | 8 | KP-3 | A | 1 | gelatin:latex-1 | 3 | LP-51 | 6% | 3% | 3 | Present |
| | | | | | | | | | | | invention |
| 17 | 8 | KP-3 | A | 1 | gelatin:latex-1 | 4 | LP-40 | 7% | 3% | 3 | Present |
| | | | | | | | | | | | invention |
| 18 | 8 | KP-3 | A | 1 | gelatin:latex-1 | 5 | LP-31 | 7% | 3% | 3 | Present |
| | | | | | | | | | | | invention |

In Table 1,
^{(Note 1)}Latex-1: MMA/St/BA/HEMA/AA = 57/8/28/5/2
Abbreviations;
MMA: methyl methacrylate,
St: styrene,
BA: butyl acrylate,
HEMA: hydroxyethyl methacrylate,
AA: acrylic acid
^{(Note 2)}SBR latex is the same as that used in the image forming layer

As is shown in Table 1, when the binder in the outermost layer contains an aqueous dispersion of a polymer having at least one crosslinked structure, and the percentage of water absorption falls within the range of the present invention, photothermographic materials were provided which are satisfactory in unprocessed stock storability and image storability, and coating capability. Further, incorporation of gelatin in the coating liquid for first layer of surface protective layers (first nonphotosensitive layer) resulted in the photothermographic material which is further excellent in coating capability. In particular, when the binder in the nonphotosensitive intermediate layer (second nonphotosensitive layer) contains the aqueous dispersion of the hydrophobic polymer in an amount of 50% by mass or greater, extremely satisfactory photothermographic material was provided.

### Example 2

Coating liquid for intermediate layer 6 or coating liquid for second layer of surface protective layers—15 was prepared by further adding a crosslinking agent—1 (EPOCROS K-2020E: Nippon Shokubai Co., Ltd.) to the coating liquid for intermediate layer—2, or the coating liquid for second layer of surface protective layers in Example 1 in an amount of 5% by mass per total amount of the binder in the added layer. Photothermographic materials—201 to 203 were produced in a similar manner to that for the photothermographic material—15 in Example 1 except that this coating liquid for intermediate layer 6 or coating liquid for second layer of surface protective layers—15 was used, and then evaluation was performed in a similar manner to that in Example 1. The results are shown in Table 2.

TABLE 2

| | Outermost | | | First Layer | | | | | | | | |
|---|---|---|---|---|---|---|---|---|---|---|---|---|
| | Layer (Second | | | of Surface | | | | | | | | |
| | layer of Surface | | | protective | | Intermediate | | | | | | |
| Photo- | Protective layers) | | | Layers | | Layer | | | | | | |
| Thermog- | Coating | | | Coating | | Coating | | | Unprocessed | | | |
| raphic | Liquid | | Crosslinking | Liquid | | Lliquid | | Crosslinking | Stock | Image | Coating | |
| Material | No. | Binder | Agent | No. | Binder | No. | Binder | Agent | Storability | storability | capability | Notes |
| 201 | 8 | KP-3 | Absent | 1 | gelatin: | 6 | SBR | Present | 5% | 2% | 3 | Present |
| | | | | | latex-1 | | | | | | | invention |
| 202 | 15 | KP-3 | Present | 1 | gelatin: | 2 | SBR | Absent | 5% | 2% | 3 | Present |
| | | | | | latex-1 | | | | | | | invention |
| 203 | 15 | KP-3 | Present | 1 | gelatin: | 6 | SBR | Present | 4% | 2% | 3 | Present |
| | | | | | latex-1 | | | | | | | invention |

In Table 2,
Latex-1: MMA/St/BA/HEMA/AA = 57/8/28/5/2;
Abbreviations;
MMA: methyl methacrylate,
St: styrene,
BA: butyl acrylate,
HEMA: hydroxyethyl methacrylate,
AA: acrylic acid
SBR latex is the same as that used in the image forming layer.

Addition of the crosslinking agent further improved the unprocessed stock storability, image storability, and coating capability.

### Example 3

(Production of PET Support)

Undercoated support was produced similarly to the production of the PET support of Example 1 except that, upon undercoating, the coating liquid for the undercoat, formula (1) was coated on both faces of the support such that the wet coating amount becomes 6.6 ml/m² (per one face) followed by drying at 180° C. for 5 min, in stead of coating with the coating liquid for the undercoat, formula (1) on one face of the support, and coating with the coating liquids for the undercoat, formulae (2) and (3) on the other face.

(Back Layer)

Although a back layer was provided in Example 1, no back layer was provided in Example 3.

(Image Forming Layer, Intermediate Layer, and Surface Protective Layer)

1. Preparation of Materials for Coating

1) Silver Halide Emulsion

<<Preparation of Silver Halide Emulsion A>>

A liquid prepared by adding 4.3 ml of a 1% by mass potassium iodide solution to 1421 ml of distilled water followed by further adding 3.5 ml of 0.5 mol/L sulfuric acid, 36.5 g of phthalated gelatin, 160 ml of a 5% by mass solution of 2,2′-(ethylenedithio)diethanol in methanol was kept at a liquid temperature of 75° C. while stirring in a stainless steel reaction pot, and thereto was added the whole of: a solution A prepared through diluting 22.22 g of silver nitrate by adding distilled water to give the volume of 218 ml; and a solution B prepared through diluting 36.6 g of potassium iodide in distilled water to give the volume of 366 ml. The solution A was added in its entirety over 16 minutes at a constant flow rate, and the solution B was added by a control double jet method while keeping the pAg of 10.2. Thereafter, 10 ml of a 3.5% by mass aqueous solution of hydrogen peroxide was added thereto, and 10.8 ml of a 10% by mass aqueous solution of benzoimidazole was further added. Moreover, a solution C prepared through diluting 51.86 g of silver nitrate by adding distilled water to give the volume of 508.2 ml, and a solution D prepared through diluting 63.9 g of potassium iodide in distilled water to give the volume of 639 ml were added thereto. The entire amount of the solution C was added at a constant flow rate over 80 minutes, and the solution D was added by a control double jet method while keeping the pAg of 10.2. Hexachloroiridium (III) potassium salt was added in its entirety to give 1×10⁻⁴ mol per mol of silver at 10 minutes post initiation of the addition of the solution C and the solution D. Moreover, at 5 seconds after completing the addition of the solution C, a potassium iron (II) hexacyanide aqueous solution was added in a total amount of 3×10⁻⁴ mol per mol of silver. The mixture was adjusted to give the pH of 3.8 with sulfuric acid having a concentration of 0.5 mol/L. Thereafter, stirring was terminated, and the mixture was subjected to precipitation/desalting/water washing steps. The mixture was adjusted to the pH of 5.9 with sodium hydroxide having the concentration of 1 mol/L to produce a silver halide dispersion having a pAg of 11.0.

The silver halide emulsion A was a pure silver iodide emulsion, and tabular particles having a mean projected area diameter of 0.93 μm, a coefficient of variation of the mean projected area diameter of 17.7%, a mean thickness of 0.057 μm and a mean aspect ratio of 16.3 occupied 80% or greater of the entire projected area. The sphere equivalent diameter was 0.42 μm. As a result of analysis by an X-ray powder diffraction analysis, 90% or more of silver iodide existed in the γ phase.

<<Preparation of Silver Halide Emulsion B>>

The tabular particle AgI emulsion prepared in the section of the silver halide emulsion A in an amount of 1 mol was charged into a reaction vessel. The pAg as measured at 38° C. was 10.2. Next, a 0.5 mol/liter KBr solution and a 0.5 mol/liter AgNO₃ solution were added at 10 ml/min over 20 min with double jet addition to substantially precipitate 10 mol % silver bromide on the AgI host emulsion epitaxially. During this operation, the pAg was kept at 10.2. In addition, the mixture was adjusted to give the pH of 3.8 with sulfuric acid having a concentration of 0.5 mol/L. Thereafter, stirring was terminated, and the mixture was subjected to precipitation/desalting/water washing steps. The mixture was adjusted to the pH of 5.9 with sodium hydroxide having the concentration of 1 mol/L to produce a silver halide dispersion having a pAg of 11.0.

The silver halide dispersion was kept at 38° C. while stirring, and thereto was added 5 ml of a 0.34% by mass methanol solution of 1,2-benzoisothiazoline-3-one, followed by elevating the temperature to 47° C. in 40 minutes thereafter. In 20 minutes after elevating the temperature, a solution of sodium benzene thiosulfonate in methanol was added at 7.6×10⁻⁵ mol per mol of silver. Additional 5 minutes later, the tellurium sensitizer C in a methanol solution was added at 2.9×10⁻⁵ mol per mol of silver and subjected to ripening for 91 minutes. Thereafter, 1.3 ml of a 0.8% by mass N,N′-dihydroxy-N″-diethylmelamine solution in methanol was added thereto, and in additional 4 minutes thereafter, 5-methyl-2mercaptobenzoimidazole in a methanol solution at 4.8×10⁻³ mol per mol of silver, 1-phenyl-2-heptyl-5-mercapto-1,3,4-triazole in a methanol solution at 5.4×10⁻³ mol per mol of silver, and 1-(3-nethylureidophenyl)-5-mercaptotetrazole in an aqueous solution at 8.5×10⁻³ mol per mol of silver were added thereto to produce a silver halide emulsion B.

<<Preparation of Silver Halide Emulsion C>>

A silver halide emulsion C was prepared in a similar manner to the silver halide emulsion A with changes in the addition amount of the 5% by mass solution of 2,2′-(ethylenedithio)diethanol in methanol, the temperature upon formation of the particle, and the timing point of addition of the solution A ad libitum. The silver halide emulsion C was a pure silver iodide emulsion, and tabular particles having a mean projected area diameter of 1.369 μm, a coefficient of variation of the mean projected area diameter of 19.7%, a mean thickness of 0.130 μm and a mean aspect ratio of 11.1 occupied 80% or greater of the entire projected area. Sphere equivalent diameter was 0.71 μm. As a result of analysis by the X-ray powder diffraction analysis, 90% or more of silver iodide existed in the γ phase.

<<Preparation of Silver Halide Emulsion D>>

In a completely similar manner to the silver halide emulsion B except that the silver halide emulsion C was used, a silver halide emulsion D was prepared which contains 10 mol % epitaxial silver bromide.

<<Preparation of Mixed Emulsion for Coating Liquid>>

The silver halide emulsion B and the silver halide emulsion D were dissolved to give the molar ratio of silver being 5:1, and thereto was added benzothiazolium iodide in a 1% by mass aqueous solution at 7×10⁻³ mol per mol of silver.

Moreover, compounds 1, 2 and 3 whose one electron oxidized form produced by one electron oxidation can release one or more electrons were added in an amount to be 2×10⁻³ mol per mol of silver in the silver halide, respectively.

Adsorptive redox compounds 1 and 2 having an adsorptive group and a reducing group were added in an amount to be 8×10⁻³ mol per mol of the silver halide, respectively.

Further, water was added thereto to give the content of silver halide of 15.6 g per liter of the mixed emulsion for a coating liquid.

<<Other Additives>>

Other additives in the image forming layer, intermediate layer, and surface protective layer were similarly prepared to Example 1.

2. Preparation of Coating Liquid

1) Preparation of Coating Liquid for Image Forming Layer

<<Preparation of Coating Liquid for Image Forming Layer—2>>

To the organic silver salt dispersion B of Example 1 in an amount of 1000 g and 276 ml of water were serially added the organic polyhalogenated compound—1 dispersion, the organic polyhalogenated compound—2 dispersion, the SBR latex (Tg: 17° C.) solution, the reducing agent—1 dispersion, the reducing agent—2 dispersion, the hydrogen bonding compound—1 dispersion, the development accelerator—1 dispersion, the development accelerator—2 dispersion, the color tone-adjusting agent—1 dispersion, the aqueous mercapto compound—1 solution, the aqueous mercapto compound—2 solution. After adding the silver iodide complex-forming agent, the mixed emulsion for coating liquid of silver halide was added thereto in an amount of 0.22 mol per mol of the organic silver salt on the basis of the silver amount, just prior to coating. After mixing thoroughly, the mixture was fed to a coating die as is stands.

Viscosity of the coating liquid for the image forming layer was measured with a type B viscometer from Tokyo Keiki, and was revealed to be 25 [mPa.s] at 40° C. (No. 1 rotor, 60 rpm).

Viscosity of the coating liquid at 25° C. when it was measured using RFS fluid spectrometer manufactured by Rheometrics Far East Ltd. was 242, 65, 48, 26 and 20 [mPa.s], respectively, at the shear rate of 0.1, 1, 10, 100, 1000 [1/second].

The amount of zirconium in the coating liquid was 0.52 mg per g of silver.

2) Preparation of Coating Liquid for Intermediate Layer

<<Preparation of Coating Liquid for Intermediate Layer—7>>

To 1000 g of polyvinyl alcohol PVA-205 (manufactured by Kuraray Co., Ltd.) and 4200 ml of a 19% by mass methylmethacrylate/styrene/butylacrylate/hydroxyethyl methacrylate/acrylic acid copolymer (weight ratio of the copolymerization of 64/9/20/5/2) latex (hereinafter, referred to as latex—2.) solution were added 27 ml of a 5% by mass aqueous solution of aerosol OT (manufactured by American Cyanamide Co.,), 135 ml of a 20% by mass aqueous solution of diammonium phthalate salt, and water to give the total amount of 10,000 g. The pH of the mixture was adjusted to be 7.5 with NaOH to obtain a coating liquid for intermediate layer, which was fed to a coating die to provide the rate of 9.1 ml/m².

Viscosity of the coating liquid was 58 [mPa.s] as measured with a type B viscometer at 40° C. (No. 1 rotor, 60 rpm).

<<Preparation of Coating Liquids for Intermediate Layer—8 to 9>>

Coating liquids for intermediate layer—8 to 9 were prepared in a similar manner to the preparation of the coating liquid for intermediate layer—7 except that the polyvinyl alcohol PVA-205, and the latex-2 as a binder was changed to the binder shown in Table 3, and the crosslinking agent—1 (EPOCROS K-2020E: Nippon Shokubai Co., Ltd.) was further added to the coating liquid for intermediate layer—9 in an amount of 5% by mass per total amount of the binder in the added layer.

3) Coating Liquid for First Layer of Surface Protective Layers—2

Inert gelatin in an amount of 64 g was dissolved in water, and thereto were added 112 g of a 19.0% by mass solution of latex-2, 30 ml of a 15% by mass methanol solution of phthalic acid, 23 ml of a 10% by mass aqueous solution of 4-methylphthalic acid, 28 ml of sulfuric acid at a concentration of 0.5 mol/L, 5 ml of a 5% by mass aqueous solution of aerosol OT (manufactured by American Cyanamide Co.,), 0.5 g of phenoxy ethanol and 0.1 g of benzoisothiazolinone. Coating liquid was prepared by adding water to give the total amount of 750 g, and immediately before coating, 26 ml of a 4% by mass chromium alum which had been mixed with a static mixer was mixed therewith and fed to a coating die to give 18.6 m/rm².

Viscosity of the coating liquid was 20 [mPa.s] as measured with a type B viscometer at 40° C. (No. 1 rotor, 60 rpm).

4) Preparation of Coating Liquid for Second Layer of Surface Protective Layers—20

Inert gelatin in an amount of 80 g was dissolved in water, and thereto were added 102 g of a 27.5% by mass solution of latex-2, 5.4 ml of a 2% by mass solution of a fluorochemical surface active agent (F-1), 5.4 ml of 2% by mass aqueous solution of a fluorochemical surface active agent (F-2), 23 ml of a 5% by mass solution of aerosol OT (manufactured by American Cyanamide Co.,), 4 g of polymethyl methacrylate fine particles (mean particle size of 0.7 μm, distribution of the volume weighted average of 30%), 21 g of polymethyl methacrylate fine particles (mean particle size of 3.6 μm, distribution of the volume weighted average of 60%), 1.6 g of 4-methylphthalic acid, 4.8 g of phthalic acid, 44 ml of sulfuric acid having a concentration of 0.5 mol/L, 10 mg of benzoisothiazolinone, and water to give the total amount of 650 g. Thereto was added 445 ml of an aqueous solution containing 4% by mass chromium alum and 0.67% by mass phthalic acid which had been mixed with a static mixer immediately before coating to prepare a coating liquid for surface protective layer, which was fed to a coating die to give 8.3 ml/m².

Viscosity of the coating liquid was 19 [mPa.s] as measured with a type B viscometer at 40° C. (No. 1 rotor, 60 rpm).

<<Preparation of Coating Liquids for Second Layer of Surface Protective Layers—21 to 23>>

Coating liquids for second layer of surface protective layers—21 to 23 were prepared in a similar manner to the preparation of the coating liquid for second layer of surface protective layers—20 except that inert gelatin, and the latex-2as a binder was changed to the binder shown in Table 3, and the crosslinking agent -1 (EPOCROS K-2020E: Nippon Shokubai Co., Ltd.) was further added to the coating liquid for second layer of surface protective layers—23 in an amount of 5% by mass per total amount of the binder in the added layer.

3. Production of Photothermographic Material

1) Production of Photothermographic Material—301

One surface (A side face) was subjected to simultaneous superposition coating by a slide bead coating method in the order of the coating liquid for image forming layer—2, the coating liquid for intermediate layer—4, the coating liquid for first layer of surface protective layers—2, and the coating liquid for second layer of surface protective layers—6 starting from the undercoated face. In this method, the temperature was adjusted to 31° C. for the coating liquid for image forming layer and the coating liquid for intermediate layer, to 36° C. for the coating liquid for first layer of surface protective layers, and to 37° C. for the coating layer for second layer of surface protective layers. The amount of coated silver of the image forming layer was 0.821 g/m² per one face in total of the organic silver salt and silver halide.

Other face (B side face) was subjected to simultaneous superposition coating by a slide bead coating method in the order of the coating liquid for image forming layer—2, the coating liquid for intermediate layer—7, the coating liquid for first layer of surface protective layers—2, and the coating liquid for second layer of surface protective layers—20 starting from the undercoated face.

The coating amount of each compound in the image forming layer per one face (g/m²) is as follows.

| | |
|---|---|
| Organic silver salt | 2.80 |
| Polyhalogenated compound-1 | 0.028 |
| Polyhalogenated compound-2 | 0.094 |
| Silver iodide complex-forming agent | 0.46 |
| SBR latex | 5.20 |
| Reducing agent-1 | 0.33 |
| Reducing agent-2 | 0.13 |
| Hydrogen bonding compound-1 | 0.15 |
| Development accelerator-1 | 0.005 |
| Development accelerator-2 | 0.035 |
| Color tone adjusting agent-1 | 0.002 |
| Mercapto compound-1 | 0.001 |
| Mercapto compound-2 | 0.003 |
| Silver halide (on the basis of Ag content) | 0.146 |

Conditions in coating and drying are as follows.

Coating was performed at a speed of 160 m/min, with the length of a gap between the leading end of the coating die and the support being 0.10 to 0.30 mm, and with the pressure in the vacuum chamber set to be lower than atmospheric pressure by 196 to 882 Pa. The support was decharged by ionic wind prior to coating.

In the subsequent cooling zone, the coating liquid was cooled with the wind having a dry-bulb temperature of 10 to 20° C. Thereafter, conveyance with no contact was carried out, and the coated support was dried with drying wind having a dry-bulb temperature of 23 to 45° C. and a wet-bulb temperature of 15 to 21° C. in a helical type contactless drying apparatus.

After drying, moisture conditioning was performed at 25° C. in the humidity of 40 to 60% RH. Then, the film surface was heated to be 70 to 90° C. After heating, the film surface was cooled to 25° C.

2) Production of Photothermographic Materials—302 to 306

Photothermographic materials—302 to 306 were produced in a similar manner to the production of the photothermographic material—301 except that the simultaneous superposition coating was conducted with a combination of the coating liquid for image forming layer and the coating liquid for intermediate layer as shown in Table 3.

4. Evaluation of Photographic Performance

The resulting sample was cut into a size of 14×17-in (length of 43 cm×width of 35 cm), wrapped with the following packaging material under an atmosphere of 25° C. and 50% RH, stored for 2 weeks at an room temperature, and evaluated as follows.

(Packaging Material)

PET 10 μm/PE 12 μm/aluminum foil 9 μm/Ny 15 μm/polyethylene 50 μm containing carbon at 3% by mass.

Oxygen permeability: 0.02 ml/atm·m²·25° C.·day, Moisture permeability: 0.10 g/atm·m²·25° C.·day.

The prepared photosensitive material which was coated on both faces was evaluated as follows. A construct for image-formation was manufactured using two X-ray regular screens, HI-SCREEN B3 manufactured by Fuji Photo Film Co., Ltd. (CaWO₄ is used as a fluorescent material. Emission peak wavelength: 425 nm), by placing a sample therebetween. This construct was exposed to an X-ray for 0.05 sec to perform an X-ray sensitometry. The X-ray apparatus employed was trade name DRX-3724HD manufactured by Toshiba Corporation, and a tungsten target was used. A voltage of 80 kVp was applied with a pulse generator by way of three phases, and an X-ray passed through a 7 cm filter of water having approximately equivalent absorption to a human body was generated as a light source. Exposure was conducted with altered distance to generate the density of 1.2. Following the exposure, a thermal development processing was carried out under the thermal development processing condition as described below. Evaluation of the resulting image was performed with a densitometer.

The photothermographic materials—301 to 306 after the screen exposure were developed with Dry laser imager FMDP manufactured by FujiFilm Medical Co., Ltd., for 24 seconds while keeping the laser output turning off. Further, the thermal development part of FMDP-L was changed to a drum type thermal development part, and the development was executed at 116° C. for 24 seconds. The used drum type thermal development part had a diameter of the drum of 320 mm, and had a drum surface to be brought into contact with the film being covered by a fluoro rubber having a thickness of 0.5 mm. The roller used for conveyance was a stainless-steel roller having a diameter of 12 mm.

Moreover, the thermal development part was changed to a thermal development part of staggered heating rollers, and the development was executed at 123° C. for 24 seconds. The staggered heating roller employed was a stainles-steel metal roller having a diameter of 12 mm on which a 0.5 mm fluoro rubber was coated.

The process for photographic evaluation was similar to that of Example 1. The results are shown in Table 3.

TABLE 3

| | Outermost Layer | | | | | | | | | | | | |
|---|---|---|---|---|---|---|---|---|---|---|---|---|---|
| | (Second Layer | | | | | | | | | | | | |
| | of Surface | | | | | | | | | | | | |
| | Protective Layers) | | | | First Layer | | | | | | | | |
| | | | Per- | | of Surface | | | | | | | | |
| Photo- | | | centage | | Protective | | Intermediate | | | | | | |
| Ther- | | | of | | Layers | | Layer | | | | | | |
| mog- | Coating | | Water | Cross- | Coating | | Coating | | Cross- | Unprocessed | | Coating | |
| raphic | Liquid | | Absorp- | linking | Liquid | | Liquid | | linking | Stock | Image | Capa- | |
| Material | No. | Binder | tion | Agent | No. | Binder | No. | Binder | Agent | Storability | Storability | bility | Notes |
| 301 | 20 | gelatin: | C | Absent | 2 | gelatin: | 7 | PVA: | Absent | 22% | 15% | 3 | Com- |
| | | latex-2 = | | | | latex-2 = | | latex-2 = | | | | | parative |
| | | 80:28 | | | | 64:21 | | 10:8 | | | | | Example |
| 302 | 21 | SBR | B | Absent | 2 | gelatin: | 7 | PVA: | Absent | 23% | 16% | 1 | Com- |
| | | latex | | | | latex-2 = | | latex-2 = | | | | | parative |
| | | | | | | 64:21 | | 10:8 | | | | | Example |
| 303 | 22 | KP-3 | A | Absent | 2 | gelatin: | 7 | PVA: | Absent | 14% | 10% | 3 | Present |
| | | | | | | latex-2 = | | latex-2 = | | | | | invention |
| | | | | | | 64:21 | | 10:8 | | | | | |
| 304 | 22 | KP-3 | A | Absent | 2 | Gelatin: | 8 | SBR | Absent | 13% | 9% | 3 | Present |
| | | | | | | latex-2 = | | latex | | | | | invention |
| | | | | | | 64:21 | | | | | | | |
| 305 | 23 | KP-3 | A | Present | 2 | Gelatin: | 8 | SBR | Absent | 11% | 8% | 3 | Present |
| | | | | | | latex-2 = | | latex | | | | | invention |
| | | | | | | 64:21 | | | | | | | |
| 306 | 23 | KP-3 | A | Present | 2 | Gelatin: | 9 | SBR | Present | 10% | 8% | 3 | Present |
| | | | | | | latex-2 = | | latex | | | | | invention |
| | | | | | | 64:21 | | | | | | | |

In Table 3,
Latex-1: MMA/St/BA/HEMA/AA = 64/9/20/5/2; and
(Abbreviations;
MMA: methyl methacrylate,
St: styrene,
BA: butyl acrylate,
HEMA: hydroxyethyl methacrylate,
AA: acrylic acid)
SBR latex is the same as that used in the image forming layer

As is shown in Table 3, when the binder in the outermost layer contains an aqueous dispersion of a polymer having at least one crosslinked structure, and the percentage of water absorption falls within the range of the present invention, photothermographic materials were provided which are satisfactory in unprocessed stock storability and image storability, and coating capability, also in cases of the photosensitive materials having image forming layers on both faces of a support. Further, incorporation of gelatin in the coating liquid for first layer of surface protective layers (first nonphotosensitive layer) resulted in the photothermographic material which is further excellent in coating capability. In particular, when the binder in the nonphotosensitive intermediate layer (second nonphotosensitive layer) contains the aqueous dispersion of the hydrophobic polymer in an amount of 50% by mass or greater, and when a crosslinking agent is contained, extremely satisfactory photothermographic material was provided.

1. A photothermographic material which comprises an image forming layer provided on at least one side of a support, the image forming layer containing a photosensitive silver halide, a nonphotosensitive organic acid silver salt, a reducing agent, and a binder, wherein:
a binder in an outermost layer on the side of the support on which the image forming layer is provided contains an aqueous dispersion of a polymer having at least one crosslinked structure; and
a percentage of water absorption of the polymer having a crosslinked structure is 0.3% or greater and 10% or less.

2. The photothermographic material according to claim 1, wherein the binder in the outermost layer contains the aqueous dispersion of the polymer having the crosslinked structure in an amount of 90% by mass or greater and 100% by mass or less.

3. The photothermographic material according to claim 1, wherein:
a first nonphotosensitive layer is provided on the side of the support on which the image forming layer is provided; and
the first nonphotosensitive layer contains at least one binder which can be gelated due to a reduction in temperature.

4. The photothermographic material according to claim 3, wherein:
a second nonphotosensitive layer containing a binder is provided on the side of the supprt on which the image forming layer is provided; and
the binder in the second nonphotosensitive layer contains an aqueous dispersion of a hydrophobic polymer in an amount of 50% by mass or greater.

5. The photothermographic material according to claim 1, wherein any one layer on the side of the supprt on which the image forming layer is provided contains a crosslinking agent.

6. The photothermographic material according to claim 1, wherein the image forming layer is provided on both sides of the supprt.

7. The photothermographic material according to claim 1, wherein a polymer having the crosslinked structure is obtained by the polymerization of monomera including a crosslinkable radical polymerizable monomer.

8. The photothermographic material according to claim 7, wherein a content of the crosslinkable radical polymerizable monomer is 0.1% by mass or greater and 10% by mass or less.

9. The photothermographic material according to claim 1, wherein the binder in the outermost layer contains the aqueous dispersion of the polymer having the crosslinked structure in an amount of 92% by mass or greater and 100% by mass or less.

10. The photothermographic material according to claim 3 wherein the binder which can be gelated due to a reduction in temperature is a polymer derived from animal protein.

11. The photothermographic material according to claim 10, wherein the polymer derived from animal protein is gelatin.

12. The photothermographic material according to claim 11, wherein the number average molecular weight of the gelatin is 10,000 or greater and 1,000,000 or less.

13. The photothermographic material according to claim 4, wherein the binder in the second nonphotosensitive layer contains the aqueous dispersion of the hydrophobic polymer in an amount of 80% by mass or greater.

14. The photothermographic material according to claim 4, wherein the binder in the second nonphotosensitive layer contains the aqueous dispersion of the hydrophobic polymer in an amount of 90% by mass or greater.

15. The photothermographic material according to claim 4, wherein the number average molecular weight of the hydrophobic polymer is 5,000 or greater and 1,000,000 or less.

16. The photothermographic material according to claim 4, wherein the glass transition temperature of the hydrophobic polymer is −30° C. or higher and 70° C. or lower.

17. The photothermographic material according to claim 4, wherein the hydrophobic polymer is a polymer obtained by copolymerization of a monomer represented by the following formula (M):
CH₂═CR⁰¹—CR⁰²═CH₂
wherein R⁰¹ and R⁰² are each independently a group selected from a hydrogen atom, an alkyl group having 1 to 6 carbon atoms, a halogen atom, or a cyano group.

18. The photothermographic material according to claim 1, wherein a matting agent is contained in the outermost layer.

19. The photothermographic material according to claim 18, wherein the volume weighted average of the sphere equivalent diameter of the matting agent is 0.3 μm or greater and 10 μm or less.
